(19) United States
(12) Patent Application Publication
(10) Pub. No.: US 2003/0113096 A1
(43) Pub. Date: Jun. 19, 2003

(54) Multi-screen display system for automatically changing a plurality of simultaneously displayed images

(75) Inventors: Kazuhiko Taira, Yokohama-shi (JP); Shinichi Kikuchi, Yokohama-shi (JP); Mitsuyuki Nozaki, Tokyo (JP); Hideki Mimura, Yokohama-shi (JP)

Correspondence Address: Pillsbury Winthrop LLP, Intellectual Property Group, 1600 Tysons Boulevard, McLean, VA, 22102, US

(73) Assignee: KABUSHIKI KAISHA TOSHIBA

(21) Appl. No.: 10/356,472

(22) Filed: Feb. 3, 2003

Related U.S. Application Data
(63) Continuation of application No. 09/110,442, filed on Jul. 7, 1998.

(30) Foreign Application Priority Data
Jul. 7, 1997 (JP) 9-181406
Mar. 24, 1998 (JP) 10-075694

(51) Int. Cl. H04N 5/781

(52) U.S. Cl. 386/46; 386/125

(57) ABSTRACT

If there are a plurality of angles or scenes that can be played back within an identical time band, the playback screen is divided into a plurality of areas, and some or all of a plurality of angles or scenes that can be played back are simultaneously displayed (digest-displayed) on the divided screen areas. The display contents of a plurality of angles or scenes that can be played back can be automatically changed.

### BACKGROUND OF THE INVENTION

The present invention relates to a playback system for playing back multi-screen displayable information from a large-capacity information recording medium, and an information recording medium which can be played back by the playback system.

The present invention particularly relates to a playback system which can play back a digest of pictures of a plurality of scenes (angles) that can be played back at individual timings, from an optical disk or disc which records a plurality of multiscene pictures (multiangle pictures) that can be selectively played back in an identical time band.

Furthermore, the present invention relates to a playback system which can automatically switch and play back various angle pictures from an optical disk which records multiangle pictures.

In recent years, along with the improvement of optical pickup techniques using lasers with shorter wavelengths, and development of high-density recording techniques and data compression techniques, the capacities of recording media such as optical disks and the like have increased, and the information volume that can be recorded on a recording medium has increased remarkably.

For example, the recording capacity of a CD (compact disk) that uses a read laser wavelength of 780 nm is about 650 MB, while a DVD (digital video disk or digital versatile disk) that uses a read laser wavelength of 650 nm can record digital information up to about 4.7 GB in case of a disk having a single information recording layer. The DVD is an optical disk having the same diameter (120 mm) as that of the CD, but its storage capacity is about seven times that of the CD even in a DVD of single-layered disk type. Furthermore, the DVD can have two to four information recording layers, and its storage capacity can be further increased if it has a recording multilayer.

Since the DVD can record a huge volume of information, it can realize functions that cannot be realized by CDs or LDs (laser disks which record analog video signals).

For example, assume that a live concert video title of a certain music artist is produced. In this case, various scenes of the concert are taken and recorded using a plurality of cameras (for example, five cameras respectively sense “whole band”, “vocalist alone”, “guitarist alone”, “bassist alone”, and “drummer alone” scenes). These recorded scene pictures of five different camera angles are edited until a final video title is completed. In the edit process, the editor (producer) determines the correspondence between the images taken by the cameras and scenes in the video title, and completes a single concert video title.

In the conventional concert video title completed in this way, the user can only enjoy the concert from the camera angles (normally, centered on the vocalist) determined by the editor (producer). In this case, even when the audience (playback apparatus user) of that video title wants to always watch “guitarist alone” to master the technique of the guitarist, his or her requirement is not satisfied.

Since a DVD has a very large recording capacity, it can individually record all the pictures in an identical time band (the camera angles of the whole band, vocalist alone, guitarist alone, bassist alone, and drummer alone) recorded by the five cameras in the above-mentioned conventional concert video title. As a result, the playback apparatus user can desirably select and play back pictures (multiangle pictures) taken by the individual cameras. This is the multiangle function of the DVD that has been introduced first in the video media field, and a DVD containing video pictures using the multiangle function can be called multiangle software.

However, when the multiangle software is played back by an existing DVD playback apparatus, the user can freely select and play back desired camera angle pictures but the selected angle picture alone is kept played back unless the angle selection state is changed (or the angle playback mode is reset to a default state). In such state, a requirement of another user who wants to watch that video title as a normal concert video title (original angle playback in the edited state that the video editor intended) is not met.

When the editor (producer) records the conventionally edited concert video title as one angle picture sequence, the user can select that angle picture sequence. In this case, however, the user must always watch identical picture sequence, and may lose interest in such title soon after repetitive watching.

In case of single-angle recording, if there are a plurality of angles that the user wants to watch, the user can neither arbitrarily select and watch his or her desired angle nor mask an angle that he or she does not want to watch and select and watch other angles.

Furthermore, if there are a plurality of angles that the user wants to watch, he or she can neither alternately or randomly and automatically select and watch only those angles nor mask (skip) an angle that he or she does not want to watch and automatically select and watch other angles.

Moreover, when a plurality of angle (scene) pictures can be played back from a medium that records multiangle (multiscene) pictures, the user can confirm angle (scene) pictures which are currently available only by manually switching and playing back different angles (scenes).

An angle switching mode of multiangle software includes seamless angle switching in which joints upon angle switching are continuous in the flow of playback time, and non-seamless angle switching in which joints upon angle switching are discontinuous in the flow of playback time. When the playback system automatically determines seamless or non-seamless angle switching and switches angle, it must extract identification information indicating seamless or non-seamless angle switching from the recording medium.

### BRIEF SUMMARY OF THE INVENTION

The present invention has been made in consideration of the above situation, and has as its first object to provide a playback system (including an apparatus or method) that allows the user to easily recognize angle (scene) pictures which are currently available in a location where multiangle (multiscene) playback is allowed.

It is the second object of the present invention to provide a multiangle automatic switching/playback system (including an apparatus or method) which can realize a colorful, appealing angle switching function for the user (viewer of multiangle software) by automatically switching the angles of multiangle pictures.

It is the third object of the present invention to provide an information recording medium which has information for informing the user of angle (scene) pictures recorded at a location where multiangle (multiscene) playback is allowed.

It is the fourth object of the present invention to provide an information recording medium having identification information indicating seamless or non-seamless angle switching so as to allow a playback system to automatically detect if multiangle pictures use seamless or non-seamless angle switching.

It is the fifth object of the present invention to provide a computer-readable program holding medium having a multiangle processing program which can automatically switch the angle of multiangle pictures (or can simultaneously display a plurality of multiangle windows).

In order to achieve the first object, a playback system according to the present invention can divide a playback window into a plurality of windows if there are a plurality of angles or scenes that can be played back in an identical time band, and can simultaneously display some or all of a plurality of angles or scenes on the divided windows (digest display).

In order to achieve the second object, a playback system according to the present invention can automatically select, play back, and display one of multiangle pictures from a recording medium which records multiangle pictures made up of a plurality of picture data that can be selectively played back in an identical time band (auto-angle display).

In order to achieve the third object, an information recording medium according to the present invention records information (SML_AGLI or NSML_AGLI) associated with a plurality of angles or scenes in a location (angle block) where there are a plurality of angles or scenes that can be played back in an identical time band. By extracting this information associated with a plurality of angles or scenes from the medium, a plurality of angle or scene pictures that can be played back in an identical time band can be simultaneously displayed on the monitor screen which is divided into a plurality of windows in correspondence with the number of angles or scenes that can be played back in the multiangle or multiscene playback mode.

In order to achieve the fourth object, an information recording medium according to the present invention records more than one video title sets each containing a plurality of cells each made up of more than one video object units each including more than one video packs each of which records video information in a small unit (2 kB). In this case, an angle block including a first angle cell (AGL_C#1) which is made up of more than one cells and contains first camera angle picture information, and a second angle cell (AGL_C#i) which is made up of more than one cells and contains second camera angle picture information is recorded in the video title set. Also, an angle change flag (b24 in FIG. 27) that indicates if the playback angle can be switched between the first angle cell (AGL_C#1) and second angle cell (AGL_C#i) non-seamlessly or seamlessly upon playing back that angle block is recorded in the video title set. The contents of the angle change flag are used for automatically determining if the playback angle is switched non-seamlessly or seamlessly.

In order to achieve the fifth object, a computer-readable program holding medium according to the present invention describes processes (ST40 to ST60) for automatically selecting a desired angle from multiangle pictures that contain a plurality of picture data which can be selectively played back in an identical time band, and are numbered in the recording order, and switching the angles to be played back.

Alternatively, a computer-readable program holding medium according to the present invention describes processes (ST43, ST60) which select a plurality of angles from multiangle pictures that contain a plurality of picture data which can be selectively played back in an identical time band, and are numbered in the recording order, and determine the display positions and sizes of the individual selected angles on the playback screen in accordance with the number of selected angles.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments give below, serve to explain the principles of the invention.

FIG. 1 is a perspective view for explaining the physical structure of an optical disk (read-only DVD disk) that can be used in the present invention;

FIG. 2 is a plan view for explaining the track/sector structure of a recording area of the optical disk (read-only DVD disk) shown in FIG. 1;

FIG. 3 is a perspective view for explaining the physical structure of an optical disk (read-only or read/write type DVD disk) that can be used in the present invention;

FIG. 4 is a plan view for explaining the track/sector structure of a recording area of the optical disk (read/write type DVD disk) shown in FIG. 3;

FIG. 5 is a view for explaining the structure of data recorded on optical reflection layer 16 of the optical disk shown in FIG. 1 or ROM layer 17A of the optical disk shown in FIG. 3;

FIG. 6 is a view for explaining an example of the hierarchical structure of data in a video object set shown in FIG. 5;

FIG. 7 is a view for explaining the contents of the respective packs (data read out from the disk) contained in a video object unit shown in FIG. 6;

FIG. 8 is a view for explaining the data format of navigation pack NV_PCK shown in FIG. 7;

FIG. 9 is a view for explaining the data arrangement of presentation control information PCI shown in FIG. 8;

FIG. 10 is a view for explaining the contents of presentation control information PCI shown in FIG. 9;

FIG. 11 is a view for explaining the contents of PCI general information PCI_GI shown in FIG. 10;

FIG. 12 is a view for explaining the contents of user operation control VOBU_UOP_CTL of VOBU shown in FIG. 11;

FIG. 13 is a view for explaining the contents of angle information NSML_AGLI for non-seamless shown in FIG. 10;

FIG. 14 is a view for explaining the contents of non-seamless angle change cell destination address NSML_AGL_Cn_DSTA shown in FIG. 13;

FIG. 15 is a view for explaining the process of non-seamless angle change in an angle block made up of a plurality of multiangle cells;

FIG. 16 is a view for explaining the data arrangement of data search information DSI shown in FIG. 8;

FIG. 17 is a view for explaining the contents of data search information DSI shown in FIG. 16;

FIG. 18 is a view for explaining the contents of DSI general information DSI_GI shown in FIG. 17;

FIG. 19 is a view for explaining the contents of angle information SML_AGLI for seamless shown in FIG. 17;

FIG. 20 is a view for explaining the contents of seamless angle change cell destination address SML_AGL_Cn_SDTA shown in FIG. 19;

FIG. 21 is a view for explaining seamless angle change in an angle block made up of a plurality of multiangle cells;

FIG. 22 is a view for explaining the structure of program chain information contained in video title set information VTSI shown in FIG. 5;

FIG. 23 is a view for explaining the structure of program chain general information PGC_GI shown in FIG. 22;

FIG. 24 is a view for explaining the contents of user operation control PGC_UOP_CTL of PGC shown in FIG. 23;

FIG. 25 is a view for explaining the structure of cell playback information table C_PBIT shown in FIG. 22;

FIG. 26 is a view for explaining the contents of cell playback information C_PBI shown in FIG. 25;

FIG. 27 is a view for explaining the contents of cell category C_CAT shown in FIG. 26;

FIG. 28 is a view for explaining restriction of seamless playback in an angle block;

FIG. 29 is a view for explaining an example of angle switching (in case of seamless);

FIG. 30 is a view for explaining the structures of available menus;

FIG. 31 is a view for explaining a menu for selecting and setting playback permission/prohibition of specific angles of multi-angle picture information played back from the optical disk shown in FIG. 1 or 3;

FIG. 32 is a view for explaining a flag set that holds the setup result of the menu shown in FIG. 31;

FIG. 33 is a flow chart for explaining the operation for setting flags in the flag set shown in FIG. 32 via the menu shown in FIG. 31;

FIG. 34 is a flow chart for explaining the first example of automatic angle switching (auto-angle by random number generation);

FIG. 35 is a flow chart for explaining the second example of automatic angle switching (auto-angle by angle number counting);

FIG. 36 is a flow chart for explaining the third example of automatic angle switching (auto-angle by random number generation with a variable angle switching period);

FIG. 37 is a flow chart for explaining the contents of seamless angle switching (ST70) in automatic angle switching shown in FIG. 36;

FIG. 38 is a flow chart for explaining the contents of non-seamless angle switching (ST80) in automatic angle switching shown in FIG. 36;

FIG. 39 shows an example of change in playback screen when the playback angle is switched in the automatic angle switching mode shown in one of FIGS. 34 to 36;

FIG. 40 is a block diagram for explaining the arrangement of principal part of a multiangle automatic switching/playback system;

FIG. 41 is a flow chart for explaining the fourth example of automatic angle switching (auto-angle switching by audio signal level detection);

FIG. 42 is a view for explaining a case wherein n angle pictures that can be played back are displayed on a screen divided into n display areas (four areas), and the currently selected angle picture is displayed as a movie;

FIG. 43 is a flow chart for explaining the fifth example of automatic angle switching (auto-angle by means of n-divisional display);

FIG. 44 is a flow chart for explaining the sixth example of automatic angle switching (auto-angle by angle number counting with a variable angle switching period);

FIG. 45 is a block diagram for explaining the overall arrangement of a playback apparatus with a built-in multiangle (multiscene) digest display system according to an embodiment of the present invention;

FIG. 46 is a block diagram for explaining the overall arrangement of a playback apparatus with a built-in multiangle (multiscene) digest display (multiangle movie simultaneous playback) system according to another embodiment of the present invention;

FIG. 47 is a block diagram for explaining the overall arrangement of a playback apparatus with a built-in multiangle (multiscene) digest display (multiangle movie simultaneous playback) system according to still another embodiment of the present invention;

FIG. 48 is a plan view for explaining the arrangement of a remote controller that can be used in a playback apparatus (or a recording/playback apparatus) according to the present invention;

FIG. 49 is a view for explaining the flow of a multiangle video stream and its display timing;

FIG. 50 is a view for explaining the flow of a multiangle video stream and its seamless movie display timing;

FIG. 51 is a block diagram for explaining the circuit arrangement that can realize seamless multi-screen display of multiangle scenes;

FIGS. 52A to 52D are views for explaining n-divided (four- or nine-divided) reduced-scale or shrunk display examples for performing multiangle display (digest display);

FIG. 53 is a flow chart for explaining an example of the processing sequence of the n-divided reduced-scale display exemplified in FIG. 42 or FIGS. 52A to 52D;

FIG. 54 is a flow chart for explaining an example of the processing sequence of seamless n-divided reduced-scale movie display;

FIG. 55 is a flow chart for explaining another example of the processing sequence of n-divided reduced-scale display shown in FIG. 42 or FIGS. 52A to 52D;

FIG. 56 is a flow chart for explaining synchronization between video and audio signals in a portion where system time clocks STC become discontinuous upon executing n-divided reduced-scale display shown in FIG. 42 or FIGS. 52A to 52D;

FIG. 57 is a flow chart for explaining an example of the processing sequence for performing multiangle simultaneous display (digest display) without synchronizing video and audio signals;

FIG. 58 is a flow chart for explaining an example for independently processing the four- and nine-divided display modes in the processing sequence of n-divided (four- or nine-divided) reduced-scale display shown in FIGS. 52A to 52D;

FIG. 59 is a view for explaining the correspondence between the recording pattern (interleaved arrangement of a video stream including a plurality of angles) of angle blocks on a disk, and a plurality of angle data which have been rearranged based on the time axis or with time alignment;

FIG. 60 is a view for explaining angle switching when system time clocks STC are continuous;

FIG. 61 is a view for explaining angle switching when system time clocks STC are not continuous;

FIG. 62 is a view for explaining the correspondence between the movie display timings of the respective angles and MPEG temporal reference upon executing n-divided reduced-scale display shown in FIG. 42 or FIGS. 52A to 52D;

FIG. 63 is a block diagram for explaining the overall arrangement of a playback apparatus with a built-in multiangle automatic switching/playback system (or auto-angle playback system) according to an embodiment of the present invention; and

FIG. 64 is a block diagram for explaining a case wherein a multiangle (multiscene) automatic switching/playback system or a multiangle (multiscene) digest display system is built using a versatile personal computer.

### DETAILED DESCRIPTION OF THE INVENTION

A multi-screen display system and multiangle automatic switching system according to an embodiment of the present invention, and the physical and logical arrangements of an information recording medium used in these systems will be described below with reference to the accompanying drawings. Note that common reference numerals denote portions with common functions throughout a plurality of drawings so as to avoid repetitive descriptions.

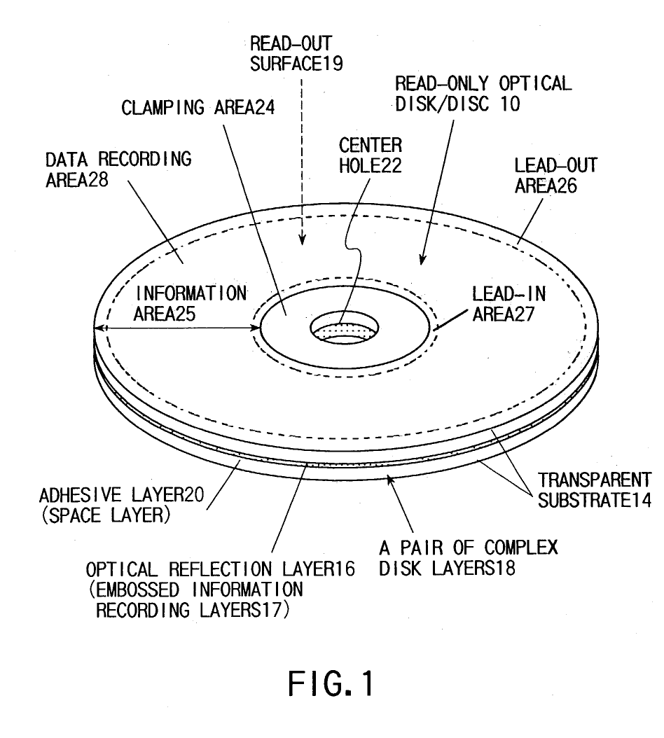

FIG. 1 is a perspective view for explaining the physical structure of an optical disk (read-only DVD video disk) that can be used in the present invention.

As shown in FIG. 1, this optical disk 10 comprises a pair of complex disk layers (single-layers or multilayers) 18, and very thin adhesive (e.g., 40-μm thick ultraviolet setting resin) layer 20 inserted between these complex disk layers 18. Each complex disk layer 18 consists of transparent substrate (e.g., 0.6-mm thick polycarbonate) 14 and recording layer, i.e., optical reflection layer 16 (embossed information recording layers 17 formed by sputtering aluminum, aluminum alloy, gold, or the like). These pair of disk layers 18 are adhered so that their optical reflection layers 16 (embossed information recording layers 17) contact the surfaces of adhesive layer 20, thus obtaining a 1.2-mm thick high-density optical disk.

Optical disk 10 has center hole 22, and clamping areas 24 used for clamping optical disk 10 upon its rotation are formed around the center hole 22 on the two surfaces of the disk. Center hole 22 receives the spindle of a disk motor (not shown) when disk 10 is loaded into an optical disk apparatus. Optical disk 10 is clamped at its clamping areas 24 by a disk clamper (not shown).

Optical disk 10 has information areas 25 that can record video data, audio data, and other information around clamping areas 24 on its two surfaces.

Each information area 25 has lead-out area 26 on its outer periphery side, and lead-in area 27 on its inner periphery side that contacts clamping area 24. The area between lead-out and lead-in areas 26 and 27 is defined as data recording area 28.

On recording layer (optical reflection layer) 16 of information area 25, a recording track serving as data recording area 28 is continuously formed in a spiral pattern. The continuous track is divided into a plurality of physical sectors, which have serial numbers. Various data are recorded on optical disk 10 using these sectors as recording units.

Data recording area 28 on information area 25 serves as an actual data recording area, and records video data (main picture data), sub-picture data, and audio data as similar pit trains (physical shapes or embossed shapes that bring about change in optical conditions).

In read-only optical disk (DVD-ROM disk)-10, pit trains are pre-formed by a stamper on transparent substrate 14, and a reflection layer is formed by deposition or sputtering on the surface of transparent substrate 14 formed with pit trains. The reflection layer (embossed layer) is used as each recording layer 16.

In read-only optical disk 10, no groove serving as a recording track is particularly formed, and pit trains formed on the surface of transparent substrate 14 serve as the track. (The groove is formed on a DVD-RAM disk that can be subjected to recording/playback or read/write.)

Data recorded on optical disk 10 can be played back when the user (viewer) operates a key input unit arranged on the front panel of an optical disk playback apparatus (DVD player; to be described later) or its remote controller. The played-back recording data (main picture data, sub-picture data, and audio data) are converted into audio and video signals in the playback apparatus, and are played back as video pictures and audio after they are sent to an external monitor and loudspeaker.

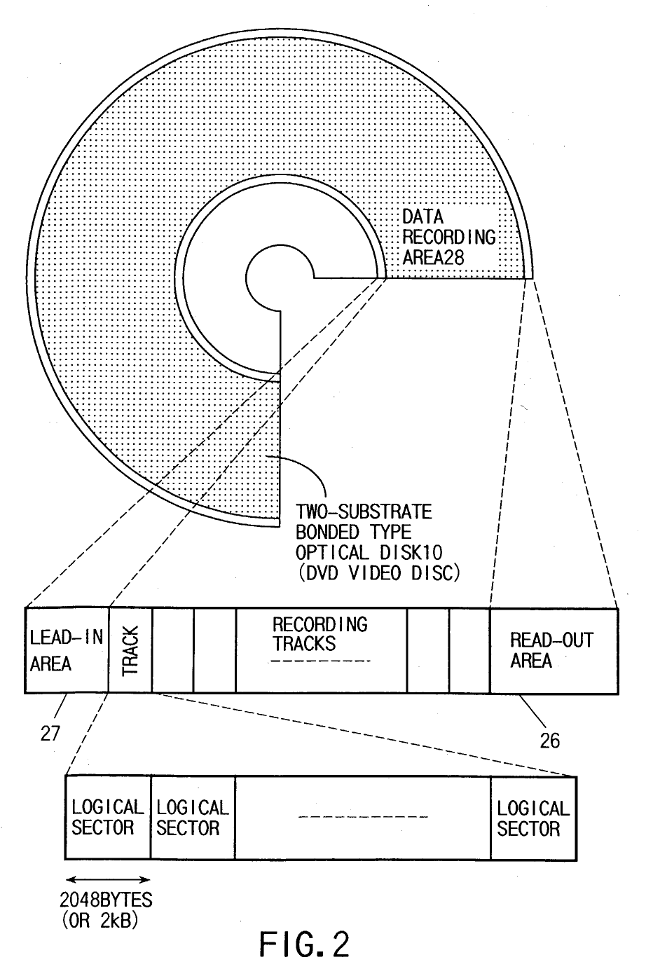

FIG. 2 is a plan view for explaining the track/sector structure of the recording area on the optical disk (read-only DVD-ROM disk) shown in FIG. 1.

Optical disk 10 is a two-substrate bonded type optical disk having a storage capacity of 4.7 GB per side, and a large number of recording tracks are formed on each data recording area 28 between lead-in area 27 on the disk inner periphery side to lead-out area 26 on the disk outer periphery side. Each track is made up of a large number of logical sectors, each storing various kinds of information (appropriately compressed digital data).

Embossed information recording layers 17 of each information area 25 shown in FIG. 1 normally serve as a data recording area, and are formed with a continuous track in a spiral pattern. The continuous track is divided into a plurality of logical sectors (minimum recording units) each having a given storage capacity, as shown in FIG. 2, and data are recorded with reference to these logical sectors.

The recording capacity per logical sector is determined to be 2,048 bytes (or 2 kbytes) which are equal to one pack data length (to be described later). Data recording area 28 on information area 25 is an actual data recording area, which records management data, main picture data, sub-picture data, and audio data as changes in physical conditions of pits.

In read-only optical disk (DVD-ROM disk) 10, pit trains are pre-formed by a stamper on transparent substrate 14, and a reflection layer is formed by deposition or sputtering on the surface of transparent substrate 14 formed with pit trains. Normally, in read-only optical disk 10, no groove serving as a recording track is particularly formed, and pit trains formed on the surface of transparent substrate 14 serve as the track.

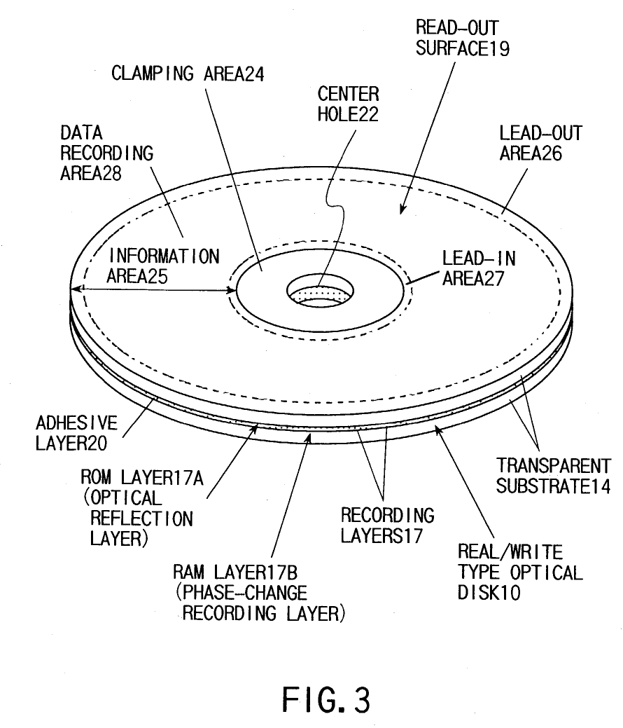

FIG. 3 is a perspective view for explaining the physical structure of an optical disk (read-only or read/write type DVD disk; DVD-RAM/DVD-RW disk or the like) that can be used in the present invention.

As shown in FIG. 3, optical disk 10 has a structure obtained by adhering a pair of transparent substrate 14 having recording layers 17 via adhesive layer 20. Each substrate 14 can consist of 0.6-mm thick polycarbonate layer, and adhesive layer 20 can consist of a very thin (e.g., 40-μm thick) ultraviolet setting resin. The pair of 0.6-mm thick substrates 14 are adhered to each other so that their recording layers 17 contact the surfaces of the adhesive layer 20, thus obtaining 1.2-mm thick large-capacity optical disk 10.

Note that each recording layer 17 can have a ROM/RAM two-layered structure. In this case, ROM layer/optical reflection layer (embossed layer) 17A is formed on the side closer to read-out surface 19, and RAM layer/phase-change recording layer 17B is formed on the side farther from read-out layer 19.

On recording layer (optical recording layer) 17 of each information area 25, a recording track is continuously formed in a spiral pattern. The continuous track is divided into a plurality of physical sectors, which have serial numbers. Various data are recorded on optical disk 10 using these sectors as recording units.

Data recording area 28 is an actual data recording area, and records video data (main picture data) such as a movie, and the like, sub-picture data such as superimposed dialogue, menus, and the like, and audio data such as speech, effect sounds, and the like as similar pit trains (physical shapes or phase conditions that bring about optical changes in laser reflected light) as recording/playback information.

When optical disk 10 is a double-sided recording RAM disk in which each surface has one recording layer, each recording layer 17 can be formed by three layers, i.e., by sandwiching a phase-change recording material layer (e.g., Ge₂Sb₂Te₅) between two zinc sulfide•silicon oxide (ZnS•SiO₂) mixture layers.

When optical disk 10 is a single-sided recording RAM disk in which each surface has one recording layer, recording layer 17 on the side of read-out surface 19 can be formed by three layers including the phase-change recording material layer. In this case, layer 17 on the side opposite to read-out surface 19 need not be an information recording layer but may merely be a dummy layer.

When optical disk 10 is a one-side read type two-layered RAM/ROM disk, two recording layers 17 can comprise a single phase-change recording layer (on the side farther from read-out surface 19; read/write), and a single semi-transparent metal reflection layer (on the side closer to read-out surface 19; read-only).

When optical disk 10 is a write-once DVD-R, a polycarbonate substrate is used, gold can be used as a reflection layer (not shown), and an ultraviolet setting resin can be used as a protection layer (not shown). In this case, an organic dye is used in recording layer 17. As the organic dyes, cyanine, squarilium, chroconic, and triphenylmenthane dyes, xanthene and quinone dyes (naphthoquinone, anthraquinone, and the like), metal complex dyes (phthalocyanine, porphyrin, dithiol complex, and the like), and so forth can be used.

Data can be written on such DVD-R disk using a semiconductor laser having a wavelength of 650 nm and an output of about 6 to 12 mW.

When optical disk 10 is a one-side read type two-layered ROM disk, two recording layers 17 can be comprised of a single metal reflection layer (on the side farther from read-out surface 19) and a single semi-transparent reflection layer (on the side closer to read-out surface 19).

In case of read-only DVD-ROM disk 10, pit trains are pre-formed by a stamper on substrate 14, and a reflection layer of, e.g., a metal, is formed on that surface of substrate 14, which is formed with pit trains. The reflection layer is used as recording layer 17. In such DVD-ROM disk 10, no grooves serving as recording tracks are especially formed, and the pit trains formed on the surface of substrate 14 serve as tracks.

In various types of optical disks 10 described above, read-only ROM information is recorded on recording layer 17 as an embossed pattern signal. By contrast, no such embossed pattern signal is formed on substrate 14 having read/write (or write-once) recording layer 17, and a continuous groove is formed instead. A phase-change recording layer is formed on such groove. In case of read/write DVD-RAM disk, the phase-change recording layer in land portions is also used for information recording in addition to the groove.

When optical disk 10 is of one-side read type (independently of one or two recording layers), substrate 14 on the rear side viewed from read-out surface 19 need not always be transparent to the read/write laser beam used. In this case, a label may be printed on the entire surface of substrate 14 on the rear side.

A DVD digital video recorder (to be described later) can be designed to attain repetitive recording/repetitive playback (read/write) for a DVD-RAM disk (or DVD-RW disk), single recording/repetitive playback for a DVD-R disk, and repetitive playback for a DVD-ROM disk.

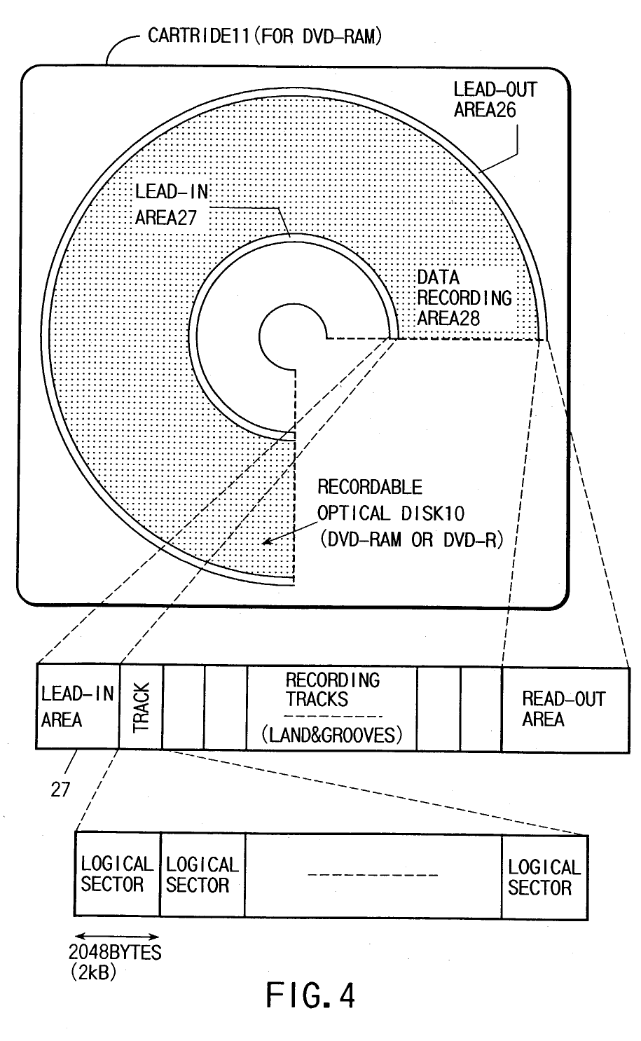

FIG. 4 is a view for explaining the track/sector structure of the recording area on the optical disk (read-only or read/write type DVD disk) shown in FIG. 3.

When disk 10 is a DVD-RAM (or DVD-RW), disk 10 itself is stored in cartridge 11 to protect its delicate disk surface. When DVD-RAM disk 10 in cartridge 11 is inserted into the disk drive of a DVD video recorder (to be described later), disk 10 is pulled out from cartridge 11, is clamped by the turntable of a spindle motor (not shown), and is rotated to face an optical head (not shown).

On the other hand, when disk 10 is a DVD-R or DVD-ROM, disk 10 itself is not stored in cartridge 11, and bare disk 10 is directly set on the disk tray of a disk drive.

Recording layer 17 of information area 25 shown in FIG. 3 is formed with a continuous data recording track in a spiral pattern. The continuous track is divided into a plurality of logical sectors (minimum recording units) each having a given storage capacity, as shown in FIG. 4, and data are recorded with reference to these logical sectors. The recording capacity per logical sector is determined to be 2,048 bytes (or 2 kbytes) which are equal to one pack data length

Data recording area 28 is an actual data recording data, which similarly records management data, main picture (video) data, sub-picture data, and audio data.

Note that data recording area 28 of disk 10 shown in FIG. 3 can be divided into a plurality of ring-shaped (annular) recording areas (a plurality of recording zones). The disk rotational velocity varies in units of recording zones. However, within each zone, a constant linear or angular velocity can be set. In this case, an auxiliary recording area, i.e., spare area (free space) can be provided for each zone. These free spaces in units of zones may collectively form a reserve area for that disk 10.

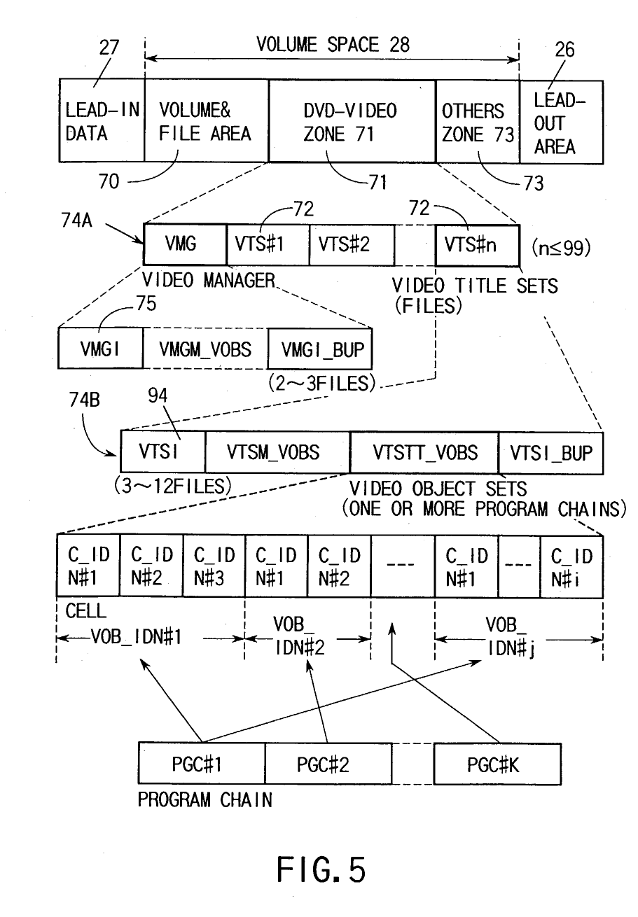

FIG. 5 is a view for explaining the structure of data recorded on optical reflection layer 16 of the optical disk shown in FIG. 1, or ROM layer 17A of the optical disk shown in FIG. 3.

Data recording area 28 formed on optical disk 10 has a volume & file structure, as shown in FIG. 5. The logical format of this structure is defined to comply with, e.g., the UDF (Universal Disk Format) Bridge (a hybrid of the ISO-9660 standard and UDF format) as one of standard formats.

Data recording area 28 between lead-in area 27 and lead-out area 26 is assigned as a volume space, which can include a space for the application of a special format (DVD format), and a space for an application other than that of the special format.

The volume space of data recording area 28 is physically divided into a large number of sectors, and these physical sectors have serial numbers. The logical addresses of data recorded on this volume space (data recording area 28) mean logical sector numbers (LSNs), as defined by the UDF Bridge. The logical sector size in this space is 2,048 bytes (or 2 kbytes) as in the physical sector size. The logical sector numbers (LSNs) are assigned serial numbers in ascending order of physical sector numbers.

Unlike the logical sectors, each physical sector is added with redundant information such as error correction information and the like. For this reason, the physical sector size does not strictly match the logical sector size.

As shown in FIG. 5, the volume space of data recording area 28 has a hierarchical structure, which includes volume & file structure area 70, DVD-video zone 71 consisting of more than one video title sets VTS 72, and others zone 73. These area/zones are split up on the boundaries of logical sectors. Note that one logical sector is defined to be 2,048 bytes, and one logical block is also defined to be 2,048 bytes. Hence, one logical sector is defined equivalently with one logical block.

File structure area 70 corresponds to a management area defined by the UDF Bridge. Based on the description of this area 70, the contents of video manager VMG are stored in a memory of a playback apparatus (DVD player; to be described later).

Video manager VMG consists of a plurality of files 74A, which describe information (video manager information VMGI 75, video object set VMGM_VOBS for video manager menus, and video manager information backup file VMGI_BUP) for managing video title sets (VTS#1 to VTS#n) 72.

Each video title set VTS 72 stores video data (video pack) compressed by a predetermined technique such as MPEG or the like, audio data compressed by a predetermined technique or uncompressed audio data (audio pack), runlength-compressed sub-picture data (sub-picture pack; including bitmap data, each pixel of which is defined by a plurality of bits), and also information for playing back these data (navigation pack; including playback control information/presentation control information PCI and data search information DSI).

Video title set (VTS) 72 is also made up of a plurality of files 74B as in video manager VMG. Each file 74B contains video title set information (VTSI), object set (VTSM_VOBS) for video title set menus, video object sets (VTSTT_VOBS; nine files in maximum) for video title set titles, and backup information (VTSI_BUP) for video title set information.

Assume that the number of video title sets (VTS#1 to VTS#n) is limited to a maximum of 99, and the number of files 74B that make up each video title set VTS) 72 is limited to a maximum of 12. These files 74A and 74B are similarly split up at the boundaries of logical sectors.

Others zone 73 can record other kinds of information that can be used in video title sets (VTS) 72 mentioned above or that do not pertain to video title sets. Others zone 73 is not indispensable, and may be omitted if it is not used.

Each video title set (VTS) 72 shown in FIG. 5 contains a plurality of video object sets (VTSTT_VOBS). The video object sets (VOBS) in each video title set (VTS) 72 include video object sets (VTSM_VOBS) for video title set menus, and video object sets (VTSTT_VOBS) for more than one video title set titles. These video object sets have the same structures except for their purposes.

Each video object set (VTSTT_VOBS) consists of more than one video object units (VOBU), each of which has more than one cells. More than one program chains (PGCs) are recorded using video object set (VTSTT_VOBS) as a set in units of cells. Each of stories in a multi-story program can be constituted in units of PGCs.

Assuming that one PGC corresponds to one drama, a plurality of cells that make up this PGC can correspond to various scenes in that drama. The contents of the PGC (or those of cells) are determined by, e.g., a software provider who produces the contents recorded on disk 10.

Note that each of angles that form a multiangle program is configured in units of cells.

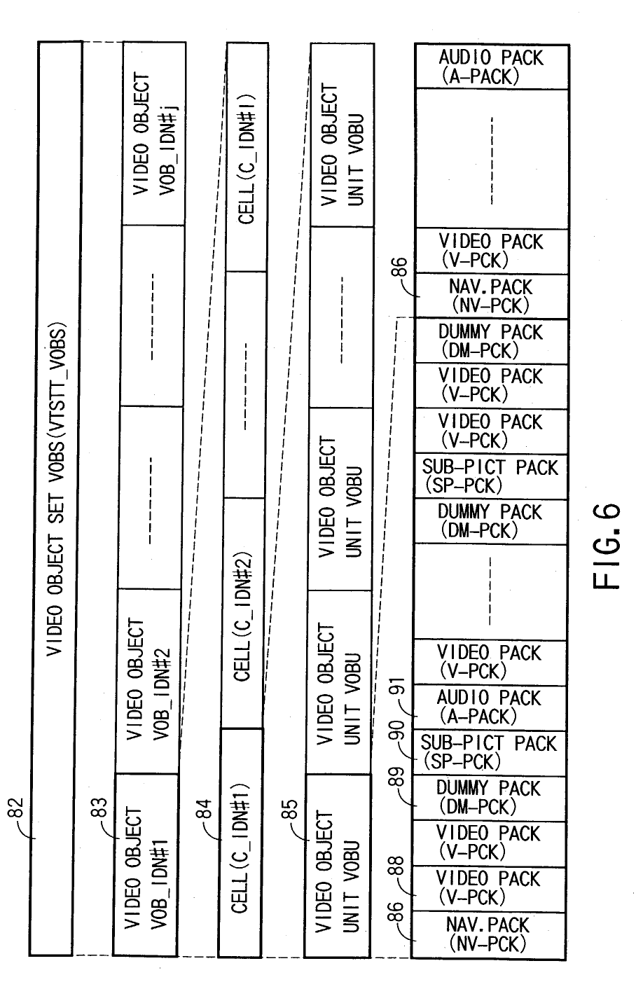

FIG. 6 shows the hierarchical structure of information contained in video object set VTSTT_VOBS shown in FIG. 5.

As shown in FIG. 6, video object set VOBS 82 is defined as a set of more than one video objects VOB 83. Video objects VOB 83 in video object set VOBS 82 are used for the same purpose.

Video object set (VTSM_VOBS) 82 for menus normally consists of single video object 83, which stores a plurality of menu screen display data. By contrast, video object set (VTSTT_VOBS) for a title set normally consists of a plurality of video objects 83.

Taking a concert video title of a certain rock band as an example, video objects 83 that form video object set (VTSTT_VOBS) for a title set correspond to picture data of the performance of that band. In this case, by designating given video object 83, for example, the third tune in the concert of the band can be played back.

Video object 83 that forms video object set (VTSM_VOBS) for menus stores menu data of all the tunes performed in the concert of the band, and a specific tune, e.g., an encore, can be played back according to the menu display.

Note that one video object 83 can form one video object set 82 in a normal video program. In this case, a single video stream comes to an end in single video object 83.

On the other hand, in case of a collection of animations having a plurality of stories or an omnibus movie, a plurality of video streams (a plurality of video chains) can be set in single video object set 82 in correspondence with the respective stories. In this case, the individual video streams are stored in corresponding video objects 83. An audio stream and sub-picture stream pertaining to each video stream end in corresponding video object 83.

Video objects (VOB) 83 are assigned identification numbers (IDN#i; i=0 to i), and that video object 83 can be specified by the identification number. Video object 83 consists of more than one cells 84. A normal video stream consists of a plurality of cells, but a video stream for menus often consists of single cell 84.

The cells are assigned identification numbers (C_IDN#j) as in video objects (VOB) 83, and the cell identification number (C_IDN#j; j=0 to j) can be specified. Upon changing the angle (to be described later), it can be done by specifying the cell number.

Note that the angle change normally means a change in observation angle (camera angle) of the object picture. In case of a rock concert video title, for example, the user can watch scenes from various angles, e.g., a scene that mainly captures a vocalist, a scene that mainly captures a guitarist, a scene that mainly captures a drummer, and the like in a performance scene of an identical tune (identical event).

The angle is changed when the viewer can select angles in accordance with his or her favor, and when an identical scene automatically repeats itself with different angles in the flow of story (if a software producer/provider has programmed the story in such way).

The angles are set in the following cases: temporally discontinuous, non-seamless playback that presents an identical scene of different angles (for example, in a scene at the instance when a certain boxer throws a counterpunch, the camera angle is changed to another angle to play back a scene in which the counterpunch begins to be thrown), and temporally continuous, seamless playback that changes the angle between temporally continuous scenes (for example, at the instance when a certain boxer has made a counterpunch, the camera angle is changed to another angle to play back a scene in which the other boxer who got the punch is blown off).

As shown in FIG. 6, each cell 84 consists of more than one video object units (VOBU) 85. Each video object unit 85 is constituted as a set (pack sequence) of video packs 88, sub-picture packs 90, and audio packs 91 to have navigation pack 86 at the beginning of the sequence. That is, video object unit 85 is defined as a set of all packs recorded from certain navigation pack 86 to a pack immediately before the next navigation pack 86.

Each of these packs serves as a minimum unit for data transfer. The minimum unit for logical processing is a cell, and logical processing is done is units of cells.

Navigation pack 86 is built in each video object unit 85 to realize both angle changes (non-seamless playback and seamless playback).

The playback time of video object unit 85 corresponds to that of video data made up of more than picture groups (groups of pictures; GOPs), and is set to fall within the range from 0.4 sec to 1.2 sec. One GOP is screen data which normally has a playback time of about 0.5 sec in the MPEG format, and is compressed to play back approximately 15 images during this interval.

When video object unit 85 includes video data, a video datastream is formed by arranging GOPs (complying with MPEG) each consisting of video packs 88, sub-picture packs 90, and audio packs 91. However, independently of the number of GOPs, video object unit 85 is defined with reference to the playback time of GOPs, and navigation pack 86 is set at the beginning of unit 85, as shown in FIG. 6.

Even playback data consisting of audio data and/or sub-picture data alone is formed using video object unit 85 as one unit. For example, when video object unit 85 is formed by audio packs 91 alone to have navigation pack 86 at its beginning, audio packs 91 to be played back in the playback time of video object unit 85 to which the audio data belong are stored in that video object unit 85 as in video object 83 of video data.

When a DVD video recorder can record video title set VTS containing video object sets 82 with the structure shown in FIG. 6 on optical disk 10, the user often wants to edit the recording contents after the VTS is recorded. In order to meet such requirement, dummy packs 89 can be appropriately inserted in each video object unit (VOBU) 85. Each dummy pack 89 can be used for recording edit data later.

In a certain recording format of a DVD video recorder, each VOBU 85 is formed without any navigation pack shown in FIG. 6.

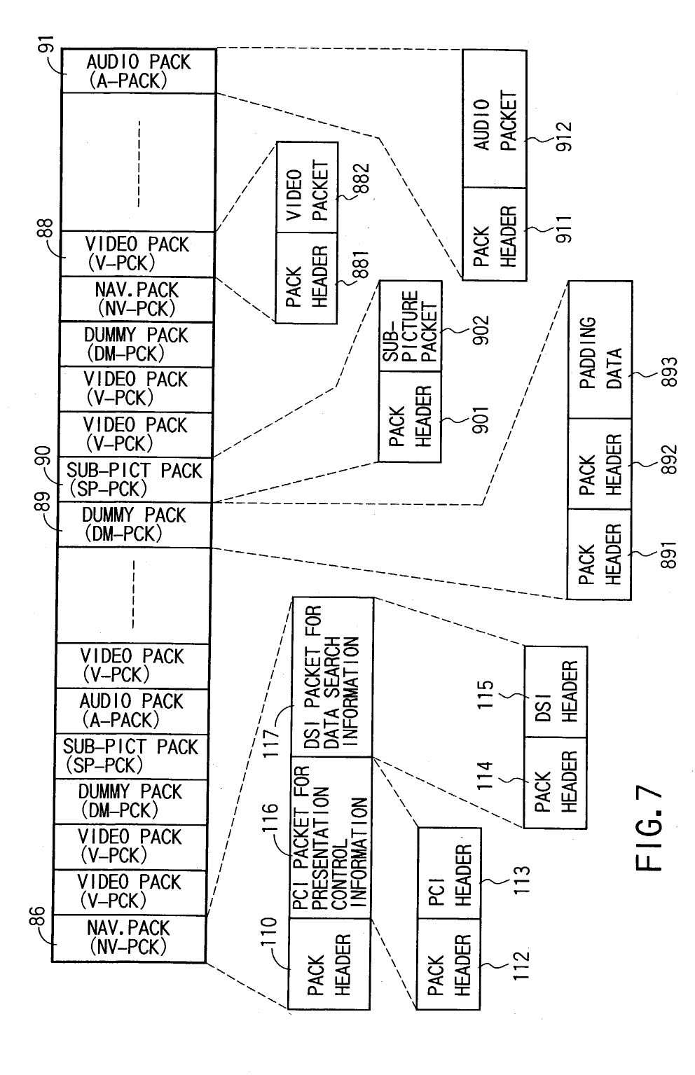

FIG. 7 is a view for explaining the contents of the respective packs (data read out from the disk) included in the video object unit shown in FIG. 6.

FIG. 7 shows a data sequence (pack sequence) in the pack format, which is output after data recorded on the optical disk 10 are read out, and are subjected to signal demodulation and error correction in a disk drive unit.

This pack sequence includes navigation pack (control pack) 86 at its beginning, and then includes video packs, dummy packs, sub-picture packs, audio packs, and the like in a random order. All these packs consist of data in units of 2,048 bytes as in the logical sectors shown in FIG. 2.

Navigation pack 86 includes pack header 110, playback control information/presentation control information (=PCI) packet 116, and data search information (=DSI) packet 117. PCI packet 116 is made up of packet header 112 and PCI data 113, and DSI packet 117 of packet header 114 and DSI data 115. PCI packet 116 contains control data used upon switching the non-seamless angles, and DSI packet 117 contains control data used upon switching the seamless angles.

Note that the angle switching means changes in angle (camera angle) of watching the object picture. In case of a rock concert video title, for example, the user can watch scenes from various angles, e.g., a scene that mainly captures a vocalist, a scene that mainly captures a guitarist, a scene that mainly captures a drummer, and the like in a performance scene of an identical tune (identical event).

The angle is switched (changed) when the viewer can select angles in accordance with his or her favor, and when an identical scene automatically repeats itself with different angles in the flow of story (if the software producer/provider has programmed the story in such way).

The angles are set in the following cases: temporally discontinuous, non-seamless playback that presents an identical scene of different angles (for example, in a scene at the instance when a certain boxer throws a counterpunch, the camera angle is changed to another angle to play back a scene in which the counterpunch begins to be thrown), and temporally continuous, seamless playback that changes the angle between temporally continuous scenes (for example, at the instance when a certain boxer has made a counterpunch, the camera angle is changed to another angle to play back a scene in which the other boxer who got the punch is blown off).

Video pack 88 is comprised of pack header 881 and video packet 882, dummy pack 89 of pack header 891 and padding packet 890, and padding packet 890 of packet header 892 and padding data 893. Note that padding data 893 stores insignificant data.

Sub-picture pack 90 is made up of pack header 901 and sub-picture packet 902, and audio pack 91 of pack header 911 and audio packet 912.

Note that video packet 882 in FIG. 7 contains a packet header (not shown), which records a decode time stamp (DST) and presentation time stamp (PTS). Each of sub-picture packet 902 and audio packet 912 contains a packet header (not shown), which records a presentation time stamp (PTS).

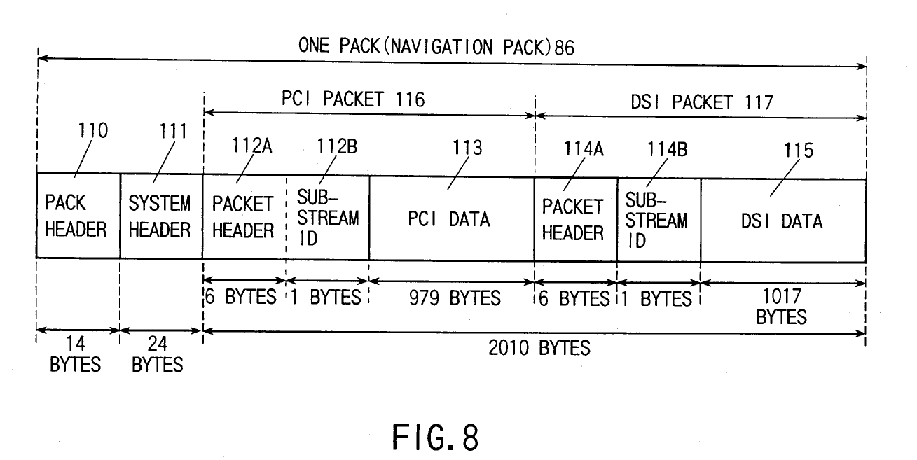

FIG. 8 shows the data structure for one navigation pack shown in FIG. 7.

More specifically, one navigation pack 86 consists of 2,010-byte navigation data including 14-byte pack header 110, 24-byte system header 111, and two packets (116, 117). The two packets that form the navigation data are presentation control information (PCI) packet 116 and data search information (DSI) packet 117 described above.

PCI packet 116 consists of 6-byte packet header 112A, 1-byte sub-stream identifier (sub-stream ID) 112B, and 979-byte PCI data 113. The datastream of PCI data 113 is designated by an 8-bit code “00000000” of sub-stream ID 112B.

DSI packet 117 is constructed by 6-byte packet header 114A, 1-byte sub-stream identifier (sub-stream ID) 114B, and 1,017-byte DSI data 115. The datastream of DSI data 115 is designated by an 8-bit code “00000001” of sub-stream ID 114B.

The data length for one navigation pack 86 with the above structure is 2,048 bytes (2 kbytes) corresponding to one logical sector shown in FIG. 2.

Pack header 110 and system header 111 shown in FIG. 8 are defined by the MPEG2 system layer. More specifically, pack header 110 stores information such as a pack start code, system clock reference (SCR), and multiplexing rate, and system header 111 describes a bit rate and stream ID. Likewise, packet header 112A of PCI packet 116 and packet header 114A of DSI packet 117 each store a packet start code, packet length, and stream ID, as defined by the MPEG2 system layer.

The hierarchical structure of PCI packet 116 and DSI packet 117 stored in navigation pack 86 shown in FIG. 8 can be applied to FIG. 6 as follows (slashes divide adjacent hierarchical levels):

VOBS/VOB/CELL/VOBU/NV-PACK/PCI&DSI

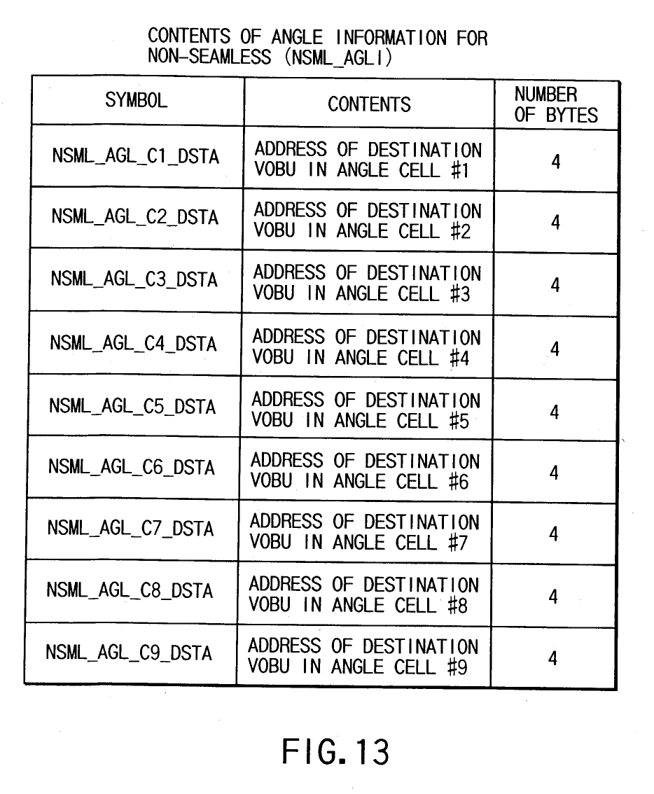

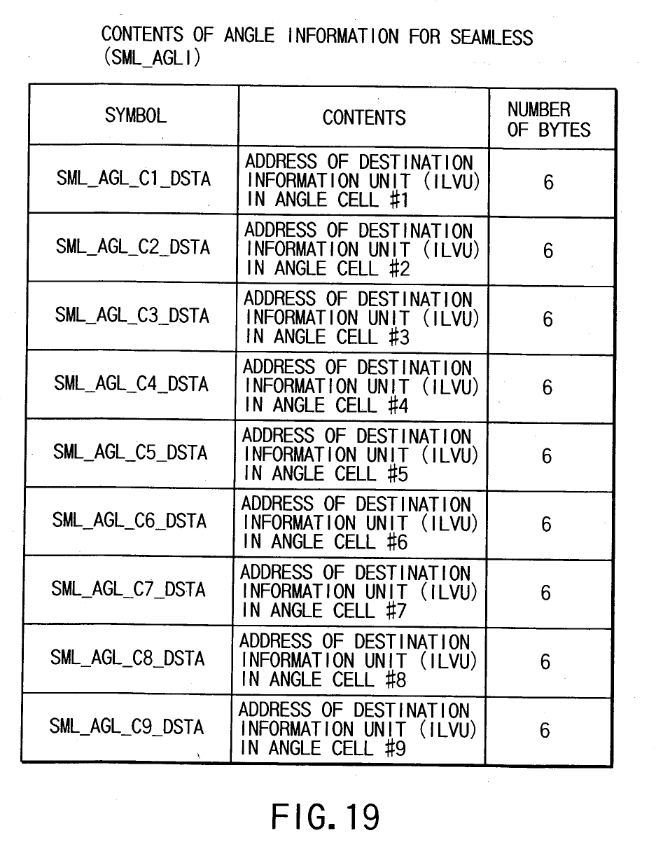

PCI packet 116 located in the lowermost layer of the above-mentioned hierarchical structure stores angle information (NSML_AGLI in FIG. 13) for non-seamless playback (to be described later), and also, DSI packet 117 located in the lowermost layer stores angle information (SML_AGLI in FIG. 19) for seamless playback (to be described later). Upon multiangle playback in this embodiment, required angle information is extracted from PCI packet 116 or DSI packet 117.

Note that dummy pack 89 in FIG. 7 has the following structure. That is, one dummy pack 89 is made up of pack header 891, packet header 892 with a predetermined stream ID, and padding data 893 padded with a predetermined code. (Packet data 892 and padding data 893 form a padding packet). The contents of padding data 893 in a non-used dummy pack are not especially significant. This dummy pack 89 can be appropriately used when the recording contents are to be edited after predetermined recording is done on disk 10 shown in FIG. 4.

For example, a case will be examined below wherein the contents of a video tape that recorded a family trip using a portable video camera are recorded and edited on a DVD-RAM (or DVD-RW) disk 10.

In this case, only the video scenes to be stored in a single disk are selectively recorded on disk 10. These video scenes are recorded in video pack 88. Also, audio data simultaneously recorded by the video camera is recorded in audio pack 91.

Each VOBU 85 that includes video pack 88 and the like has navigation pack 86 at its beginning. As shown in FIG. 7, this navigation pack 86 contains presentation control information PCI and data search information DSI. Using this PCI or DSI, the playback procedure of each VOBU can be controlled (for example, discontinuous scenes can be automatically connected or a multiangle scene can be recorded).

After the contents of the video tape are edited and recorded on disk 10, when a voice, effect sound, and the like are to be postrecorded in each scene in units of VOBU or a background music (BGM) is added, such postrecorded audio data or BGM can be recorded in dummy pack 89. When a comment for the recorded contents is to be added, sub-pictures such as additional characters, figures, and the like can be recorded in dummy pack 89. Furthermore, when an additional video picture is to be inserted, the inserted video picture can be recorded in dummy pack 89.

The above-mentioned postrecorded audio data or the like is written in padding data 893 of dummy pack 89 used as an audio pack. The additional comment is written in padding data 893 of dummy pack 89 used as a sub-picture pack. Similarly, the inserted video picture is written in padding data 893 of dummy pack 89 used as a video pack.

More specifically, dummy pack 89 is a wildcard pack that can become any of an audio, sub-picture, and video packs depending on its purpose.

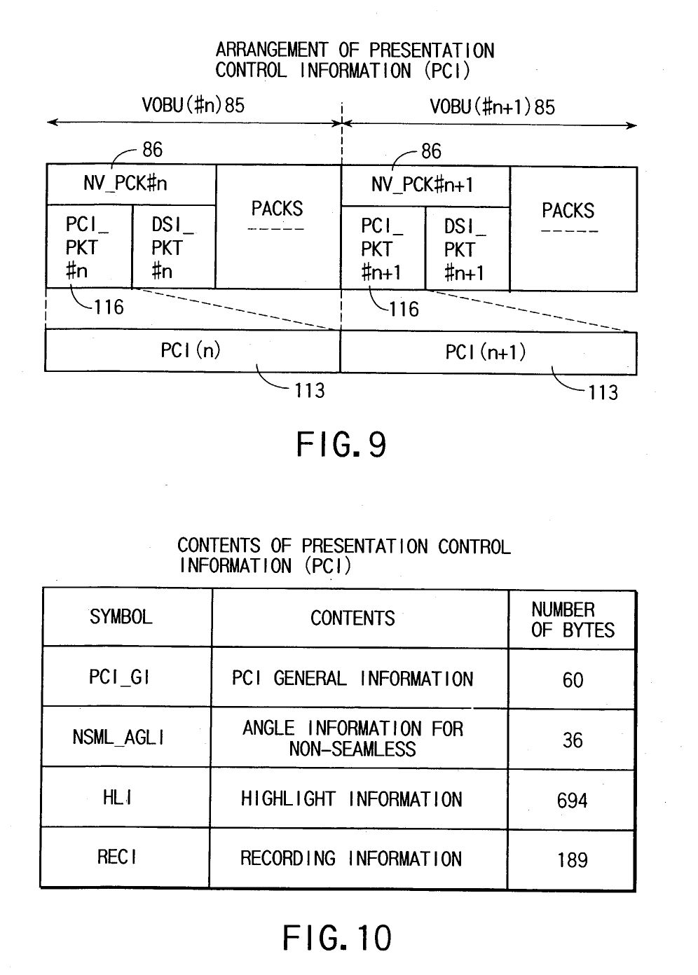

FIG. 9 shows PCI packet 116 included in navigation pack 86 located at the beginning of each VOBU 85. As shown in FIG. 9, PCI packet 116 includes presentation control information PCI (PCI data) 113 used for changing the display or playback contents (presentation contents) in synchronism with the playback state of video data in video object unit (VOBU) 85.

Navigation pack (NV_PCK) 86 can be set immediately before a video pack that includes the first data in video object unit (VOBU#n) or the corresponding group of pictures (GOP) shown in FIG. 9 (in FIG. 6, video pack 88 located at the second position from the left end in the lowermost column). When video object unit 85 does not contain any video pack, navigation pack 86 is set at the beginning of an object unit that includes the first audio pack or sub-picture pack in the corresponding GOP. In this case, navigation pack 86 need only be set at the beginning of video object unit 85.

Even when video object unit 85 does not include any video pack, the playback time of the video object unit is determined with reference to the playback unit of video data as in a case wherein the video object unit includes video packs.

Note that the group of pictures (GOP) is a data sequence for a plurality of continuous frames, which is compressed by MPEG. When this compressed data is expanded, a plurality of continuous frames of image data are obtained, and a movie can be played back using these image data.

FIG. 10 shows the contents of presentation control information (PCI data) 113 shown in FIG. 9. PCI data 113 includes 60-byte PCI general information (PCI_GI), 36-byte non-seamless playback angle information (NSML_AGLI), 694-byte highlight information (HLI), and 189-byte recording information (RECI). This recording information (RECI) can contain a copyright management code (ISRC) of the international standard.

Highlight information HLI is used upon execution of the following highlight processing. More specifically, the MPU (or CPU) of a playback apparatus (DVD video player; to be described later) reads highlight information HLI, and detects the X-/Y-coordinate values, colors, contrast values, and the like of rectangular regions (highlight buttons) displayed by sub-picture data. The MPU of the DVD video player highlights the displayed menu selection item and the like in accordance with these detected data. This highlight processing is used as a means for allowing the user to easily recognize a specific displayed item on the visual user interface. More specifically, when a DVD video title recorded on optical disk 10 is a multilingual compatible program, a specific spoken language (e.g., English) and a specific superimposed dialogue language (e.g., Japanese) are selected by highlight buttons which are displayed to be visually outstanding by the highlight processing.

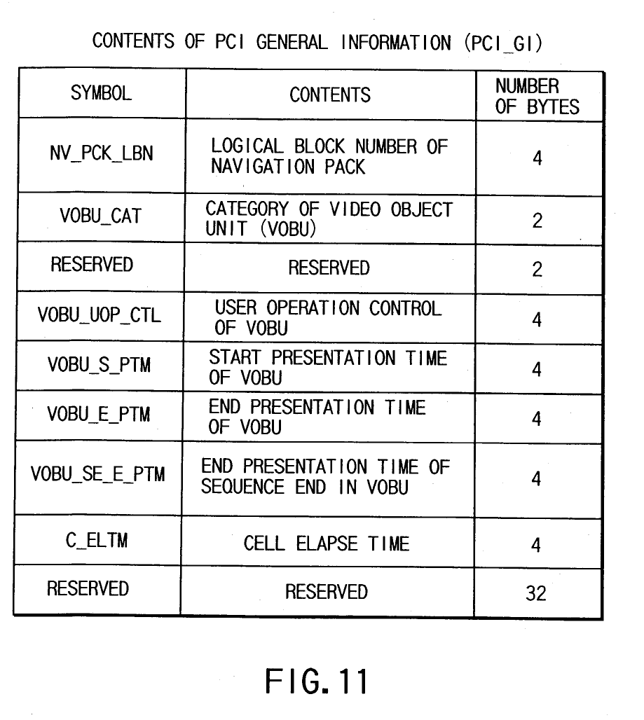

FIG. 11 shows the contents of PCI general information PCI_GI.

PCI general information PCI_GI describes the logical block number (NV_PCK_LBN) of a navigation pack, the category (VOBU_CAT) of a video object unit (VOBU), user operation control (VOBU_UOP_CTL) of the video object unit (VOBU), the start presentation time (VOBU_S_PTM) of the video object unit (VOBU), the end presentation time (VOBU_E_PTM) of the video object unit (VOBU), the end presentation time (VOBU_SE_PTM) of the sequence end in the video object unit (VOBU), and a cell elapse time (C_ELTM).

Note that the logical block number (NV_PCK_LBN) represents the address (recording location) of a navigation pack including the presentation control information (PCI) by the number of relative blocks from the first logical block in the video object set (VOBS) which includes that PCI.

The category (VOBU_CAT) describes the contents of copy protection of an analog signal corresponding to video and sub-picture data in the video object unit (VOBU) that includes the presentation control information (PCI).

The user operation control (VOBU_UOP_CTL) describes user operations which are prohibited during the display (presentation) period of the video object unit (VOBU) that includes the presentation control information (PCI).

The start presentation time (VOBU_S_PTM) describes the start time of display (presentation) of the video object unit (VOBU) that includes the presentation control information (PCI). More specifically, this VOBU_S_PTM indicates the start display time of the first picture in the display order of the first GOP in the video object unit (VOBU).

The end presentation time (VOBU_E_PTM) describes the end time of display (presentation) of the video object unit (VOBU) that includes the presentation control information (PCI). More specifically, this VOBU_E_PTM indicates the end display time of the last picture in the display order of the last GOP in the video object unit (VOBU).

On the other hand, when no video data is present in the video object unit (VOBU), or when playback of that video object unit (VOBU) is stopped, this VOBU_E_PTM indicates the end time of virtual video data aligned to the time grids at a field interval (1/60 sec in case of NTSC video).

The end presentation time (VOBU_SE_PTM) describes the end time of display (presentation) based on a sequence end code in video data in the video object unit (VOBU) that includes the presentation control information (PCI). More specifically, this end time indicates the end display time of the last picture in the display order, which picture includes the sequence end code, in the video object unit (VOBU). If no picture with a sequence end code is present in the video object unit (VOBU), 00000000h (h is an abbreviation for hexadecimal) is set in VOBU_SE_PTM.

The cell elapse time (C_ELTM) describes the relative display time from the first video frame in the display order of a cell that includes the presentation control information (PCI) to the first video frame in the display order of video object unit (VOBU) that includes the PCI in hours, minutes, and seconds in the BCD format and frames. When no video data is present in the video object unit (VOBU), the first video frame of the virtual video data is used as the video frame.

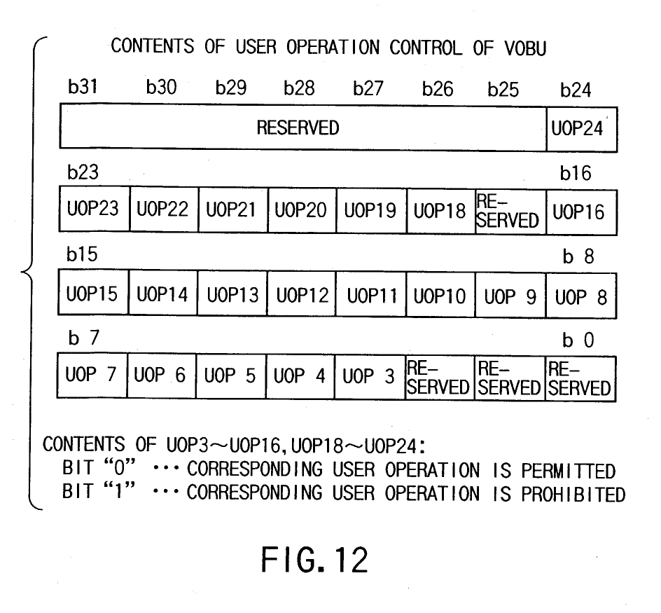

FIG. 12 is a view for explaining the contents of VOBU user operation control VOBU_UOP_CTL shown in FIG. 11.

This user operation control VOBU_UOP_CTL consists of 4 bytes (32 bits), and determines permission/prohibition of specific operation in the VOBU, which is being played back, using user operation prohibition flags UOP3 to UOP16 and UOP18 to UOP24 contained in these bits. More specifically, when the contents of each user operation prohibition flag bit (UOP3 to UOP16; UOP18 to UOP24) are 0b, the flag indicates that corresponding user operation is permitted; if the bit contents are 1b, the flag indicates that corresponding user operation is prohibited.

User operation control VOBU_UOP_CTL that describes the user operation prohibition flag bits (UOP3 to UOP16; UOP18 to UOP24) in video object unit VOBU is embedded in the lower layer of video title set VTS shown in FIG. 5.

More specifically, as shown in FIG. 6, video object set VOBS 82 contained in video title set VTS contains navigation pack 86 (FIG. 8), which contains presentation control information PCI (FIG. 9), which contains PCI general information PCI_GI (FIG. 10), which contains user operation control VOBU_UOP_CTL (FIG. 11). In this way, the user operation prohibition flag bits (UOP3 to UOP16; UOP18 to UOP24) can be obtained by following the layer paths:

VTS/VOBS/NV_PCK/PCI/PCI_GI/VOBU_UOP_CTL.

FIG. 13 shows the contents of non-seamless angle information NSML_AGLI shown in FIG. 10. As shown in FIG. 13, angle information (NSML_AGLI) describes the start addresses (NSML_AGL_C#n_DSTA) of destination angle cells (cells that form switching destination angles; AGL_C#n) in correspondence with the number #n of multiangles that form the angle block.

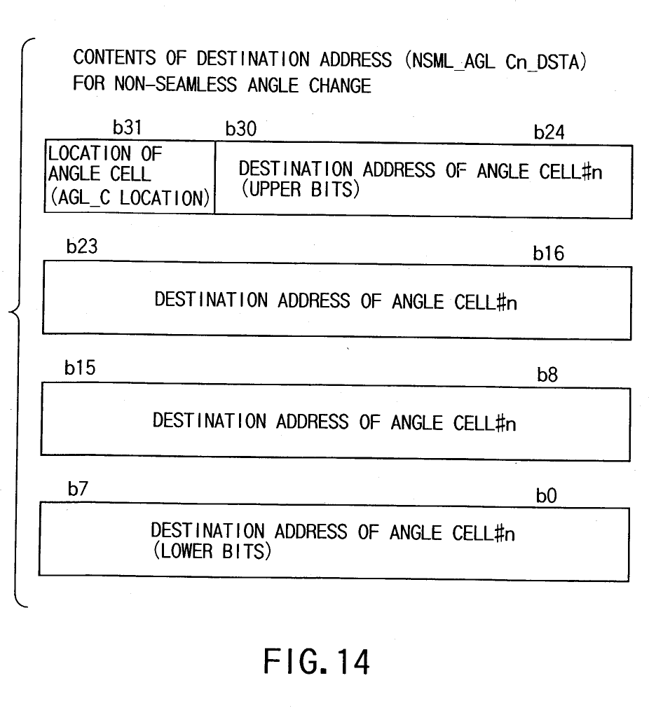

FIG. 14 shows the contents of non-seamless angle change cell destination address NSML_AGL_Cn_DSTA shown in FIG. 13. This destination address (NSML_AGL_C#n_DSTA) describes the start address of the video object unit (VOBU) in the destination angle cell (AGL_C#n) by the relative number of logical blocks from the logical block in the navigation pack that contains the presentation control information (PCI), and has a 32-bit (4-byte) configuration, as shown in FIG. 14.

More specifically, the first 1 byte forms the lower 8 bits of the angle cell (AGL_C#n), the next two bytes form intermediate the 8+8 bits of the angle cell (AGL_C#n), the next 7 bits form the upper 7 bits of the angle cell (AGL_C#n), and the last 1 bit (32nd bit) is used as a location flag (AGL_C location) of the angle cell.

The location flag (AGL_C location) of the angle cell describes if the destination is located before a navigation pack (NV_PCK) that includes the presentation control information (PCI). More specifically, if the flag (AGL_C location) is 0b (binary 0), it indicates that the destination is located after the navigation pack; if the flag is 1b, it indicates that the destination is located before the navigation pack or is the navigation pack itself.

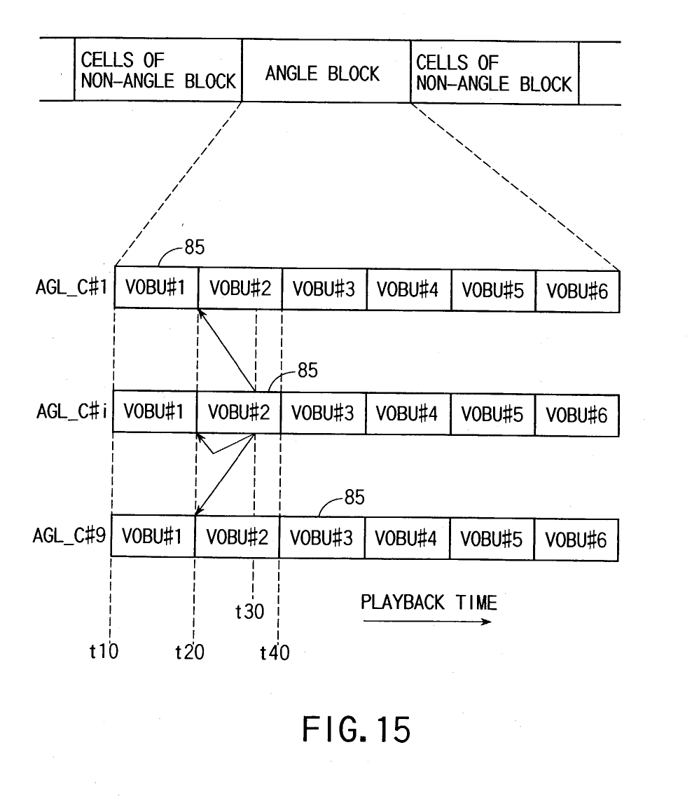

FIG. 15 is a view for explaining the process of non-seamless angle change in the angle block formed by a plurality of multiangle cells.

The start playback (presentation) time of the video object unit (VOBU) in the destination cell is selected to be either the same time (t20 in FIG. 15) as the start playback time of the VOBU that contains the presentation control information (PCI) or the start time (t10 in FIG. 15) of the immediately preceding VOBU.

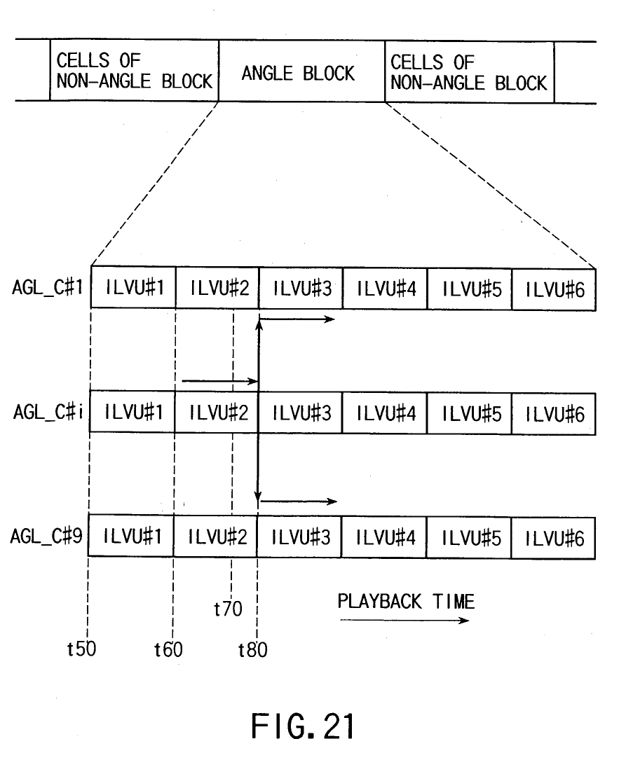

As will be described later, in angle change seamless playback using DSI data 115 shown in FIG. 8, the start playback (presentation) time of the video object unit (VOBU) in the destination cell is selected to be the playback time (t80 in FIG. 21) of the first VOBU in the interleaved unit immediately after angle change has been done (t70 in FIG. 21).

Each angle cell (AGL_C#i; i=1 to n) controlled by PCI data 113 can be changed in units of video object units (VOBU) 85 (corresponding to 0.4 sec to 1.2 sec in playback time). In FIG. 15, video object units (VOBU) 85 are assigned serial numbers #n in accordance with the playback order.

Angle cells (AGL_C#i; i=1 to n) are located parallel to each other in the flow of playback time. Also, in the positional relationship with cells other than those in the angle block, each cell in the angle block is located in series with the previous and next cells in the flow of playback time.

Video object unit (VOBU#n; n=1 or 2) 85 in another angle cell (AGL_C#1 or AGL_C#9) corresponding to playback number #n (e.g., n=2) of a certain angle cell (AGL_C#i) stores another angle data (VOBU#2) at the same time (t20) as that of video object unit (VOBU#2) with playback number #2 or another angle data (VOBU#1) which is closest to and located before (t10) that unit.

For example, assume that video object units VOBU#n 85 are continuously set in certain angle cell (AGL_C#i) as video data that can present a series of pitching/hitting motions in the whole shot including a pitcher and hitter. On the other hand, video object units VOBU 85 are continuously set in another angle cell (AGL_C#1) 84 as video data that can present the hitter alone on the screen to watch the hitting form. Also, video object units VOBU 85 are continuously set in still another angle cell (AGL_C#9) 84 as video data that can present only a closeup shot of the pitcher's face on the screen.

Assume that the viewer changes the playback angle to angle cell #1 at the instance when the hitter has struck the pitch while watching video data of angle cell #i (AGL_C#i). That is, the camera angle is changed to the one that presents the hitter alone at the instance when the hitter has made a hit. Then, the angle is changed to not a scene after the hitter has struck the pitch but a scene immediately before he begins to swing the bat (the time flow goes back about 0.4 sec to 1.2 sec within one VOBU).

On the other hand, when the viewer changes the angle to angle cell #9 at the instance when the hitter has struck the pitch while watching video data of angle cell #i (AGL_C#i), i.e., when the playback angle is changed to the camera angle that presents the pitcher alone at the instance when the hitter has struck the pitch, the look of the pitcher at the instance of hitting is displayed on the screen, and the viewer can watch psychological changes of the pitcher.

By describing the start addresses (NSML_AGL_C#n_DSTA) of angle cells in such way, the following angle change (discontinuous non-seamless playback in which the time flow in the development of the story goes back) can be realized.

The non-seamless angle change for a series of scenes from when pitcher A pitches and then hitter B strikes until that ball has gone over the fence of the ballpark (home run) in a baseball game will be explained below.

In FIG. 15, assume that the respective angle cells (AGL_C#i; i=1 to 9) contain video information obtained by taking an identical event in which hitter B homers the pitch by pitcher A in various camera angles. For example, angle cell AGL_C#1 contains video information obtained by a camera set in the infield stand on the first base side, angle cell AGL_C#i (e.g., i=5) contains video information obtained by a camera set behind the backstop, and angle cell AGL_C#9 contains video information obtained by a camera set to capture hitter A from the center field side over the back of pitcher B.

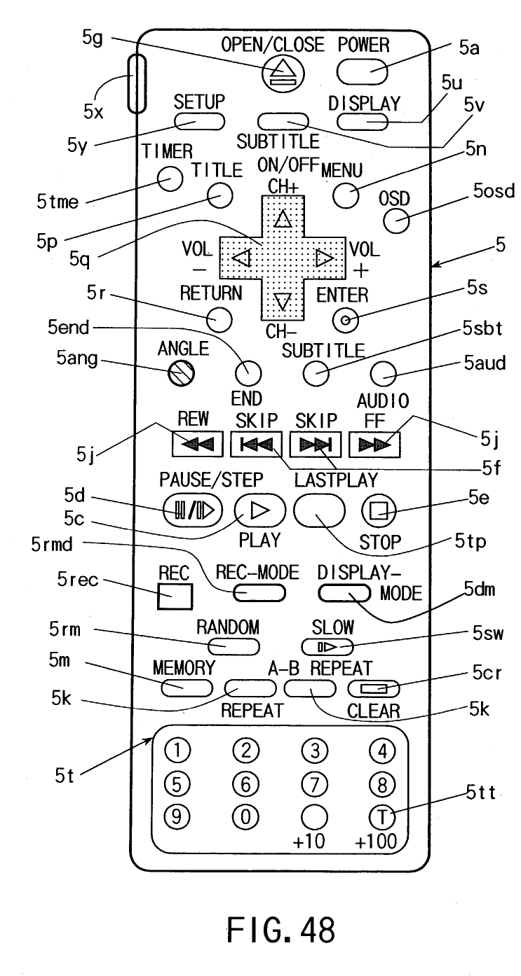

Assume that the viewer (apparatus user) who is observing the contents of DVD disk 10 including the above-mentioned angle cell (AGL_C#i; i=5) using a playback apparatus (DVD player; to be described later) has noticed by a flickering angle mark (not shown) that an angle change is currently available, and has switched the playback angle from #5 to #9 using angle button 5ang and one of number buttons (ten-key pad) 5t of remote controller 5 (which will be described later with reference to FIG. 48). (At that time, for example, the image which is being played back freezes at the instance of depression of angle button 5ang so as to pause the movie playback state.)

After that, when the viewer has pressed angle button 5ang to start the angle change playback (time t30 in FIG. 15), the system CPU of the playback apparatus (DVD player) looks up the angle information (NSML_AGLI) shown in FIG. 13 to obtain the destination address of cell number #9 (in this case, the start address of VOBU#2). Then, the CPU plays back the video information (VOBU#2 and the subsequent video object units) of angle #9 recorded on DVD disk 10 from time t20. (The image of angle #5 frozen so far is switched to that of angle #9 to start movie playback.)

Assuming that VOBU#2 and the subsequent video object units in FIG. 15 contain video data after the bat of hitter B has met the pitch, a picture at the instance when the bat strikes the pitch in the camera angle (#5) from the camera behind the backstop is switched to a picture at the instance when the bat strikes the pitch in the camera angle from the center field side, and scenes until the ball flies into the outfield stand are then played back.

On the other hand, assume that the viewer has switched the playback angle from #5 to #1 using angle button 5ang and number buttons (ten-key pad) 5t of remote controller 5.

After that, when the viewer has pressed angle button 5ang to start the angle change playback (time t30 in FIG. 15), the system CPU of the playback apparatus (DVD player) looks up the angle information (NSML_AGLI) shown in FIG. 13 to obtain the destination address of cell number #1 (in this case, the start address of VOBU#1). Then, the CPU plays back the video information (VOBU#1 and the subsequent video object units) of angle #1 recorded on DVD disk 10 from time t10. The destination address in this case is determined depending on the addresses written in the information table shown in FIG. 13 by the provider (software producer) of DVD disk 10.

Assuming that VOBU#1 and the subsequent video object units in FIG. 15 contain picture data immediately before pitcher A pitches toward hitter B, a picture at the instance when the bat strikes the pitch in the camera angle (#5) from the camera behind the backstop is switched to a picture immediately before the pitcher throws the ball that will result in a home run in the camera angle (#1) from the infield stand on the first base side. Then, the viewer can watch scenes from when pitcher A pitches from the right side of the screen and hitter B on the left side of the screen hits the pitch, until the ball flies into the right field stand on the right side of the screen.

If a cell address before VOBU#1 of angle cell AGL_C#l is written in NSML_AGL_C1_DSTA in the information table shown in FIG. 13, another angle from a time before time t10 can also be played back upon switching from angle #i to angle #1. (In this case, non-seamless angle change in which time goes back 1 sec or more can be implemented.)

When time is to go back largely upon angle change, a search with a larger time unit may be combined with the angle change in units of VOBUs. For example, angle switching can be done during playback of the angle cell (#5) in video object (VOB_IDN2) 83 in FIG. 6 to start playback from the camera angle of another angle cell (#9) in another video object (VOB_IND1) (if it is requested).

In any case, in the example shown in FIG. 15, since the playback time (the time flow in development of the story) goes back upon angle switching, temporally discontinuous, non-seamless playback is attained.

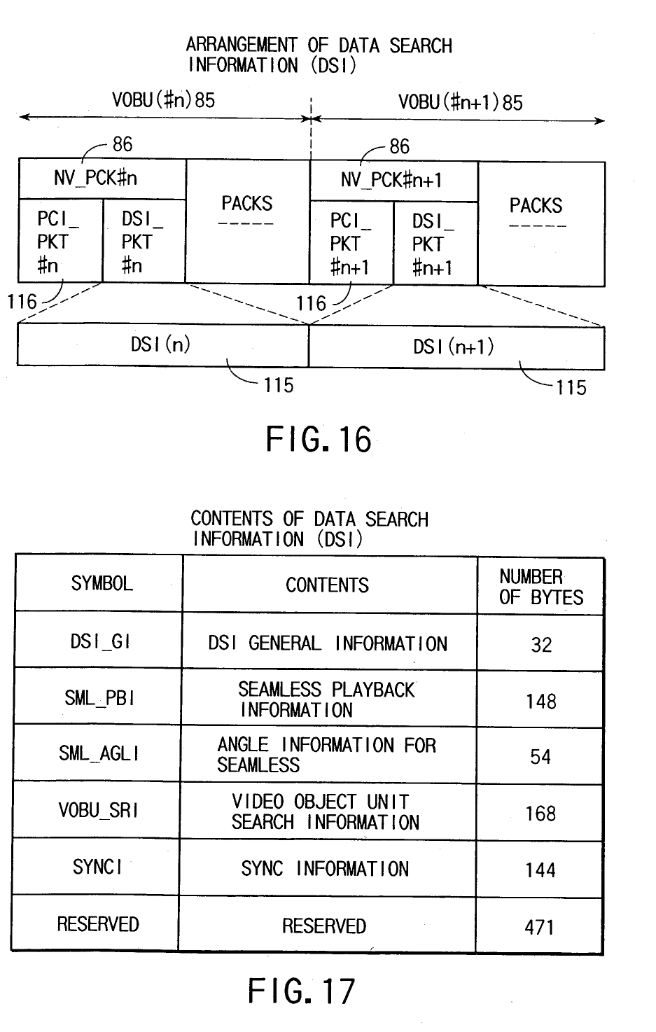

FIG. 16 is a view for explaining the data arrangement of data search information DSI shown in FIG. 8. DSI packet 117 shown in FIG. 8 includes DSI data (DSIn) 115 as navigation data used for searching video object unit (VOBU#n) 85, as shown in FIG. 16.

FIG. 17 shows the contents of data search information DSI shown in FIG. 16. As shown in FIG. 17, DSI data 115 contains 32-byte DSI general information (DSI_GI), 148-byte seamless playback information (SML_PBI), 54-byte seamless playback angle information (SML_AGLI), 168-byte video object unit search information (VOBU_SRI), and 144-byte sync playback information (SYNCI).

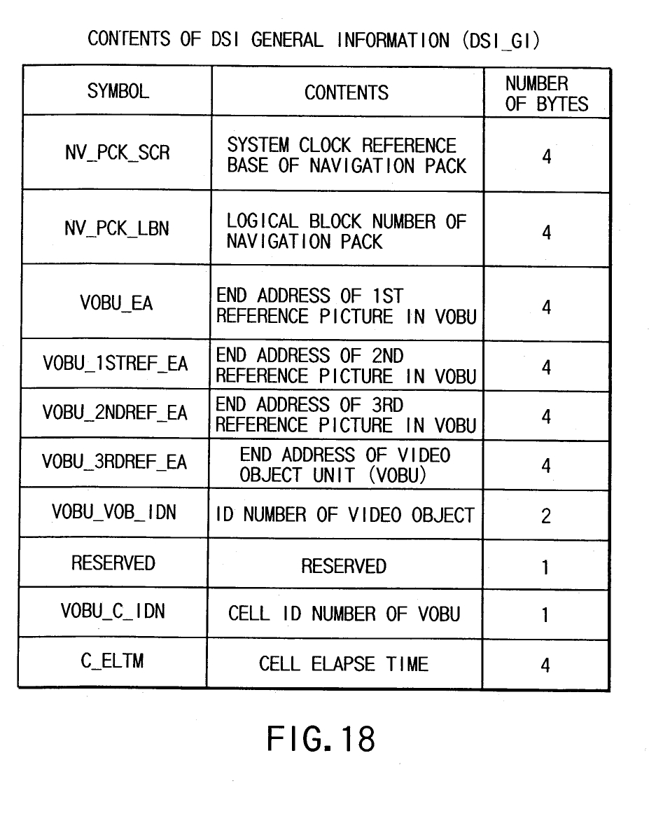

FIG. 18 shows the contents of DSI general information DSI_GI shown in FIG. 17. The DSI general information (DSI_GI) describes information pertaining to DSI data 115 as a whole, as shown in FIG. 18. More specifically, the DSI general information (DSI_GI) describes a system clock reference look-up value (NV_PCK_SCR) (SCR is an abbreviation for system clock reference) of navigation pack 86 at its beginning.

The system clock reference look-up value (NV_PCK_SCR) is loaded into a system time clock (STC; not shown) built in the playback apparatus (DVD player; to be described later). In the playback apparatus, video, audio, and sub-picture packs are respectively decoded by video, audio, and sub-picture decoders with reference to this STC, and the decoded pictures and sounds are played back via a monitor and loudspeaker.

The DSI general information (DSI_GI) describes a navigation pack logical block number (NV_PCK_LBN) which expresses the address (start address) of navigation pack 86 that contains this DSI packet by the relative number of logical blocks (RLBN) from the first logical block in video object set 82 that includes DSI packet 117.

Also, the DSI general information (DSI_GI) describes a video object unit end address (VOBU_EA) which expresses the address of the last pack in video object unit 85 that contains DSI packet 117 by the relative number of logical blocks (RLBN) from the first logical block in that video object unit 85.

Furthermore, DSI general information (DSI_GI) describes a video object unit first reference picture end address (VOBU_{—}1STREF_EA), which expresses the address of video packet 88 that records the last data of the first encoded reference picture (first I-picture) coming after DSI packet 117 by the relative number of logical blocks (RLBN) from the first logical block in video object unit 85 that records that DSI packet 117. If this video object unit 85 does not contain any I-picture (or any video data), 00000000h is written in this VOBU_{—}1STREF_EA.

Moreover, the DSI general information (DSI_GI) describes a video object unit second reference picture end address (VOBU_{—}2NDREF_EA), which expresses the address of video packet 88 that records the last data of the second encoded reference picture (I- or P-picture; normally, first P-picture) coming after DSI packet 117 by the relative number of logical blocks (RLBN) from the first logical block in video object unit 85 that records that DSI packet 117. If this video object unit 85 does not contain second reference picture, 00000000h is written in this VOBU_{—}2NDREF_EA.

In addition, the DSI general information (DSI_GI) describes a video object unit third reference picture end address (VOBU_{—}3RDREF_EA), which expresses the address of video packet 88 that records the last data of the third encoded reference picture (I- or P-picture; normally, second P-picture) coming after DSI packet 117 by the relative number of logical blocks (RLBN) from the first logical block in video object unit 85 that records that DSI packet 117. If this video object unit 85 does not contain third reference picture, 00000000h is written in this VOBU_{—}3RDREF_EA.

Note that a video object unit (VOBU) normally contains some groups of pictures (GOPs). In this case, the second and third reference pictures may belong to a GOP other than that the first reference picture belongs. In such case, the end addresses (VOBU_{—}2NDREF_EA and VOBU_{—}3RDREF_EA) are calculated across the boundary between adjacent GOPs.

Also, the DSI general information (DSI_GI) describes the identification number (VOBU_VOB_IDN) of video object 83 that contains DSI packet 117.

Furthermore, the DSI general information (DSI_GI) describes the identification number (VOBU_C_IDN) of cell 84 that contains DSI packet 117.

Moreover, the DSI general information (DSI_GI) describes a cell elapse time (C_ELTM) with the same contents as the cell elapse time (C_ELTM) in the table of PCI general information (PCI_GI) shown in FIG. 11.

FIG. 19 shows the contents of seamless angle information SML_AGLI shown in FIG. 17. The seamless playback angle information (SML_AGLI) shown in FIG. 19 describes the addresses of destination angle cells as in the non-seamless playback angle information (NSML_AGLI) of PCI data 113.

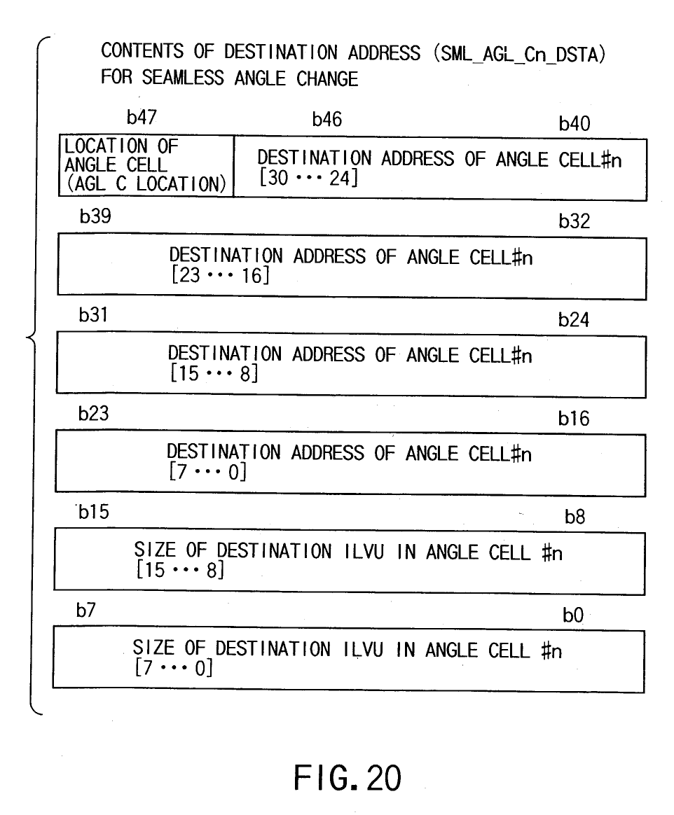

As shown in FIG. 19, the angle information (SML_AGLI) describes seamless angle cell destinations (SML_AGL_Cn_DSTA) each of which indicates the start address and cell size of a destination angle cell (AGL_C#n) in correspondence with the number of selectable angles. This SML_AGL_Cn_DSTA consists of 48 bits (6 bytes), as shown in FIG. 20.

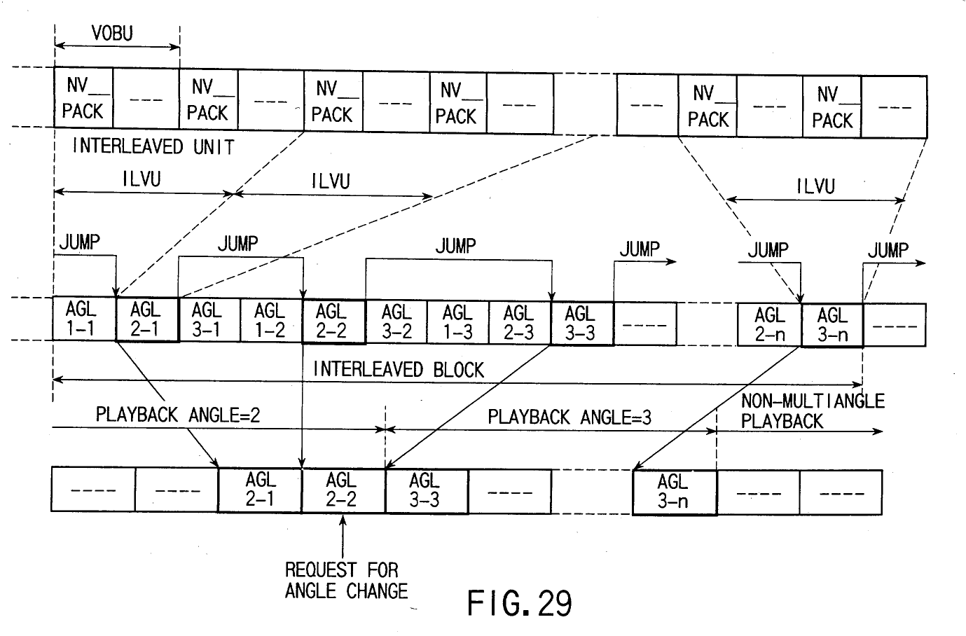

In order to implement “angle switching by means of playback and jump” to be described later with the aid of FIG. 29, the DSI packet in navigation pack 86 describes an angle information table, as shown in FIG. 19.

This table records destination information of the next interleaved unit ILVU to be played back in units of angles.

FIG. 20 shows one seamless angle change cell destination address SML_AGL_Cn_DSTA described in the angle information table shown in FIG. 19, which includes a destination address as 4-byte address information indicating the next destination of that angle number, and an ILVU size indicating the size of the angle to be played back at the next destination of that angle number.

More specifically, the first 2 bytes (lower 16 bits) indicate the size of the destination interleaved unit (ILVU) of the angle cell (AGL_C#n), the following 31 bits indicate the destination address of the angle cell (AGL_C#n), and the last 1 bit (b47 at the 48th bit) indicates the location of the angle cell, i.e., a location flag (AGL_C location).

The location flag (AGL_C location) of the angle cell describes if the destination is located before a navigation pack (NV_PCK) that includes the data search information (DSI). More specifically, if the flag (AGL_C location) is 0b (binary 0), it indicates that the destination is located after the navigation pack. The process to be done if the flag is 1b is not specified.

The seamless playback angle information (SML_AGLI) shown in FIG. 19 is effective only when the angle is to be changed seamlessly (only when a seamless angle change flag (to be described later with the aid of FIG. 27) is set). When this seamless angle change flag is not set, the angle is changed non-seamlessly. In such case, the non-seamless playback angle information (NSML_AGLI) shown in FIG. 13 is effective.

The start address of the destination angle cell (AGL_C#n) indicated by the destination address in FIG. 20 is described as follows. That is, the start address of an interleaved unit (ILVU#n) of the angle cell (AGL_C#n) to be played back immediately after completion of playback of an interleaved unit (ILVU#n−1) in a certain angle cell that contains DSI data 115 is described by the relative number of logical blocks (RLBN) from the logical block in navigation pack 86 that includes this DSI data 115.

Note that the interleaved unit (ILVU#n) is a recording unit used when a plurality of angle cells (AGL_C#n), which are continuous in terms of program contents, are physically recorded upon being interleaved on optical disk (DVD disk) 10 alternately (discretely).

If this interleaved unit (ILVU#n) is compared to video object unit (VOBU) 85 shown in FIG. 6, more than one VOBUs (more specifically, sets of video packs that form the VOBUs) in each of a plurality of angle cells are recorded upon being interleaved on the tracks of DVD disk 10. (Note that each interleaved unit is formed by more than one VOBUs.)

FIG. 21 is a view for explaining the process of seamless angle change in an angle block formed by a plurality of multiangle cells.

Taking FIG. 21 as an example, interleaved units ILVU#1 of angle cells AGL_C#1 to AGL_C#9 are allocated physically in turn on the recording tracks of DVD disk 10, and thereafter, interleaved units ILVU#2 of angle cells AGL_C#1 to AGL_C#9 are allocated physically in turn. Similarly, units ILVU#3 of AGL_C#1 to AGL_C#9, and units ILVU#4 of AGL_C#1 to AGL_C#9 are allocated in turn (each ILVU# consists of more than one VOBUs).

Angle cells (AGL_C#i; i=1 to n) in the angle block are located parallel to each other in the flow of playback time. Also, in the positional relationship with cells other than those in the angle block, each cell in the angle block is located in series with the previous and next cells in the flow of playback time.

To restate, a portion where the information contents (a plurality of VOBUs) of the respective angle cells (#1 to #9) are discretely recorded upon being interleaved in the form of interleaved units ILVU#1, #2, #3, . . . , is called an interleaved block. The interleaved units ILVU of individual angle cells AGL_C#1 to AGL_C#9 contain picture information obtained by capturing an identical event such as a home run scene of a certain hitter in various camera angles in units of video object units (VOBU) each having a playback time ranging from 0.4 sec to 1.2 sec.

When the angle is changed based on the seamless playback angle information (SML_AGLI) shown in FIG. 19 during playback of the interleaved block, the following operation, for example, is executed.

More specifically, as shown in FIG. 21, the trace destination of an optical pickup (not shown) jumps to an interleaved unit (ILVU#3) of the destination angle cell (AGL_C#1 or #9) that follows immediately after the playback time (t60 to t80) of the interleaved unit (ILVU#2) of the angle cell (AGL_C#i) which records DSI data 115 and is currently being played back.

In the example shown in FIG. 21, since the playback time jumps to the time immediately after cell switching (without interrupting playback) upon angle switching, temporally continuous, seamless playback is attained.

When no angle change is done, the optical pickup (not shown) intermittently traces interleaved units ILVU#1, #2, #3, . . . of a given angle cell (AGL_C#i) alone (by skipping ILVU#1, #2, #3, . . . of cells other than AGL_C#i) during playback of that angle cell (AGL_C#i) in the interleaved block.

When the above-mentioned angle information (NSML_AGLI) of PCI is used, the angle change that temporally goes back in units of video object units (VOBU; 0.4 sec to 1.2 sec) is done. However, when the angle information (SML_AGLI) of DSI is used, the angle is changed in units of interleaved recording units (time interval equal to or larger than the VOBU unit), thus temporally continuously playing back a scene in another angle (without temporally going back).

More specifically, the angle information (NSML_AGLI) of the presentation control information (PCI) describes a temporally discontinuous (non-seamless) angle change, while the angle information of the DSI describes a temporally continuous (seamless) angle change.

The seamless angle change will be described in more detail below taking baseball game scenes as an example. Assume that angle cell AGL_C#i contains a stream of video data obtained by continuously taking from the infield stand side, scenes in which hitter B strikes the pitch by pitcher A, and that ball is gone as a home run ball, and angle cell AGL_C#1 contains a video datastream obtained by taking identical scenes from the outfield stand side. Also, angle cell AGL_C#9 contains a video datastream obtained by taking the reactions of the teammates of hitter B in those scenes.

Assuming that the viewer who is observing the contents of angle cell AGL_C#i has changed the angle to that of angle cell AGL_C#1 (scenes from the outfield stand side) at the instance when hitter B has hit the pitch, the screen is switched to a scene in which the ball is flying toward the outfield (the viewer side) temporally continuously immediately after the scene of hitting of hitter B. (The screen does not freeze during switching.)

On the other hand, when the viewer who is observing the contents of angle cell AGL_C#i has changed the angle to that of angle cell AGL_C#9 at the instance when a home run is made, the angle is switched to an angle that shows the reactions of the teammates of hitter B. Then, a closeup of the teammates and manager who are all jubilating over the home run is displayed on the screen.

In this fashion, by selectively using the angle information (NSML_AGLI) of PCI data 113 and the angle information (SML_AGLI) of DSI data 115, quite different multiangle scene playback processes for the viewer can be realized.

Meanwhile, there are four different types of program chains (PGC), i.e., first play PGC (FP_PGC), video manager menu PGC (VMGM_PGC), video title set menu PGC (VTSM_PGC), and title PGC (TT_PGC).

Each of these program chains (PGC) normally consists of program chain information (PGCI) and more than one video objects (VOB; each including more than one cells), but a program chain (PGC) that contains program chain information (PGCI) alone without video objects can exist. Such program chain (PGC) containing program chain information (PGCI) alone is used when the playback condition is determined to pass playback to another program chain.

The number of pieces of program chain information (PGCI) is assigned from 1 in the description order of PGCI search pointers. The number of program chains (PGC) equals that of program chain information (PGCI). Even when program chains form a block structure, the number of program chains (PGC) in the block matches the number of continuous PGCI search pointers.

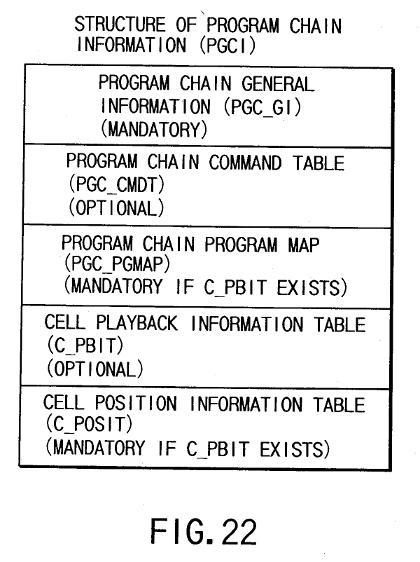

FIG. 22 is a view for explaining the structure of program chain information PGCI contained in video title set information VTSI shown in FIG. 5.

The program chain information (PGCI) has a structure shown in FIG. 22. More specifically, the program chain information (PGCI) is formed by program chain general information (PGC_GI; mandatory), a program chain command table (PGC_CMDT; optional), a program chain program map (PGC_PGMAP; mandatory if C_PBIT to be described next exists), a cell playback information table (C_PBIT; optional), and a cell position information table (C_POSIT; mandatory if C_PBIT mentioned above exists).

Program chain information (VTS_PGCI) of each of video title sets (VTS#1, VTS#2, . . . ) shown in FIG. 5 is contained in video title set information VTSI 94.

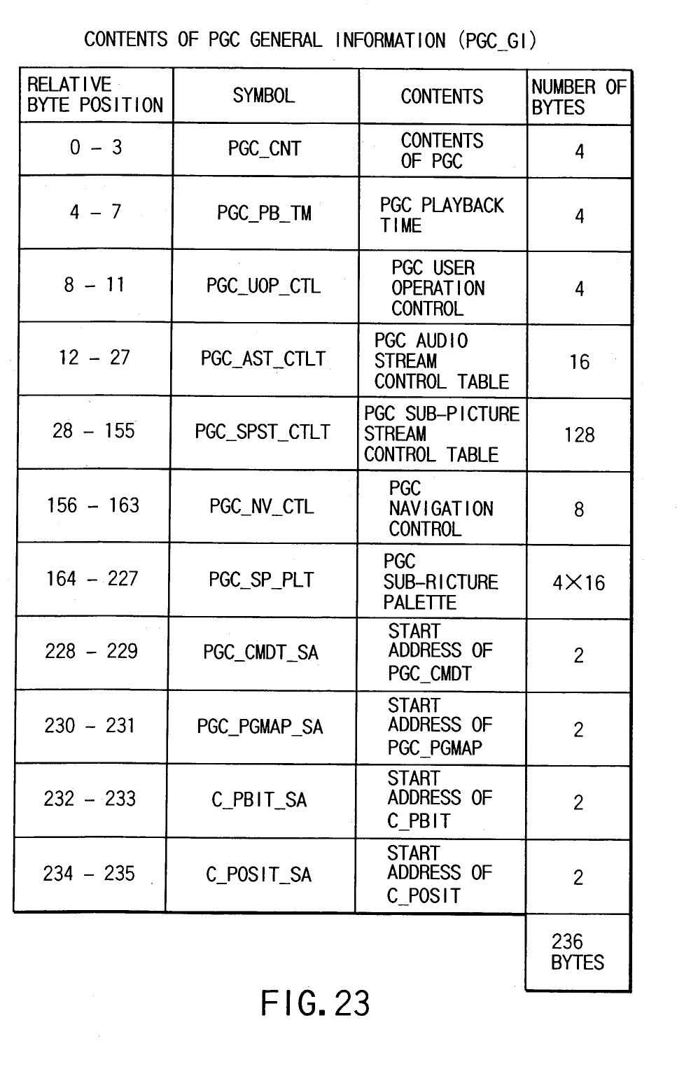

FIG. 23 is a view for explaining the contents of program chain general information (PGC_GI) included in program chain information PGCI shown in FIG. 22.

As shown in FIG. 23, the program chain general information (PGC_GI) describes program chain contents (PGC_CNT), a program chain playback time (PGC_PB_TM), program chain user operation control information (PGC_UOP_CTL), a program chain audio stream control table (PGC_AST_CTLT), a program chain sub-picture stream control table (PGC_SPST_CTLT), program chain navigation control information (PGC_NV_CTL), program chain sub-picture palette (PGC_SP_PLT), the start address of (PGC_CMDT_SA) of a program chain command table, the start address (PGC_PGMAP_SA) of a program chain program map, the start address (C_PBIT_SA) of a playback information table of cells in the program chain, and the start address (C_POSIT_SA) of a position information table of cells in the program chain.

The program chain contents (PGC_CNT) indicate the number of programs and number of cells (a maximum of 255) in the program chain. In a program chain having no video object VOB, the number of programs is “0”.

The program chain playback time (PGC_PB_TM) represents the total playback time of programs in that program chain in hours, minutes, seconds, and the number of video frames. This PGC_PB_TM also describes a flag (tc_flag) indicating the type of video frame, and a frame rate (25 or 30 frames per sec) or the like is designated by the contents of this flag.

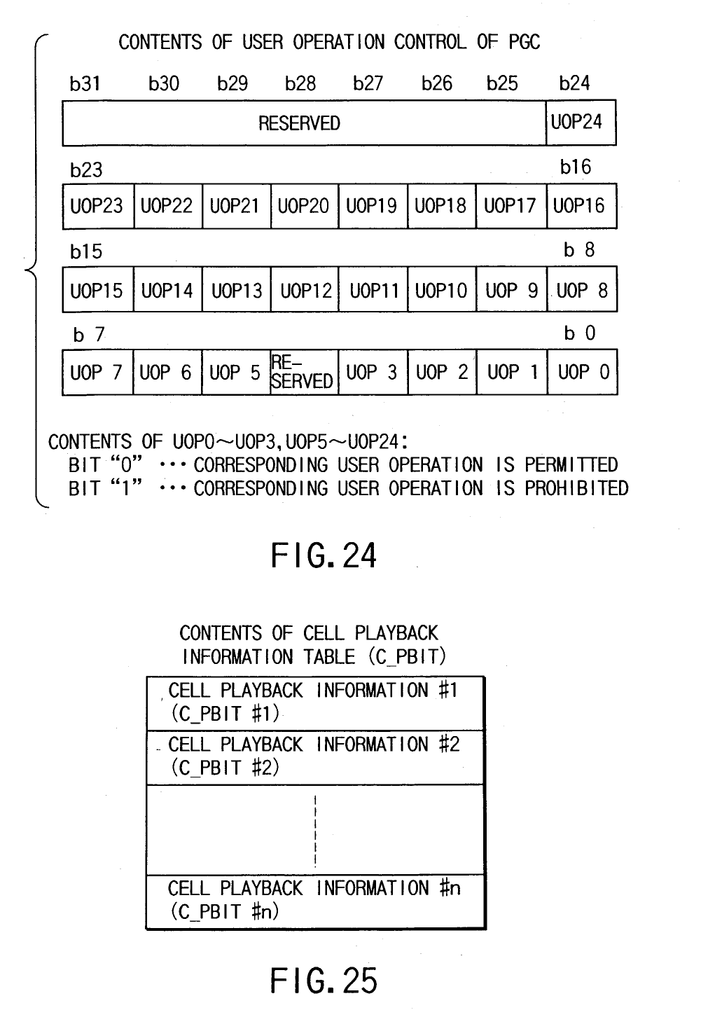

The program chain user operation control information (PGC_UOP_CTL) indicates user operations prohibited in the program chain which is being played back (its contents will be explained later with reference to FIG. 24).

The program chain audio stream control table (PGC_AST_CTLT) can contain control information for each of eight audio streams. Each control information includes a flag (availability flag) indicating if the corresponding audio stream is available in that program chain, and conversion information from an audio stream number to an audio stream number to be decoded.

The program chain sub-picture stream control table (PGC_SPST_CTLT) includes a flag (availability flag) indicating if that sub-picture stream is available in the corresponding program chain, and conversion information from a sub-picture stream number (32 numbers) into the sub-picture stream number to be decoded.

The program chain navigation control information (PGC_NV_CTL) includes Next_PGCN indicating the next program chain number to be played back after the program chain which is currently being played back, Previous_PGCN indicating a program chain number (PGCN) quoted by a navigation command “LinkPrevPGC” or “PrevPGC_Search( )”, GoUp_PGCN indicating a program number to which that program chain is to return, a PG Playback mode indicating the playback mode (sequential playback, random playback, shuffle playback, and the like) of the program, and a Still time value indicating the still time after that program chain is played back.

The program chain sub-picture palette (PGC_SP_PLT) describes 16 sets of luminance and color difference signals (each including a luminance signal and two color difference signals) used in a sub-picture stream in that program chain.

The start address (PGC_CMDT_SA) of the program chain command table assures a description area for a pre-command (executed before PGC playback), a post-command (executed after PGC playback), and a cell command (executed after PGC playback).

The start address (PGC_PGMAP_SA) of the program chain program map describes the start address of the program map PGC_PGMAP representing the program configuration in the program chain by a relative address from the first byte of program chain information PGCI.

The start address (C_PBIT_SA) of the cell playback information table in the program chain describes the start address of the cell playback information table C_PBIT that determines the playback order of cells in that program chain by a relative address from the first byte of program chain information PGCI.

The start address (C_POSIT_SA) of the position information table of cells in the program chain describes the start address of the cell position information table C_POSIT indicating VOB identification numbers and cell identification numbers used in that program chain by a relative address from the first byte of program chain information PGCI.

FIG. 24 is a view for explaining the contents of the program chain user operation control (PGC_UOP_CTL) contained in program chain general information PGC_GI shown in FIG. 23.

This user operation control PGC_UOP_CTL consists of 4 bytes (32 bits), and determines permission/prohibition of specific operations in the PGC which is being played back by user operation prohibition flags UOP0 to UOP3 and UOP5 to UOP24 contained therein.

More specifically, when the contents of each user operation prohibition flag bit (UOP0 to UOP3; UOP5 to UOP24) are 0b, the flag indicates that corresponding user operation is permitted; if the bit contents are 1b, the flag indicates that corresponding user operation is prohibited.

The provider (software producer) of DVD disk 10 can prohibit the user from calling a menu during playback of a specific PGC of a certain title to jump to another title by the contents of the user operation control information (PGC_UOP_CTL) (the bit contents of various UOPs) (in this case, the provider can permit the user to make a menu call/title number selection, and so forth, after completion of the playback of that PGC). Alternatively, the provider can prohibit the user from fastforwarding during playback of a specific PGC (If the PGC contains, e.g., a trailer of some movie series, the provider can force the user to watch that trailer unless the user stops the playback apparatus).

FIG. 25 shows the contents of cell playback information table C_PBIT shown in FIG. 22. This cell information table C_PBIT has the contents shown in FIG. 25, and contains a maximum of 255 pieces of cell playback information (C_PBIn; #n=#1 to #255).

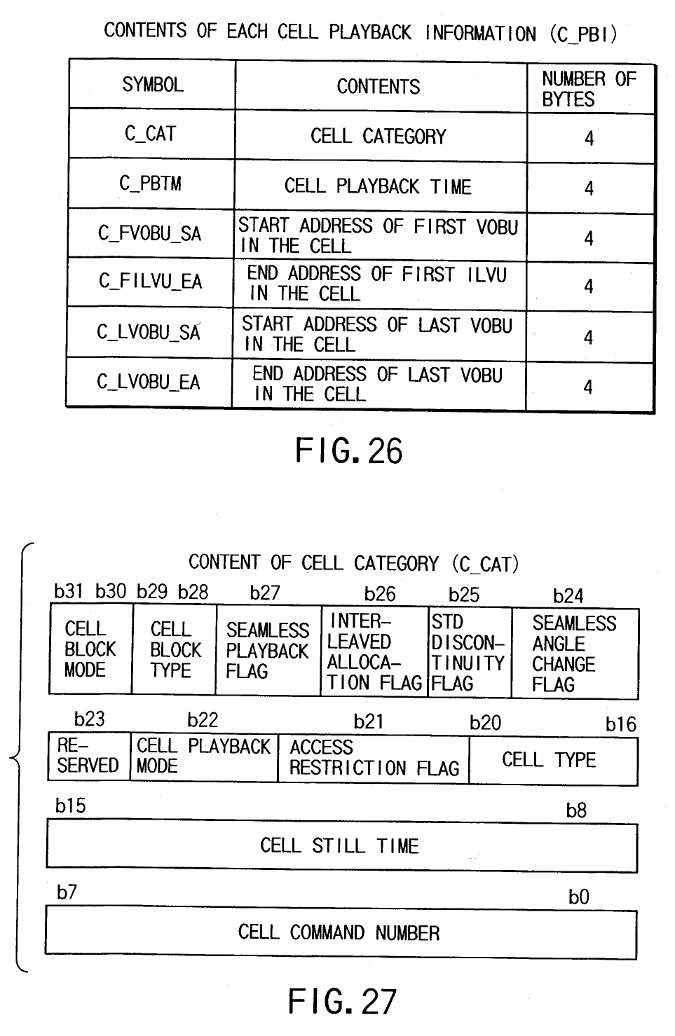

FIG. 26 is a view for explaining the contents of cell playback information C_PBI shown in FIG. 25. Each cell playback information (C_PBI#) shown in FIG. 25 includes a cell category (C_CAT; 4 bytes), cell playback time (C_PBTM; 4 bytes), the start address (C_FVOBU_SA; 4 bytes) of the first video object unit (VOBU) in the cell, the end address (C_FILVU_EA; 4 bytes) of the first interleaved unit in the cell, the start address (C_LVOBU_SA; 4 bytes) of the last video object unit (VOBU) in the cell, and the end address (C_LVOBU_EA; 4 bytes) of the last video object unit (VOBU) in the cell, as shown in FIG. 26.

FIG. 27 is a view for explaining the contents of cell category C_CAT shown in FIG. 26. As shown in FIG. 27, the cell category (C_CAT) indicates the number of cell commands by the lower 8 bits (b0 to b7); the cell still time by the next 8 bits (b8 to b15); the cell type (e.g., karaoke) by the next 5 bits (b16 to b20); an access restriction flag by the next 1 bit (b21); the cell playback mode (e.g., movie or still) by the next 1 bit (b22); a seamless angle change flag by 1 bit (b24) after the next reserved bit; an STC (system time clock) discontinuity flag by the next 1 bit (b25); an interleaved allocation flag (indicating if the cell designated by C_PBI is located in a continuous block or an interleaved block) by the next 1 bit (b26); a seamless playback flag (indicating if the cell designated by C_PBI is to be played back seamlessly) by the next 1 bit (b27); the cell block type (e.g., angle block) by the next two bits (b28 and b29); and the cell block mode (e.g., first cell in the block) by the last two bits (b30 and b31).

If the cell block mode bits are 00b (b means binary), this means that the cell is not the one in the block; if the bits are 01b, the cell is the first one in the block; if the bits are 10b, the cell is the one in the block; and if the bits are 11b, the cell is the last one in the block.

If the cell block type bits are 00b, this indicates that the cell block does not belong to the corresponding block; and if the bits are 01b, the corresponding block is an angle block (a block containing multiangle cells).

If the cell block type bits are not 01b during playback of a title containing multiangle cells, an angle mark (not shown) is kept ON (this angle mark can be displayed on the corner of the TV monitor screen, a portion of a control panel of the playback apparatus main body, or a portion of a remote controller of the playback apparatus).

If this cell block type=01b is detected during playback, the playback apparatus can inform the viewer that playback of the angle block is currently in progress by flickering the angle mark (not shown; or by changing the ON color or shape of the angle mark). With such information, the viewer can make sure that an image in another angle pertaining to the picture which is currently being played back is available.

At this time (upon detecting cell block type=01b), multi-screen digest display of individual angle pictures may be automatically done.

If the interleaved allocation flag is 0b, it indicates that the corresponding cell belongs to a continuous block (that continuously records a plurality of VOBUs); if the interleaved allocation flag is 1b, the corresponding cell belongs to an interleaved block (that interleaved-records ILVUs each containing more than one VOBUs).

If the seamless angle change flag is set (=1b), it represents that the corresponding cell is to be seamlessly played back; if this flag is not set (=0b), the corresponding cell is to be non-seamlessly played back.

That is, if the interleaved allocation flag=1b and seamless angle change flag=1b, the angle can be changed seamlessly; if the seamless angle change flag=0b, the angle can be changed non-seamlessly.

If a media drive system with a very short access time (a system that can access the beginning of a desired angle block within one video frame period; not limited to an optical disk drive system) is used, the angle can be changed smoothly even when the interleaved allocation flag=0b, i.e., between VOBU sets (different angle cells) which are not interleaved-recorded.

When optical disk 10 with relatively low access speed is used as a recording medium, one recording track of that disk is preferably assigned to recording of one interleaved block. In such format, since the trace destination of an optical head need only move in the radial direction of the disk by a very small distance corresponding to one track width, track jump suffering less time lag (suitable for seamless angle change) can be attained. In this case, if track jump for one video object unit (VOBU) is made, a time lag for a maximum of one revolution of the disk may be produced. Hence, the angle change that requires jumps in units of VOBUs is suitable for non-seamless angle change.

Note that the contents of the seamless angle change flag are normally determined in advance by the provider (the software producer who produces the program contents of titles recorded on DVD disk 10). That is, by determining the contents of the seamless angle change flag in advance, the provider can uniquely determine whether the non-seamless angle change shown in FIG. 15 or seamless angle change shown in FIG. 21 is to be used.

However, it is technically possible to design hardware which allows the viewer (apparatus user) to arbitrarily change the contents of the seamless angle change flag in read data after cell data of the corresponding title set are read from the optical disk.

Since the seamless angle change flag represents whether the angle information described in navigation pack 86 indicates seamless or non-seamless angle information, if the user of a DVD video recorder has changed this flag, the angle information in navigation pack 86 must be modified (e.g., modification from seamless angle information to non-seamless angle information).

When the cell playback mode is 0b, it indicates continuous playback in the cell; if the mode is 1b, still playback in each VOBU present in the cell.

The access restriction flag can be used when direct selection by user operation is prohibited. For example, when the access restriction flag of a cell that records answers for a collection of questions, the user is prohibited from reading the answers by stealth.

The cell type can indicate the following ones by its 5-bit contents, for example, when the corresponding cell is formed for karaoke.

If the 5 bits are 00000b, no cell type is designated; if the 5 bits are 00001b, a title image of the karaoke is designated; if the 5 bits are 00010b, an introduction part of the karaoke is designated; if the 5 bits are 00011b, a song part other than a climax (bridge) part is designated; if the 5 bits are 00100b, a song part of the first climax part is designated; if the 5 bits are 00101b, a song part of the second climax part is designated; if the 5 bits are 00110b, a song part for a male vocal is designated; if the 5 bits are 00111b, a song part for a female vocal is designated; if the 5 bits are 01000b, a song part for mixed voices is designated; if the 5 bits are 01001b, an interlude part (instrumental part) is designated; if the 5 bits are 01010b, fading-in of the interlude part is designated; if the 5 bits are 01011b, fading-out of the interlude part is designated; if the 5 bits are 01100b, the first ending part is designated; and if the 5 bits are 01101b, the second ending part is designated. The contents of the remaining 5-bit code can be used for other purposes.

Note that the angle change can be applied to that for background video data of the karaoke. For example, a full-figure shot, closeup shots of the face and mouth, and the like of a singer who is singing a guide vocal can be angle-changed seamlessly along with the flow of a karaoke music or non-seamlessly by going back some bars, or during repeat playback between desired bars, as the viewer desired.

On the other hand, if the 8-bit contents of the cell still time (FIG. 27) are 00000000b, zero still time is designated; if the contents are 11111111b, limitless still time is designated; if the contents fall within the range from 00000001b to 11111110b, a still display time having a duration defined by a decimal value (1 to 254) designated by the contents and expressed in seconds is designated.

The number of cell commands indicates the number of commands to be executed upon completion of playback of the corresponding cell.

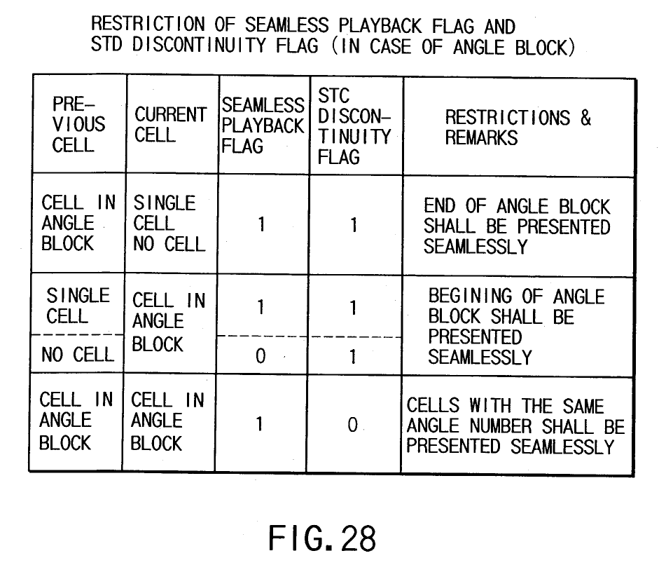

FIG. 28 is a view for explaining restriction of seamless playback in the angle block.

The seamless playback flag and STC discontinuity flag in FIG. 27 have contents shown in FIG. 28 depending on the cell playback state. More specifically, if the immediately preceding cell is a cell in the angle block and the current cell is a single cell, the seamless playback flag and STC discontinuity flag are respectively “1” and “1”. Also, if the immediately preceding cell is a single cell and the current cell is a cell in the angle block, the seamless playback flag and STC discontinuity flag are respectively “1” and “1”. (That is, the discontinuity flag is set at “1” since the angle block and non-angle block are switched.)

On the other hand, if both the immediately preceding cell and current cell are those in the angle block, the seamless playback flag and STC discontinuity flag are respectively “1” and “0”. (That is, since the angle block remains unswitched, the discontinuity flag is not set, i.e., “0”.)

If the discontinuity flag is active (flag=“1”), it is determined that the system time clocks (STC) are discontinuous (this determination can be made during, e.g., the vertical blanking period of a main picture signal). If discontinuity is determined, the comparison result between the presentation time stamp (PTS) and STC is ignored, and the current display control is maintained. During this interval, counting of a sub-timer is maintained, and the latest system clock reference (SCR) is set in a main timer. After that, the same operation as in normal playback is made until the next angle switching is done.

FIG. 29 is a view for explaining an example of angle switching (in case of seamless) executed by a playback apparatus (DVD player; to be described later). FIG. 29 shows the relationship between the pack sequence read out from DVD disk 10, and the angles to be switched and played back, and exemplifies a case wherein there are three angles.

In the upper column of FIG. 29, each video object unit VOBU includes packs from a navigation pack (NV pack) serving as a control pack to a pack immediately before the next NV pack as a playback & control unit. Non-seamless playback is done in units of VOBUs. On the other hand, each interleaved unit ILVU consists of more than one VOBUs, and is used as a unit for seamless angle playback.

In the middle column of FIG. 29, seamless multiangle playback cell data (corresponding to AGL_C# in FIG. 21) are set in the order of angle #1 (AGL1-1 to AGL1-n), angle #2 (AGL2-1 to AGL2-n), and angle #3 (AGL3-1 to AGL3-n), and these angles #1 to #3 form an angle block (interleaved block).

Upon seamless angle switching, playback images must not be interrupted by angle switching. In order to prevent images from being interrupted by angle switching, data (ILVU) of the respective angles are interleaved like

AGL1-1•AGL2-1•AGL3-1/AGL1-2•AGL2-2•AGL3-2/AGL1-3 . . . .

In this manner, angle data are broken up into relatively small units (ILVU), which are alternately allocated and are physically recorded on the recording tracks (FIG. 2) on DVD disk 10. With such format, the physical jump step required for an optical pickup (not shown) of a disk drive unit upon angle switching can be reduced.

For example, in the middle and lower columns in FIG. 29, when angle #2 (AGL2-2) is seamlessly switched to angle #3 during playback of angle #2, the physical jump step for the optical pickup (not shown) requires only three interleaved units (AGL3-2•AGL1-3•AGL2-3) (if the number of angles that can be played back is a maximum of nine, as shown in FIG. 21, the jump step requires a maximum of nine ILVUs). To cope with such small jump step (a maximum of nine ILVUs), it is technically possible to design hardware so that the optical pickup completes angle switching jump and starts to read out new angle data while MPEG-decoded pictures stored in an MPEG buffer memory of the playback apparatus are being played back.

More specifically, since individual interleaved units ILVU are interleaved in the order of angles #1, #2, and #3 to form an angle block, playback images can be practically prevented from being interrupted by angle switching (i.e., angle switching can be done seamlessly).

The seamless angle switching in the example shown in FIG. 29 will be described in more detail.

The middle column of FIG. 29 shows a case wherein angle #2 is selected as a default value. As a consequence, in the interleaved block shown in FIG. 29, the control skips the first unit of angle #1 (AGL1-1), and jumps to the beginning of the first unit of angle #2 (AGL2-1) to play back this unit. Similarly, the control skips the first unit of angle #3 (AGL3-1) and the second unit of angle #1 (AGL1-2) and jumps to the beginning of the second unit of angle #2 (AGL2-2) to play back this unit.

The lower column of FIG. 29 shows the playback state of the angle unit selected in the middle column of FIG. 29. Assume that an angle switching request to angle #3 is generated during playback of the second unit of angle #2 (AGL2-2). In this case, as shown in the middle column of FIG. 29, the control jumps from the second unit of angle #2 (AGL2-2) to the third unit of angle # (AGL3-3) to play back this unit.

In this way, the optical pickup of the disk drive unit repeats playback and jump in units of ILVUs of the respective angles, thus executing playback of a predetermined angle and seamless angle switching.

In order to execute angle switching by repetition of playback and jump, DSI packet 117 (FIG. 16) in NV pack 86 records the angle information table shown in FIG. 19. This table records the destination address and size information of the next ILVU to be played back in units of angles.

One information in the angle information table shown in FIG. 19 has the contents shown in FIG. 20, and includes the destination address (4-byte address information) indicating the next destination of that angle number), and the size of the angle to be played back at the next destination of that angle number.

In the example of seamless angle switching shown in FIG. 29, the angle cannot be immediately switched from the second unit of angle #2 (AGL2-2) to the second unit of angle #3 (AGL3-2) for the following reason. That is, the two angle units (AGL2-2 and AGL3-2) form an angle block to be played back in an identical time band. The unit of seamless angle switching is each ILVU that forms an angle playback unit. However, when angle switching is done between ILVUs in an identical time band (the ILVUs of AGL2-2 and AGL3-2), the flow of movie playback becomes temporally discontinuous (non-seamless), and temporally continuous, seamless angle switching cannot be done until the next angle block (AGL3-3). For this reason, the angle is prohibited from being immediately switched from the second unit of angle #2 (AGL2-2) to the second unit of angle #3 (AGL3-2).

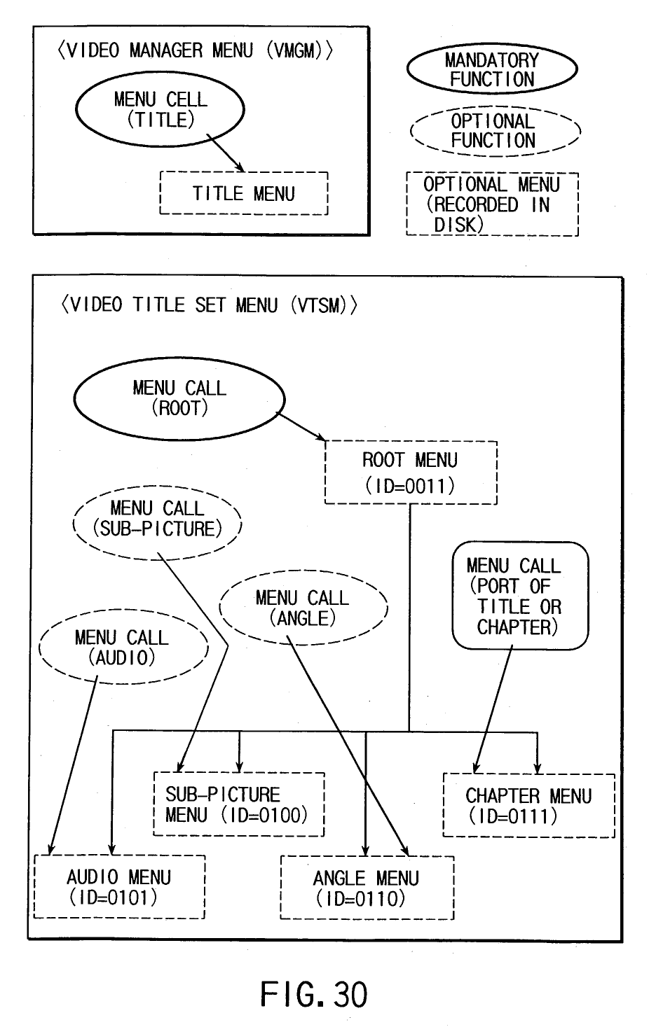

FIG. 30 shows the arrangement of menus used in the playback apparatus to be described later, and is a schematic view for explaining the correspondence between the system menus and user operation functions. The menus (popped up on the monitor screen if necessary) used in the playback apparatus are roughly classified into title menus, video title set menus, and optional menus. Of these menus, each of the video title set menus is called based on the contents of the menu ID.

More specifically, in response to the first menu call, a program chain for a root menu with menu ID=0011b is called. After that, when an audio menu is to be displayed, a program chain for the audio menu with menu ID=0101b is called. When a sub-picture menu is to be displayed, a program chain for the sub-picture menu with menu ID=0100b is called. When an angle menu is to be displayed, a program chain for the angle menu with menu ID=0110b is called. When a part of title (chapter) menu is to be displayed, a program chain for the part of title menu with menu ID=0111b is called.

When the user (viewer) of the playback apparatus wants to change the angle, the program chain for the angle menu with menu ID=0110b is called if necessary, and the angle menu is displayed on the monitor. (Note that the angle may be changed without displaying any angle menu on the monitor. In such case, in order to inform the viewer of the current playback angle, the current playback angle number is displayed on a display panel on the front surface of the playback apparatus main body (not shown).)

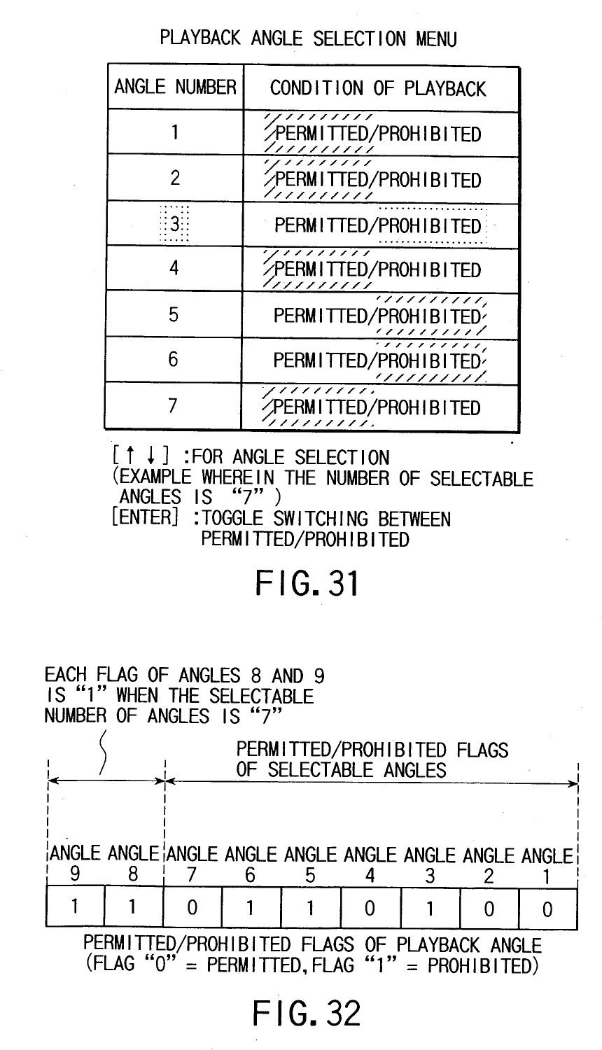

FIG. 31 is a view for explaining a menu used by the user to select and set playback permission/prohibition of a specific angle of multiangle picture information to be played back from DVD disk 10.

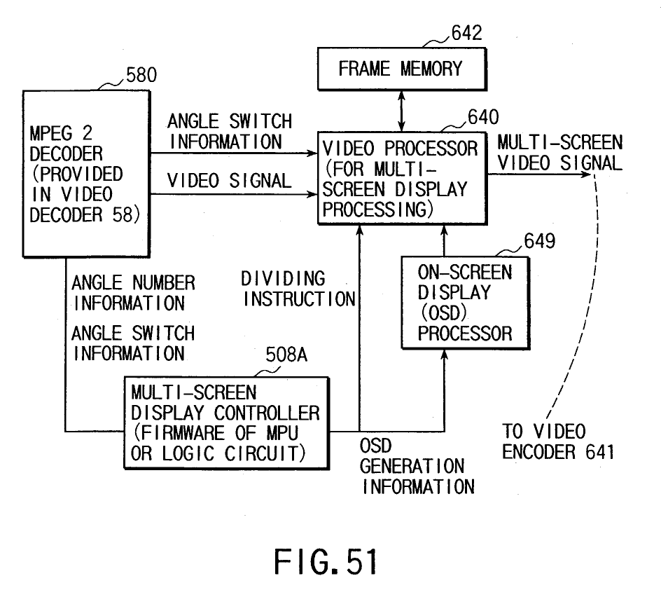

Assume that the user has pressed setup key 5y of remote controller 5 (to be described in detail later with reference to FIG. 48). In this case, the system CPU of the playback apparatus looks up the angle information (see FIG. 13 or 19) recorded on DVD disk 10, and detects selectable angle numbers (a maximum of nine numbers). If the detected angle numbers are #1 to #7, the number of angles that can be switched is a maximum of seven. In such case, the system CPU directs an OSD unit (to be described later with reference to FIG. 51) in the playback apparatus to generate a menu for setting playback permission/prohibition for each of angle numbers #1 to #7.

Video manager information VMGI 75 shown in FIG. 5 contains video manager information management table VMGI_MAT, title search pointer table TT_SRPT, and the like (not shown), and this title search pointer table TT_SRPT also describes angle information (the number of selectable angles).

The OSD unit in the playback apparatus reads out data of the playback angle selection menu shown in, e.g., FIG. 31 from a ROM (not shown). This menu is output to the monitor to have a blue-back screen (or a video image read out from DVD disk 10) as a background.

On the menu screen shown in FIG. 31, the user operates an upward triangular mark portion (cursor ↑) or a downward triangular mark portion (cursor ↓) of cursor key 5q of remote controller 5 as needed, thus selecting the angle of one of angle numbers #1 to #7 recorded on DVD disk 10. In this cursor operation, the currently selected angle number is highlighted by black-white inversion processing or by changing the color, contrast, or the like (in FIG. 31, angle number #3 is currently selected, and is indicated by halftone dot screen).

When the user has pressed enter key 5s of remote controller 5 while the menu screen shown in FIG. 31 is OSD-displayed, the highlight display of “permitted/prohibited” of the angle playback condition of the currently selected angle number (#3 in FIG. 31) is toggle-switched. For example, when the user has pressed enter key 5s once in the state illustrated in FIG. 31, the highlight display portion (halftone dot screen portion in FIG. 31) shifts from the position of “prohibited” to the position of “permitted”, and when the user has pressed enter key 5s once again, the highlight display portion returns from the position of “permitted” to the position of “prohibited”.

When the user has changed the selected angle number position by cursor key 5q after he or she determined a desired playback permission/prohibition condition by the above-mentioned enter key operation, the selected condition of the highlight display portion (halftone dot screen portion) by the toggle switch operation of enter key 5s is confirmed, and the display state of that portion changes to another highlight display pattern (hatching) (e.g., the condition is indicated by hatching like angle number #5).

After the user sets the playback permission/prohibition conditions for all the selectable angle numbers #1 to #7, the display state shown in, e.g., FIG. 31 is obtained. In this case, of angle numbers #1 to #7, the angles of angle numbers #1, #2, #4, and #7 are set to be those that can be played back in practice, but the angles of angle numbers #3, #5, and #6 are masked upon playback even if they are recorded in the angle block of DVD disk 10 and cannot be played back by a DVD player.

For example, assume that, in the angle block of a DVD video disk that records the performance of a classical music orchestra, angle #1 stores long shot scenes that capture the entire orchestra from the audience side of the concert (from the back side of the conductor), angle #2 stores up shot scenes that capture the face of the conductor from the orchestra side, angle #3 stores long shot scenes that capture the audience of the concert from the orchestra side, angle #4 stores middle shot scenes that capture the first violin group from the audience side, angle #5 stores middle shot scenes that capture the viola-contrabass group from the audience side, angle #6 stores middle shot scenes that capture the wind instrument group from the audience side, and angle #7 stores up shot scenes that capture the percussion instrument group from the audience side.

When the angle block of the orchestra is to be played back, the user (viewer) can selectively watch any of angles #1 to #7 in the default state. However, after the playback angle selection menu is set, as shown in FIG. 31, the audience in angle #3, the viola-contrabass group in angle #5, and the wind instrument group in angle #6 can neither be selected nor played back (i.e., angles #3, #5, and #6 are masked).

In this case, the entire orchestra in angle #1, the conductor in angle #2, the first violin group in angle #4, and the percussion instrument group in angle #7 are angles that can be played back. Among these angles (#1, #2, #4, and #7) that can be played back, auto-angle playback (to be described later; multiangle playback is done while automatically and variously changing the playback angles during playback of the angle block that records the multiangle information) or multi-screen simultaneous display (multiangle digest display) is made.

When the user does not particularly set playback prohibition on the playback angle selection menu shown in FIG. 31, all the angles of angle numbers #1 to #7 recorded in the angle block of DVD disk 10 are permitted to be played back in the default state.

FIG. 32 is a view for explaining a flag set that holds the setup result on the menu shown in FIG. 31.

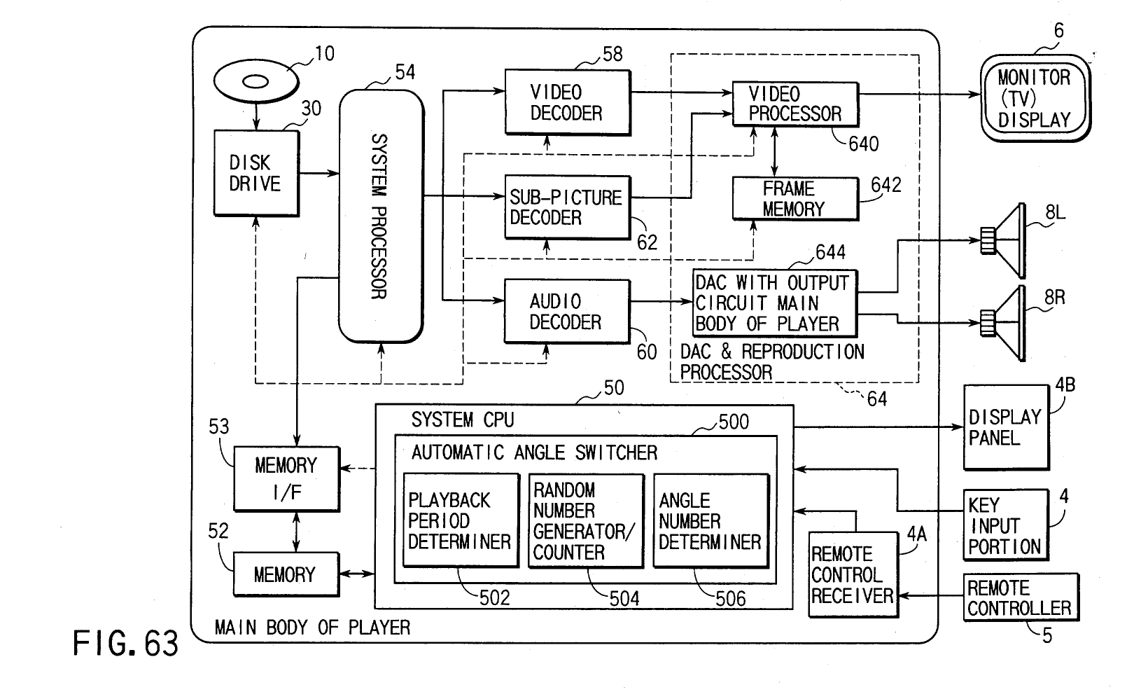

The user setup result on the playback angle selection menu shown in FIG. 31 is set in a 9-bit flag set corresponding to the angle numbers, as shown in FIG. 32, by an angle number determiner (506 in FIG. 63) in the system CPU of the playback apparatus. This flag set is stored in the internal RAM of the playback apparatus, separately prepared EEPROM, or the like.

Upon executing auto-angle playback (to play back the angle block while automatically changing the playback angles) or multiangle digest display (to simultaneously display angle pictures that can be played back on a plurality of divided, small display areas), as will be described later, the flag set in the internal RAM is looked up. Only the angles of the angle numbers with no prohibited flags (bit “1”) (i.e., the angles with flags=bit “0”) are played back while being variously switched (or simultaneously).

Note that flags corresponding to unused angles (angles #8 and #9 in the example of FIG. 31) in the flag set in FIG. 32 are set in the prohibited state (bit “1”). Such processing can be implemented by the above-mentioned angle number determiner (506 in FIG. 63).

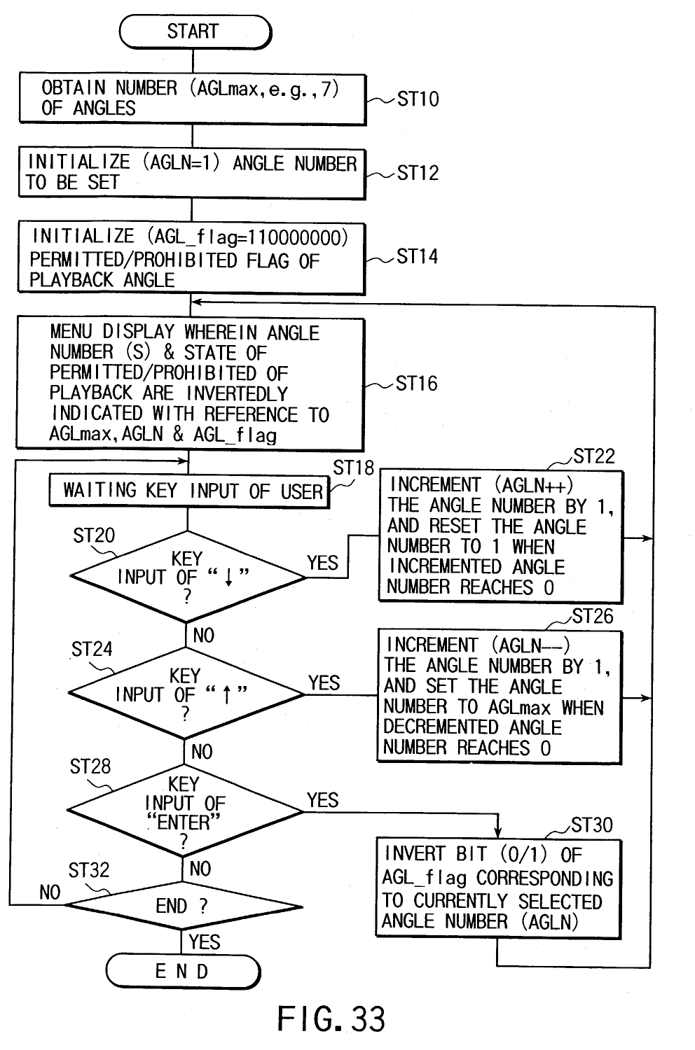

FIG. 33 is a flow chart for explaining the operation of setting the respective flags in the flag set shown in FIG. 32 via the menu shown in FIG. 31.

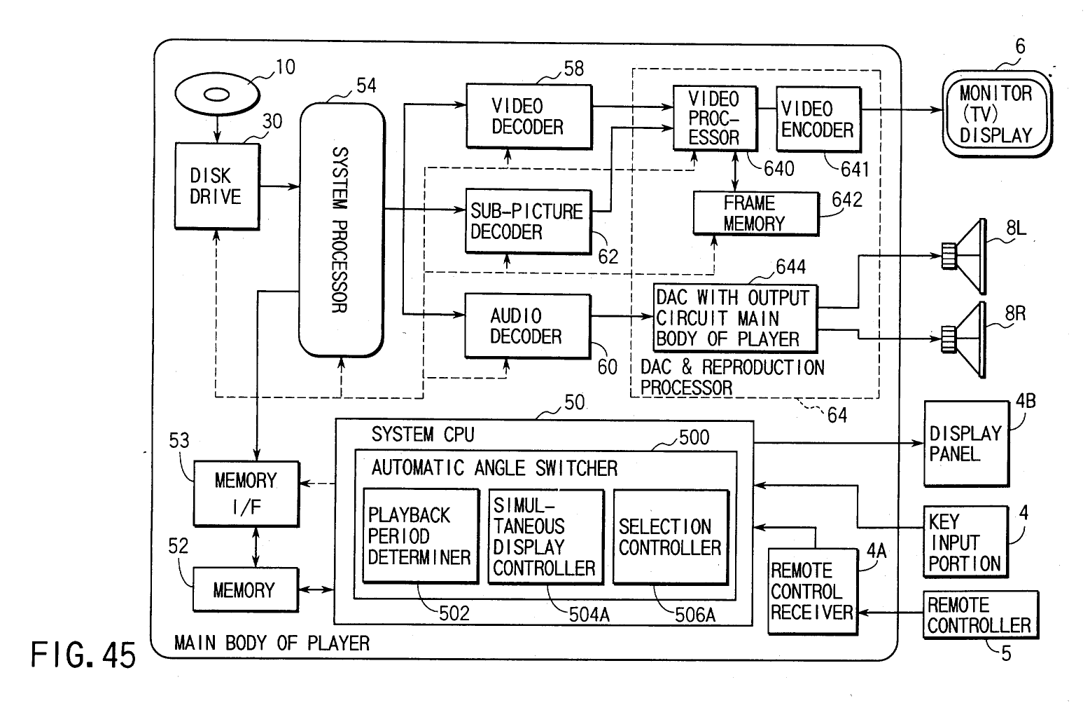

When the user has pressed setup key 5y of remote controller 5 (FIG. 48), selection items (not shown) of various setup menus are OSD-displayed on monitor display 6 of the playback apparatus (FIGS. 45 to 47, FIGS. 63 and 64). When the user selects the playback angle selection menu from the displayed setup menu items by cursor key operation and enter key operation on remote controller 5, the playback angle selection menu is OSD-displayed on monitor display 6, as shown in FIG. 31.

Alternatively, when the user has simultaneously pressed angle key 5ang and menu key 5n of remote controller 5, the playback angle selection menu (OSD) shown in FIG. 31 can be called by a single action. In this state, the processing shown in FIG. 33 is started.

The system CPU of the playback apparatus looks up the angle information (FIG. 13 or 19) recorded on DVD disk 10, and detects selectable angle numbers (a maximum of nine numbers). Assuming that the detected angle numbers are #1 to #7, the maximum number of angles that can be switched is seven. In this case, the CPU of the playback apparatus obtains the number (AGLmax=7) of angles (step ST10).

After the number of selectable angles (AGLmax=7) is obtained, angle number AGLN to be activated first on the menu screen in FIG. 31 is initialized (AGLN=1) (step ST12). With this initialization, angle number #1 in FIG. 31 is activated.

Initially, all the angles #1 to #7 are selectable unless the user prohibits playback of a specific angle on the menu shown in FIG. 31. On the other hands since the angle block to be played back is assumed to include only seven angles, angles #8 and #9 are prohibited from being played back.

Since the playback prohibited angle flag is defined by bit “1”, the contents of playback angle permitted/prohibited flag set AGL_flag (FIG. 32) are initialized to “110000000” when bits are aligned in the order from the ninth bit to the first bit (step ST14).

Subsequently, the number of selectable angles (AGLmax=7), the default value (AGLN=1) of the angle number to be set, and the default value (AGL_flag=“110000000”) of the playback angle permitted/prohibited flag set are looked up, and the playback angle selection menu shown in FIG. 31 is OSD-displayed (step ST16), thus waiting for the user's key input (step ST18).

Since angle number AGLN is initialized to “1” in step ST12, that number “1” is initially highlighted (FIG. 31 exemplifies a case wherein angle number “3” is highlighted).

If the user has pressed the “↓” key of cursor key 5q of remote controller 5 (YES in step ST20), angle number AGLN to be activated is incremented by 1 (step ST22). In this case, AGLN=2, and the angle number “2” in FIG. 31 is highlighted and activated. When the “↓” key has been repetitively pressed, and the incremented AGLN has exceeded AGLmax=7, AGLN returns to “1”.

If the user does not press the “↓” key of the cursor key 5q of the remote controller 5 (NO in step ST20) and has pressed the “↑” key once (YES in step ST24), angle number AGLN to be activated is decremented by one (step ST26). When the “↑” key is pressed while AGLN=1, AGLN=0 is set. However, in this case, AGLN is set at AGLmax=7, and the angle number “7” in FIG. 31 is highlighted and activated. When the “↑” key is repetitively pressed and the decremented AGLN reaches AGLmax=0, AGLN returns to AGLmax=7.

If the user has activated, e.g., the angle number “3” by the “↓” or “↑” key of cursor key 5q of remote controller 5 and has pressed enter key 5s of remote controller 5 in this state (YES in step ST28), the flag bit contents corresponding to angle number “3” is inverted from “0” to “1” (step ST30). When the user makes similar operations for angle numbers “5” and “6”, the bit contents of playback angle permitted/prohibited flag set AGL_flag become “110110100”, as shown in FIG. 32. With this setup, in auto-angle playback later, the angles of angle numbers “1”, “2”, “4”, and “7” can be played back.

When the setup state of the playback angle selection menu in FIG. 31 is obtained as the user desired, the user presses end key 5end of remote controller 5 shown in FIG. 48 (YES in step ST32), thus ending the processing in FIG. 33.

Note that the processing in FIG. 33 can also be ended by simultaneously pressing angle key 5ang and menu key 5n of remote controller 5n.

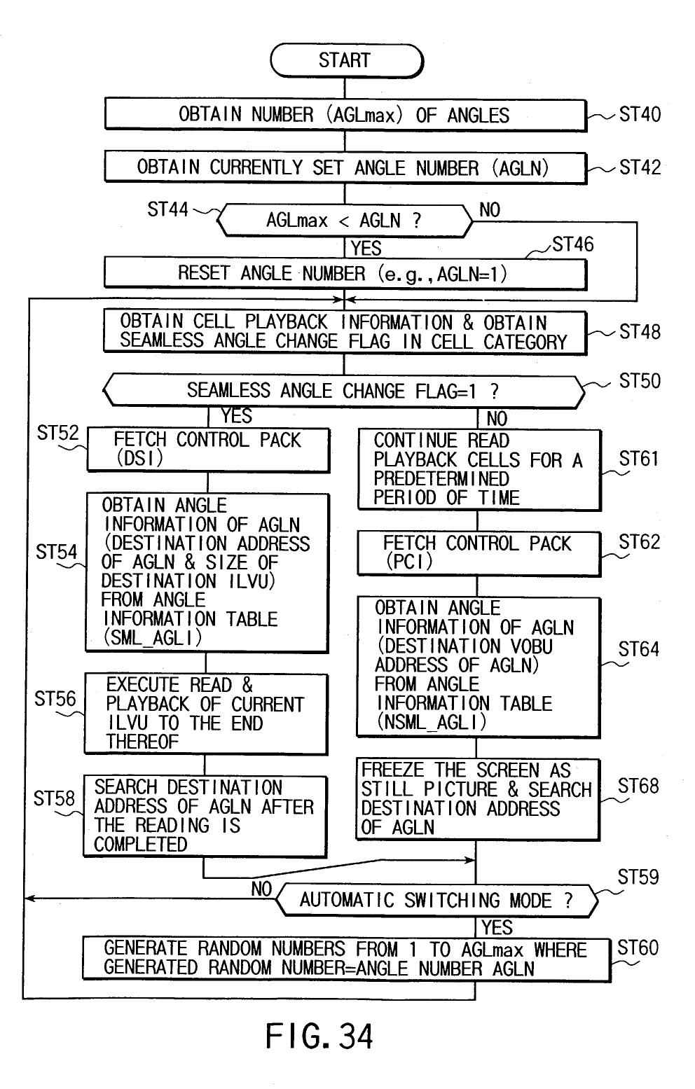

FIG. 34 is a flow chart for explaining the first example of automatic angle switching (auto-angle by generating random numbers).

When the user has pressed playback key 5c of remote controller 5 after he or she determined the angle numbers to be played back by the processing in FIG. 33, DVD disk 10 begins to be played back. When the playback position enters the angle block shown in FIG. 15 or 21, the CPU of the playback apparatus obtains the number of angles (seven in the example shown in FIG. 31) in that angle block (step ST40).

After the number of angles (AGLmax=7) of the angle block to be played back is obtained, the CPU of the playback apparatus obtains playback angle permitted/prohibited flag set AGL_flag=“110110100” (FIG. 32) stored in the memory of the playback apparatus (step ST42).

At that time, the CPU checks in step ST44 if set angle number AGLN (set as the angle number to be played back) is larger than the obtained number of angles (AGLmax=7). If AGLN>AGLmax=7 (step ST44), angle number AGLN is reset to a predetermined value equal to or smaller than AGLmax, e.g., “1” (step ST46). At this time, if AGLN≦AGLmax=7 (NO in step ST44), the flow skips the reset processing in step ST46.

Subsequently, the CPU of the playback apparatus reads out cell category C_CAT in FIG. 27 from DVD disk 10, and checks the contents of a seamless angle change flag (bit 24) written by the provider of DVD disk 10 (step ST48).

If the seamless angle change flag is bit “1” (YES in step ST50), it is determined that the angle block is a seamless angle block in units of ILVUs, as shown in FIG. 21. In such case, the CPU fetches DSI data 115 from first navigation pack 86 (FIG. 16) in the first VOBU in the ILVU with the angle number to be played back (step ST52).

This DSI data contains seamless angle information SML_AGLI, as shown in FIG. 19. If the angle number to be played back is #1, the CPU of the playback apparatus looks up SML_AGL_C1_DSTA in this seamless angle information SML_AGLI, and obtains the destination address to angle #1 (AGLN=1) and the ILVU size of that angle number therefrom (step ST54).

The CPU of the playback apparatus controls reads of the disk drive unit on the basis of the obtained destination address to angle number #1 and the ILVU size of that angle number so as to read and play back that ILVU to its end (step ST56).

Upon completion of reading of this ILVU (step ST58), the destination address of the next ILVU with angle number #1 (AGLN=1) is searched (step ST58). This search corresponds to that of the ILVU of AGL2-2 upon completion of reading of the ILVU of AGL2-1 in, e.g., the example shown in FIG. 29.

After the search, if it is determined that an automatic angle switching mode or automatic angle changing mode is not started (NO in step ST59), DSI data 115 is fetched from first navigation pack 86 in the first VOBU of the next ILVU (step ST52). After that, similar operations (YES in step ST50 to step ST58) repeat themselves.

If the above-mentioned seamless angle change flag (FIG. 27) is bit “0” (NO in step ST50), it is determined that the angle block is a non-seamless angle block in units of VOBUs, as shown in FIG. 15. In such case, the VOBUs of the angle number to be played back are read out for a predetermined period of time, and are played back (step ST61). Assuming that the predetermined period of time is several seconds, since the playback time of one VOBU is normally about 0.5 sec, a plurality of continuous VOBUs are read and played back in step ST61. At this time, PCI data 113 is fetched from first navigation pack 86 (FIG. 9) of the VOBU which is being played back (step ST62).

This PCI data contains non-seamless angle information NSML_AGLI as shown in FIG. 13. If the angle number to be played back is #2, the CPU of the playback apparatus looks up NSML_AGL_C2_DSTA in this non-seamless angle information NSML_AGLI, and fetches the destination address to angle number #2 (AGLN=2) therefrom (step ST64).

The CPU of the playback apparatus controls reads of the disk drive unit (e.g., 30 in FIG. 63) on the basis of the fetched destination address to angle number #2 (AGLN=2), freezes, as a still picture, the screen of the VOBU (of, e.g., angle number #1) that has been played back at that time, and searches the next VOBU (of, e.g., angle number #2) (step ST68).

If the automatic angle switching mode is not started (NO in step ST59), the next VOBU and subsequent VOBUs (VOBUs in the same angle as that of the previous ones) are played back for the predetermined period of time (step ST61). After that, similar operations (NO in step ST50, steps ST61 to ST68) repeat themselves.

If the automatic angle switching mode is started (YES in step ST59), a random number generator/counter (504 in FIG. 63) in the CPU of the playback apparatus generates random number from 1 to AGLmax (=7). Angle number #1 (AGLN=1) used so far is replaced by the angle number (which can be 1 but is highly likely to be an angle number other than 1) designated by the random number generated by this random number generator/counter (step ST60), and the flow returns to step ST48. After that, the similar processing (seamless playback in steps ST52 to ST58 or non-seamless playback in steps ST61 to ST68) repeat themselves for the angle cells of the new angle number.

Note that the user of the playback apparatus can freely determine whether the automatic angle switching mode (step ST59) is to be started. For example, the user presses setup key 5y of remote controller 5 to OSD-display a setup menu on the monitor of the playback apparatus. This OSD display includes an ON/OFF setup item of the automatic angle switching mode, and if the user selects “auto-angle switching=ON” using cursor key 5q and enter key 5s of remote controller 5, the automatic angle switching mode is started (YES in step ST59).

Playback angle permitted/prohibited flag set AGL_flag set by the processing in FIG. 33 can be used as follows in the processing in step ST60.

More specifically, the random number generator/counter (504 in FIG. 63) in the CPU of the playback apparatus generates a random number equal to or smaller than the value AGLmax. The system CPU logically ANDs a value obtained by bit-shifting a value “1” to the left by “generated random number” minus “1”, and AGL_flag. If the AND becomes zero, the angle number of the generated random number is used as the angle which is permitted to be played back.

This random number can be generated by giving a maximum value (max value) to be generated in, e.g., a random (n; n is the max value to be generated) function or the like. Whether or not the angle can be played back is determined based on the return value from this random(n) function and the bit value of playback angle permitted/prohibited flag set AGL_flag.

More specifically, since AGLmax=7 in the example shown in FIG. 31, the random(7) function is used.

The return value from this function assumes one of “1” to “7”. Suppose this return value “4”, and AGL_flag is “110•110•100”.

The above-mentioned value “1” is “000•000•001” if it is expressed by the same number of bits as AGL_flag.

When this “000•000•001” is bit-shifted to the left by “3”=“4”−“1”, “000•001•000” is obtained. The AND of this bit value “000•001•000” and the bit value “110•110•100” of AGL_flag is “000•000•000”. Hence, the AND of the corresponding bit (the bit of angle #4 in FIG. 32) of playback angle permitted/prohibited flag set AGL_flag is “0” to indicate playback permission, and the angle with the angle number=“4” is played back.

On the other hand, if playback angle permitted/prohibited flag set AGL_flag is “110•111•100”, (i.e., if playback prohibited bit “1” is set for angle #4) when the return value from the random(7) function is “4”, the AND of AGL_flag=“110•111•100” and the 3-bit left-shifted value “000•001•000” is “000•001•000”. That is, the corresponding bit of playback angle permitted/prohibited flag set AGL_flag is “1” to indicate playback prohibition, and the angle of the angle number=“4” is not played back. In this case, another random number (return value) is obtained from the random(7) function, and random number generation and ANDing repeat themselves until the bit corresponding to the angle number to be played back in the AND becomes “0”.

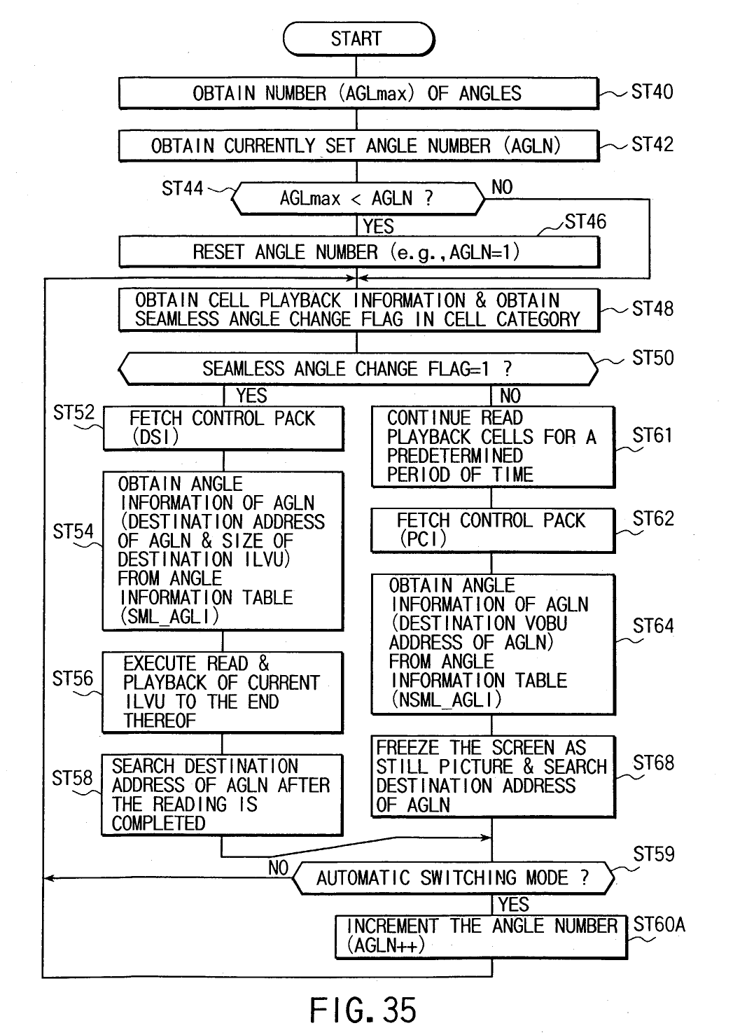

FIG. 35 is a flow chart for explaining the second example of automatic angle switching (auto-angle by counting the angle numbers).

In FIG. 35, random number generation in step ST60 in FIG. 34 is replaced by angle number counting step ST60A.

In random number generation shown in FIG. 34, the next angle to be automatically played back cannot be expected in the automatic angle switching mode (YES in step ST59). However, in counting in FIG. 35, the next angle to be automatically played back in the automatic angle switching mode can be predicted (YES in step ST59).

Note that this processing which uses playback angle permitted/prohibited flag set AGL_flag can also be made in this example. For example, in angle number counting step ST60A, counting is done while skipping the playback-prohibited angle numbers (the angles corresponding to bits “1” in the example shown in FIG. 32), and the playback-permitted angle numbers alone (the angles corresponding to bits “0” in the example shown in FIG. 32) can be played back.

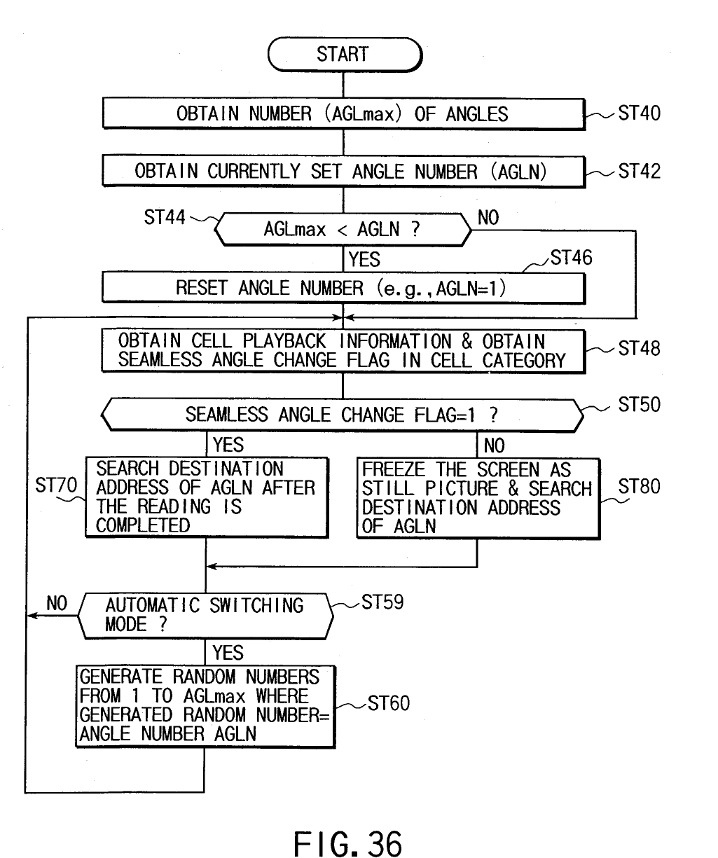

FIG. 36 is a flow chart for explaining the third example of automatic angle switching (auto-angle by generating random numbers with a variable angle switching period).

In FIG. 36, seamless angle playback in steps ST52 to ST58 and non-seamless angle playback in steps ST61 to ST68 in FIG. 34 are modified so as to change the angle playback duration. In case of FIG. 36, during seamless automatic angle playback, not only the playback angle is automatically switched, but also its playback period changes. Similarly, even during non-seamless automatic angle playback, not only the playback angle is automatically switched, but also its playback period changes.

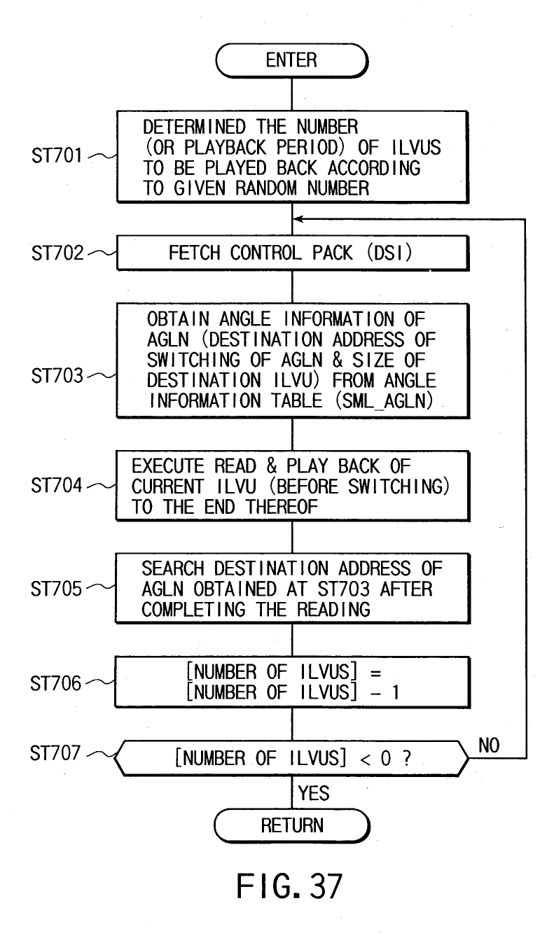

FIG. 37 is a flow chart for explaining the contents of seamless angle switching (ST70) in the automatic angle switching shown in FIG. 36.

If the seamless angle change flag=1 is detected in the processing shown in FIG. 36 (YES in step ST50), the control enters seamless automatic angle switching with a variable playback period shown in FIG. 37.

The random number generator/counter (504 in FIG. 63) generates a playback period determination random number independently of the random number generated in step ST60. The playback period determination random number is a numerical value that determines the number of ILVUs (of n ILVUs) to be played back, that form the angle to be played back, in that angle. For example, in case of FIG. 21, the number of ILVUs that form the angle is 6 (n=6), and the random number generator/counter generates an arbitrary playback period determination random number between 1 to 6. In the following explanation to be given, assume that the generated random number is [3].

When the playback period determination random number=[3] is generated by the random number generator/counter, the number of ILVUs to be played back is [three] (step ST701).

DSI data 115 is fetched from navigation pack 86 (FIG. 16) in the first VOBU in the first ILVU (e.g., ILVU#2 in FIG. 21) of the three playback ILVUs in the angle (e.g., AGL_C#i in FIG. 21) to be played back (step ST702).

This DSI data contains seamless angle information SML_AGLI, as shown in FIG. 19. If the angle number to be played back is #1 (AGL_C#i=AGL_C#1), the CPU of the playback apparatus looks up SML_AGL_C1_DSTA in this seamless angle information SML_AGLI, and obtains the destination address to angle number #1 (AGLN=1) and the ILVU size of that angle number therefrom (step ST703). Then, the CPU reads ILVU#1 of angle number #n, which is currently being played back, to its end, and plays it back (step ST704).

Upon completion of reading of this ILVU#1, the destination address of the ILVU of angle number #1 (AGLN=1) to be switched is searched (step ST705). This search corresponds to that of ILVU#2 after reading of ILVU#1 in the example shown in FIG. 21.

After the next ILVU (#3) is searched upon completion of playback of one (#2) of the three ILVUs (#2 to #4), the playback period determination random number=[number of ILVUs], which was set to be [2], is decremented by 1 to obtain [1] (step ST706).

Since the decremented [number of ILVUs=1] is not smaller than zero (NO in step ST707), the flow returns to step ST702 to read out and play back the next ILVU (#3) (step ST704).

The above-mentioned processing in steps ST702 to ST705 repeats itself until the [number of ILVUs] becomes smaller than zero.

After the read and playback processes of the ILVUs (#2 to #4) of angle number #1 (AGLN=1) have repeated themselves three times, the [number of ILVUs] becomes smaller than zero (YES in step ST707). Then, the flow returns to step ST59 in FIG. 36.

Since the number of playback ILVUs determined in step ST701 in FIG. 37 (the default value of the [number of ILVUs] in step ST706) randomly changes depending on the random number generated by the random number generator/counter (504 in FIG. 63) in the CPU of the playback apparatus, the angle playback duration (=the number of ILVUs) changes every time the control processes the loop of steps ST48, ST50, ST70, ST59, and ST60 in FIG. 36.

The angle, the playback duration (playback period) of which changes in this way, is determined by the random number processing in step ST60.

More specifically, according to the processing shown in FIGS. 36 and 37, the playback angle number randomly changes in step ST60, and the duration of seamless angle playback also changes in every processing in step ST70.

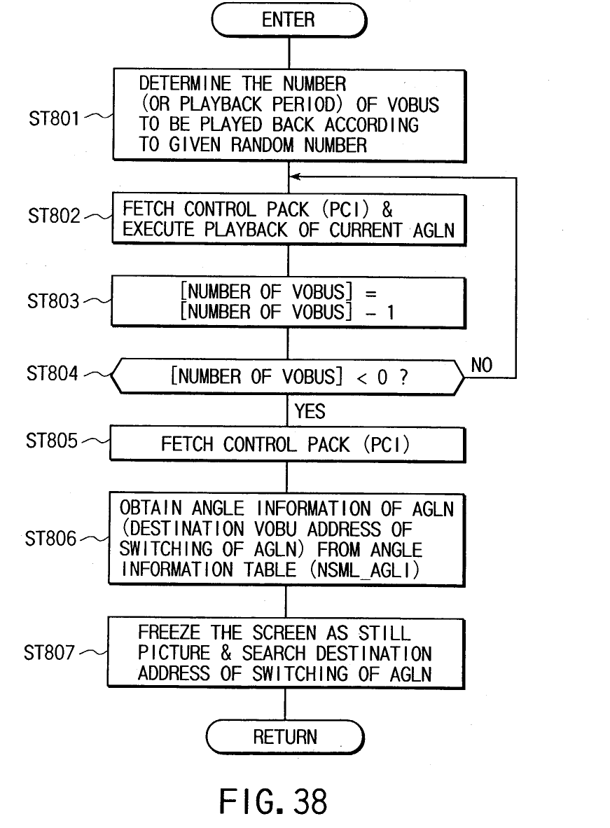

FIG. 38 is a flow chart for explaining the contents of non-seamless angle switching (ST80) in automatic angle switching shown in FIG. 36.

The random number generator/counter (504 in FIG. 63) generates a playback period determination random number independently of the random number generated in step ST60. The playback period determination random number is a numerical value that determines the number of VOBUs (of m VOBUs) to be played back, that form the angle to be played back, in that angle. For example, in case of FIG. 15, the number of VOBUs that form the angle is 6 (m=6), and the random number generator/counter generates an arbitrary playback period determination random number between 1 to 6. In the following explanation to be given, assume that the generated random number is [2].

When the random number generator/counter generates the playback period determination random number=[2], the number of VOBUs to be played back is [two] (step ST801).

PCI data 113 is fetched from navigation pack 86 (FIG. 9) in the first VOBU (e.g., VOBU#2 in FIG. 15) of the two playback VOBUs in the angle (e.g., AGL_C#i in FIG. 15) to be played back, and the VOBU#2 is played back (step ST802).

Upon completion of playback of VOBU#2, the playback period determination random number=[number of VOBUs], which was set to be [2], is decremented by 1 to obtain [1] (step ST803).

Since the decremented [number of VOBUs=1] is not zero (NO in step ST804), the flow returns to step ST802 to fetch the control pack (PCI) of the next VOBU (#3) and to play it back.

The above-mentioned processing in step ST802 repeats itself until the [number of VOBUs] becomes zero.

After the read and playback processes of the VOBUs (#2 and #3) of angle number #i (AGLN=i) have repeated themselves twice, the [number of VOBUs] becomes zero (YES in step ST804). Then, PCI data is read out from the navigation pack of the VOBU (VOBU#3) selected when the [number of VOBUs] has become zero (step ST805).

This PCI data contains non-seamless angle information NSML_AGLI shown in FIG. 13. If the angle number to be played back is #1 (AGL_C#i=AGL_C#1), the CPU of the playback apparatus looks up NSML_AGL_C1_DSTA in this non-seamless angle information NSML_AGLI, and obtains the destination address to angle number #1 (AGLN=1) therefrom (step ST806).

After that, the CPU of the playback apparatus freezes as a still picture the screen of the immediately preceding VOBU (#3) that has been played back, and searches VOBU#4 of angle number #1 on the basis of the obtained destination address to angle number #1 (AGLN=1) (step ST807). Then, the flow returns to step ST59 in FIG. 36.

Since the number of playback VOBUs determined in step ST801 in FIG. 38 (the default value of the [number of VOBUs] in step ST803) randomly changes depending on the random number generated by the random number generator/counter (504 in FIG. 63) in the CPU of the playback apparatus, the angle playback duration (=the number of VOBUs) changes every time the control processes the loop of steps ST48, ST50, ST80, ST59, and ST60 in FIG. 36.

The angle, the playback duration (playback period) of which changes in this way, is determined by the random number processing in step ST60.

More specifically, according to the processing shown in FIGS. 36 and 38, the playback angle number randomly changes in step ST60, and the duration of seamless angle playback also changes in every processing in step ST80.

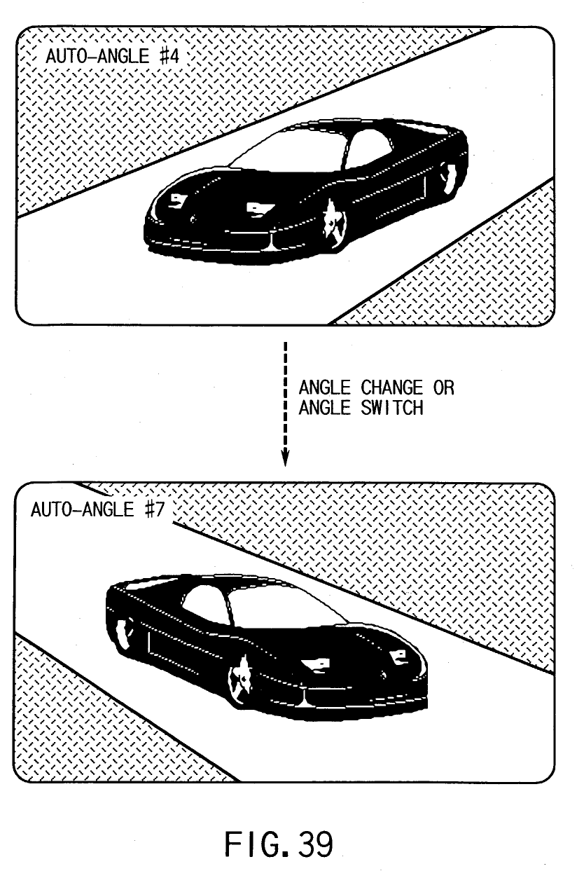

FIG. 39 exemplifies changes in playback screen when the playback angle has been switched in the automatic angle switching mode in one of FIGS. 34 to 36.

When the playback angle has been switched automatically (independently of the user's will), the user cannot determine the switching timing and the switched angle, especially, in random angle switching.

For this reason, as shown in FIG. 39, in the automatic angle switching mode (auto-angle=ON), the OSD unit of the playback apparatus generates characters or symbols that indicate the angle number which is being currently played back, and superimposes them on the angle image which is being played back. In this fashion, the user can know the current playback angle by the superimposed angle number during auto-angle playback (that number changes in correspondence with the playback angle like AUTO-ANGLE#4, AUTO-ANGLE#7, and the like).

Note that the angle number (AUTO-ANGLE#4, AUTO-ANGLE#7, and the like) during auto-angle playback need not always be displayed on the playback screen all the time. The user may set using the setup menu, so that the angle number is displayed for a predetermined period of time (about several seconds) after the angle has been automatically changed, and the angle number (AUTO-ANGLE#4, AUTO-ANGLE#7, and the like) is turned off after an elapse of the predetermined period of time. Alternatively, the user may set using the setup menu to prohibit the angle number (AUTO-ANGLE#4, AUTO-ANGLE#7, and the like) from being displayed even when the angle has been automatically changed.

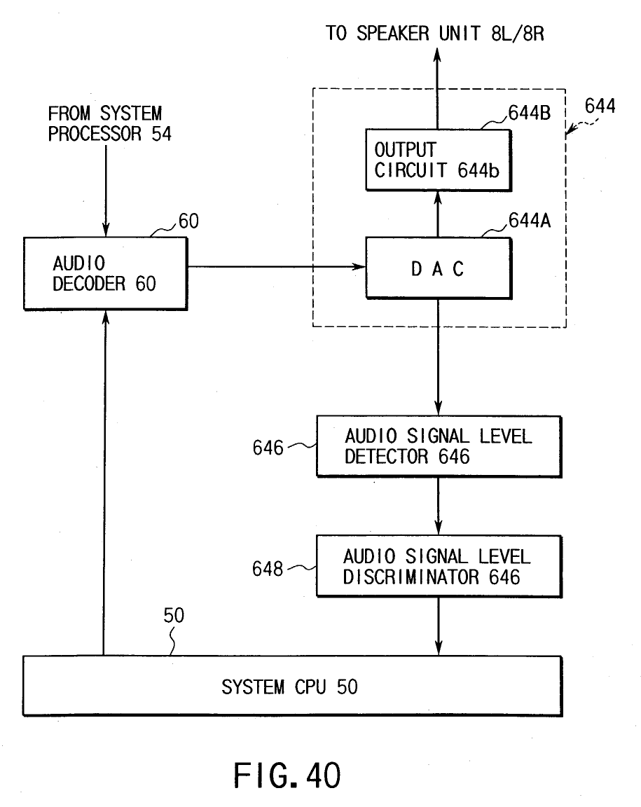

FIG. 40 is a block diagram for explaining the arrangement of principal part of a multiangle automatic switching/playback system obtained by partially modifying an apparatus shown in one of FIGS. 45 to 47 and FIG. 63 (to be described later).

Normally, multiangle pictures are accompanied by corresponding sounds. In this case, the playback angle can be automatically switched on the basis of changes in contents of such sounds.

More specifically, audio data (audio pack) recorded on DVD disk 10 is transferred from system processor 54 to audio decoder 60. Audio decoder 60 transfers digital data of the audio pack pertaining to the angle, which is being played back, to digital-to-analog converter (DAC) 644A under the control of system CPU 50 of the playback apparatus. DAC 644A D/A-converts the bitstream of the received audio data into an analog signal. The converted analog audio signal is appropriately amplified by output circuit 644B, and the amplified signal is output to external speaker units 8L/8R.

The analog audio signal (or digital audio data) processed by DAC 644A is input to audio signal level detector 646. Audio signal level detector 646 detects the signal level of the input analog audio signal (or the data value of the digital audio data). The detected signal level (data value) is compared with a predetermined discrimination level (discrimination data) by audio signal level discriminator 648. If the detected signal level (data value) has exceeded the predetermined discrimination level (discrimination data), audio signal level discriminator 648 determines an angle switching timing, and informs the system CPU of the playback apparatus of that message.

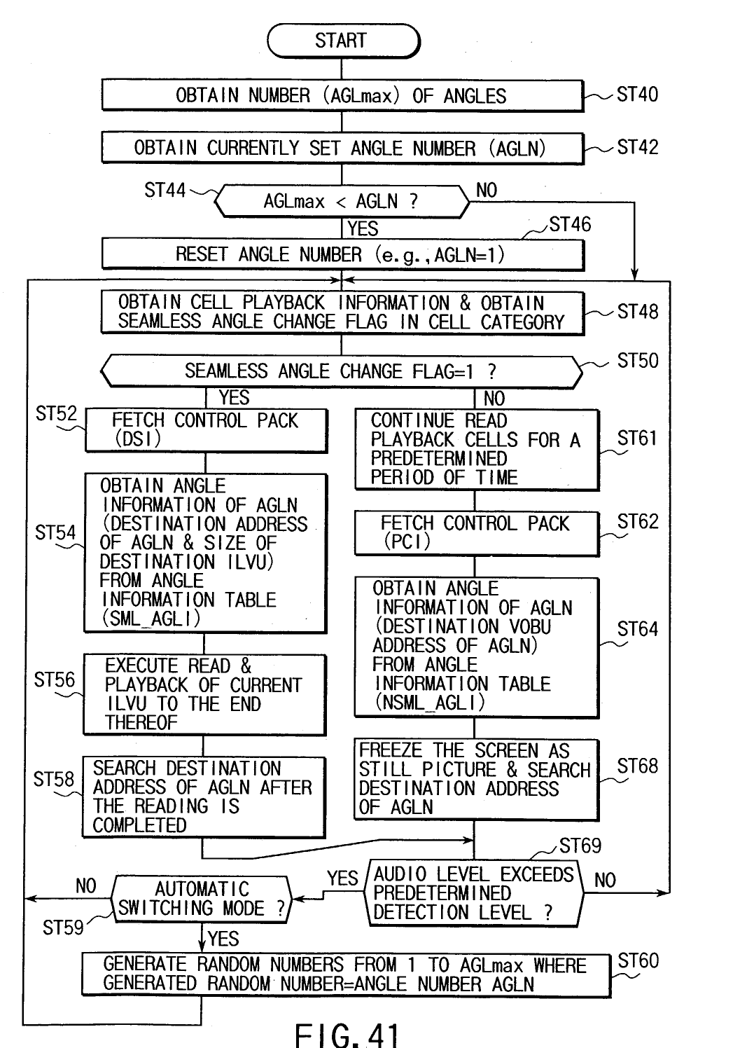

FIG. 41 is a flow chart for explaining the fourth example of automatic angle switching (auto-angle by audio signal level detection).

The processing shown in FIG. 41 is obtained by adding the audio signal level detection process (step ST69) to the random number generation auto-angle processing shown in FIG. 34, and is done by hardware shown in FIG. 40. Since the processing in steps ST40 to ST68 in FIG. 41 is the same as that in FIG. 34, a detailed description thereof will be omitted.

The arrangement shown in FIG. 40 can execute the following operations according to the procedure shown in FIG. 41.

Assume that DVD disk 10 stores a live concert of a certain rock band, and various scenes of that concert are taken and recorded using a plurality of cameras. For example, five cameras are respectively used for multiangle-recording scenes in “whole band”, “vocalist alone”, “guitarist alone”, “bassist alone”, and “drummer alone” angles. The angle “whole band” links to an audio pack that stores the sounds played by the whole band, the angle “vocalist alone” links to an audio pack that stores emphasized vocalist's voice data, the angle “guitarist alone” links to an audio pack that stores the emphasized lead guitar audio data, the angle “bassist alone” links to an audio pack that stores the emphasized bass guitar audio data, and the angle “drummer alone” links to an audio pack that stores the emphasized drum/percussion audio data.

Assume that the introduction part of a certain tune is being played back in the angle “whole band”, and the played sounds have become abruptly louder after the end of the introduction part. The change in level of the played sounds is detected by audio signal level detector 646+audio signal level discriminator 648 (YES in step ST69 in FIG. 41), and the CPU of the playback apparatus is informed that the automatic angle switching time is reached.

If the automatic angle switching mode is selected (YES in step ST59), the CPU of the playback apparatus controls the disk drive unit to read the ILVU (or VOBU) of a cell in another angle on the basis of the angle number automatically generated in step ST60 (step ST60).

As a result, assuming that the angle “vocalist alone” is automatically selected, the emphasized vocal audio data that links to the angle picture data of the vocalist is played back together with that picture data. On the other hand, assuming that the angle “drummer alone” is automatically selected, the emphasized drum/percussion audio data that links to the angle picture data of the drummer is played back together with that picture data.

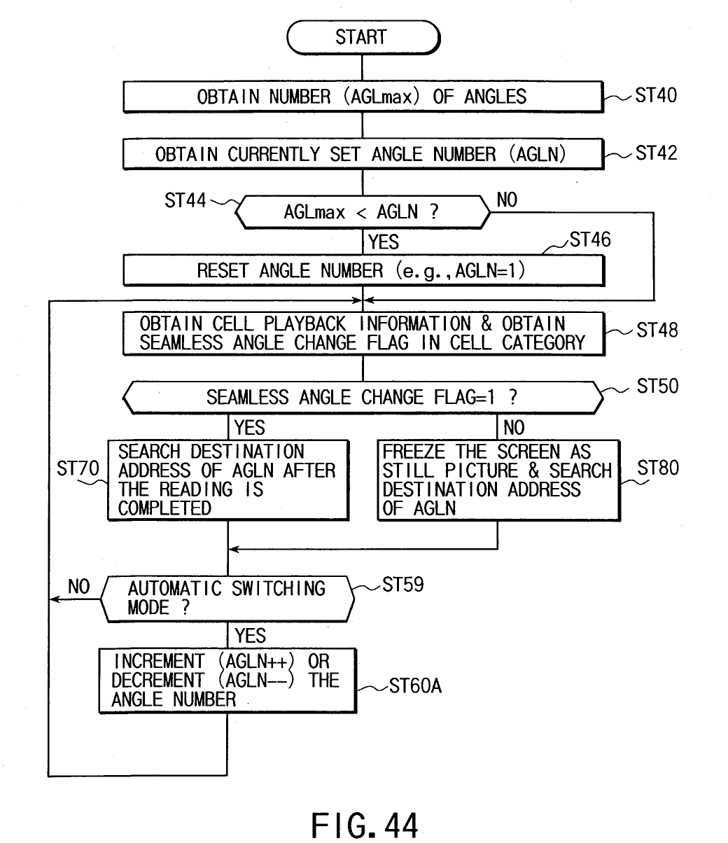

Note that the angle number automatic determination processing (ST60) by means of random number generation in FIG. 41 may be replaced by the angle number counting processing (ST60A; angle number increment/decrement processing) shown in FIG. 35 or 44.

In the arrangement shown in FIG. 40, when an analog audio signal is used in audio signal level detection for automatic angle switching, for example, the following processing can be done.

More specifically, a middle-range audio signal (about 200 Hz to 2 kHz) is picked up from the input signal level using a bandpass filter (to prevent automatic angle switching based on the audio signal level from erroneously operating due to unwanted noise components). The picked-up middle-range audio signal is detected to detect its audio signal amplitude (or the envelope level of that signal) (audio signal level detector 646).

The detected signal amplitude (envelope level) is sampled at a one-frame period (every 1/30 sec in a color TV signal of standard NTSC) of a video signal, and the sample value (DC level) is temporarily latched. The latched sample value is compared with a predetermined reference value by an analog comparator. When the sample value has exceeded the reference value, the comparator (audio signal level discriminator 648) outputs an audio detection signal (a binary signal that has changed from low level to high level).

The CPU of the playback apparatus executes automatic angle switching in response to the signal edge at which this audio detection signal changes to high level (YES in step ST69, YES in step ST59, and the processing in step ST60 in FIG. 41). When the audio detection signal output from the comparator (audio signal level discriminator 648) has changed from high level to low level or maintains low level, automatic angle switching is not executed (NO in step ST69 in FIG. 41).

Note that the bandpass filter for about 200 Hz to 2 kHz is not always necessary. In case of a sound source with a high S/N ratio, such bandpass filter is often not required. On the other hand, when automatic angle switching is to be done in a noisy environment (running noise of vehicles and the like) in response to human voice, the voice can be detected using a bandpass filter with a narrowed pass bandwidth corresponding to such noisy environment (high-pass or low-pass filter).

When a digital audio signal (linear PCM audio data of 16 to 24 bits) is used in audio signal detection in the arrangement shown in FIG. 40, for example, the following processing can be done (assuming a case wherein no filter is used). More specifically, the upper 8 bits of digital audio data (16 to 24 bits) are set in an 8-bit register (since the lower 8 to 16 bits define data from maximum volume level information (0 dB if they are all “1”s) to small volume level information (−48 dB or less), these bits are ignored).

If audio data set in the 8-bit register is “00000000”, since the audio signal level corresponds to a very small volume level below −48 dB, automatic angle switching is not executed (NO in step ST69 in FIG. 41).

If audio data set in the 8-bit register is “11110000” in the bit order from the LSB to MSB, the audio signal level is a small volume level, i.e., −24 dB, but the voice of a singer who is singing a ballad or the like corresponds to such level. Hence, automatic angle switching is executed (YES in step ST69, YES in step ST59, and the processing in step ST60 in FIG. 41).

If the angle number of the vocalist is known in advance in the angle block to be played back, the CPU of the playback apparatus may be programmed to execute processing for searching the angle number of the vocalist (step ST58 or ST68 after the angle number of the vocalist is set in step ST60 in FIG. 41) upon detecting audio data=“11110000”. In such case, since it is not easy to determine if the audio data=“11110000” is obtained from vocal data or accompaniment tone data, the vocal angle may not always be selected once the vocal play back has started. However, automatic angle switching that responds to changes in audio signal level is effective.

If the audio data set in the 8-bit register is “11111100” in the bit order from the LSB to MSB, the audio signal level corresponds to a middle volume level, i.e., −12 dB. Since most music play sounds correspond to such level, automatic angle switching is executed (YES in step ST69, YES in step ST59, and the processing in step ST60 in FIG. 41). In this case, since the sound source type of audio data=“11111100” cannot often be specified, angle switching is preferably executed randomly (step ST60 in FIG. 41).

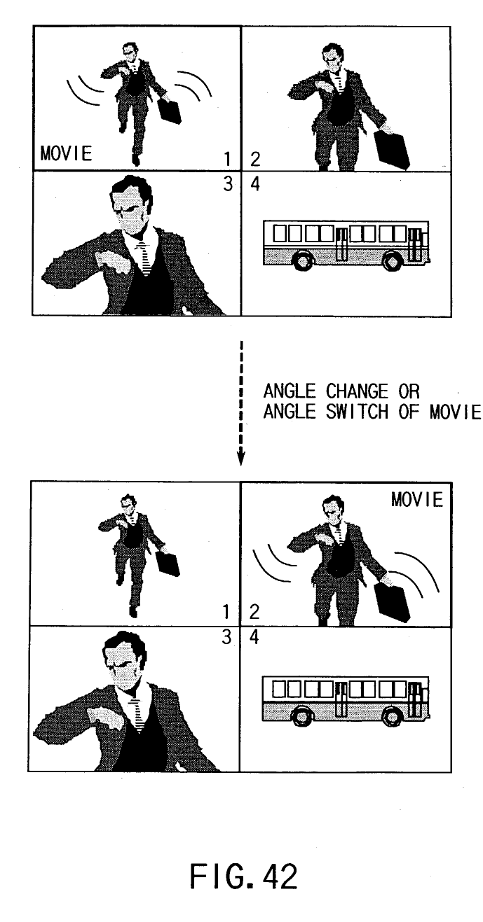

FIG. 42 is a view for explaining the case wherein n angle pictures that can be played back are displayed on a screen divided into n display areas (four areas), and the currently selected angle picture is displayed as a movie.

When the number of angles in the angle block recorded on the disk is, e.g., four, these angle pictures can be displayed by dividing the monitor screen into four areas, as shown in FIG. 42. The four-divided screen images are mapped on a frame memory (642 in FIGS. 45 to 47 and FIG. 63) of the playback apparatus, and are then sent to the monitor.

When n angle pictures are to be simultaneously displayed by dividing the display screen into n areas, the start addresses and sizes of the n angles are set. A case will be exemplified below wherein four angle cells are recorded in a seamless angle block, and they are divided onto the four-divided monitor screen areas. As shown in the upper image in FIG. 42, angle #1 is played back as a movie picture on the upper left area on the monitor. At this time, angles #2 to #4 are displayed as still images. (In the current DVD video format, since a single angle block can have a maximum of nine angle cells, the number n of divisions is a maximum of 9.)

Upon completion of the read and playback processes of angle #1 in correspondence with the predetermined number of ILVUs, the optical pickup (not shown) traces and jumps to a new ILVU at the angle switching destination, and the next angle #2 is played back as a movie picture, as shown in the lower image in FIG. 42. At this time, angles #1, #3, and #4 are displayed as still images.

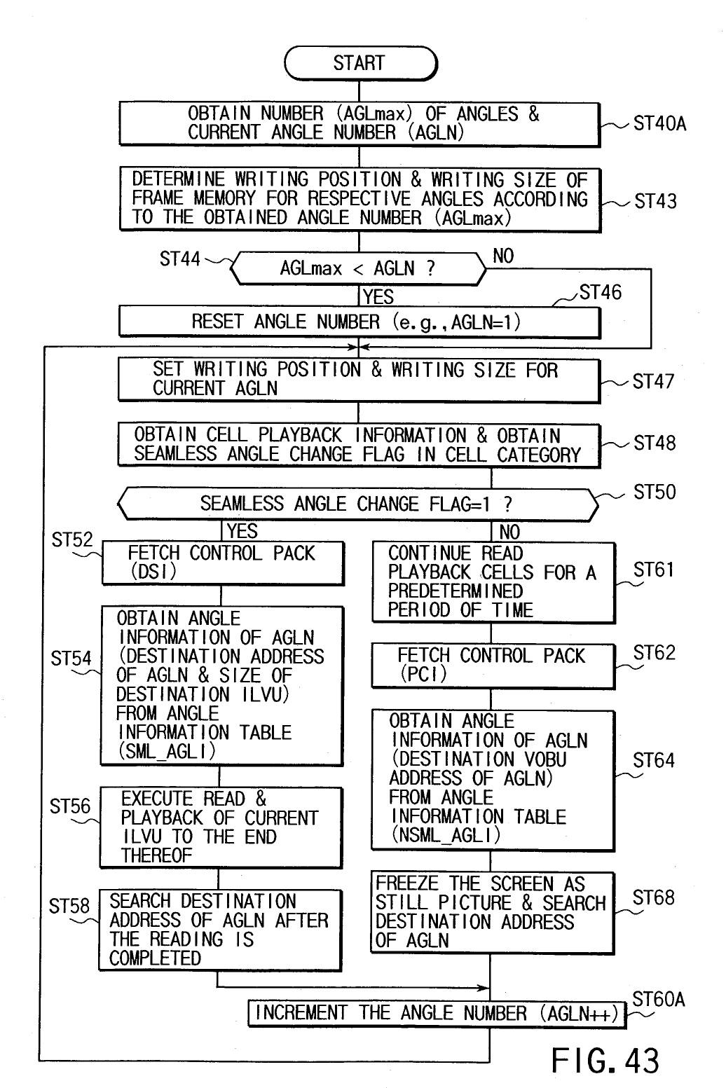

When automatic angle switching and playback processes sequentially progress in this manner, and playback is completed up to the maximum angle (in this case, AGLmax=4), the playback angle returns to angle #1. After that, angles #1 to #4 are cyclically played back (when the angle increment processing (ST60A) in FIG. 43 (to be described later) is used).

Alternatively, angles #1 to #4 can be cyclically played back while randomly switching the playback angle (when the random number angle processing (ST60) in FIG. 34 described above is used).

When the video decoder of the playback apparatus has two to four MPEG decoders, and can simultaneously and independently decode two to four MPEG-encoded videostreams (two to four angle cell data), movie pictures can be displayed on arbitrary ones (one to four) of the four-divided screen areas shown in FIG. 42.

For example, assume that the playback apparatus is a DVD player which is compatible with both a normal video mode (digital NTSC) having 525 scan lines and a horizontal resolution of 500 lines, and a high-resolution video mode (digital Hi-Vision) having 1,050 scan lines and a horizontal resolution of 1,000 lines, and implements playback of a Hi-Vision DVD disk by parallel processing of four MPEG2 decoders. In such DVD player, when an NTSC multiangle DVD disk is to be played back, since four MPEG decoders can be used, movie pictures can be displayed on all the four-divided screen areas shown in FIG. 42.

When a plurality of videostreams can be simultaneously and parallelly decoded using a plurality of (four in this case) MPEG decoders, as described above, and a buffer memory having a sufficiently large capacity can be used, pictures of a plurality of program chains (PGC#1 to PGC#k) in FIG. 5 may be displayed on the four-divided screen areas in FIG. 42 in place of those of the angle cells (AGL_C#i) shown in FIG. 15 or 21.

Note that FIG. 42 exemplifies tiling layout of the four screen areas. Alternatively, four screen areas may be displayed using overlapping windows. For example, in case of the upper image in FIG. 42, angle #1 played back as a movie picture is displayed on the full screen, and angles #2 to #4 as still images may be displayed on small windows popped up on the display screen of angle #1. In such case, when the angle to be played back as a movie picture is switched to #2, as shown in the lower image in FIG. 42, the movie picture of angle #2 is displayed on the screen, and still images of angles #1, #3, and #4 are displayed on three small windows.

FIG. 43 is a flow chart for explaining the fifth example of automatic angle switching (auto-angle by means of n-divided display).

When the user has pressed playback key 5c of remote controller 5 after the angle number to be played back is determined by the processing in FIG. 33, playback of DVD disk 10 starts. When the playback position enters the angle block shown in FIG. 15 or 21, the CPU of the playback apparatus obtains the number (AGLmax) of angles in that angle block (four in the example in FIG. 42), and the current angle number (AGLN) to be played back (#1 in the example of the upper image in FIG. 42) (step ST40A).

Based on the obtained number of angles (AGLmax=4), the writing positions and sizes of the respective angles in the frame memory of the playback apparatus are determined (step ST43).

For example, a case will be examined below wherein a bitmap image for one frame to be mapped on the frame memory has a resolution of 640×480 dots, and each dot is expressed by 8-bit gradation. In this case, if equally divided display corresponding to the obtained number of angles is to be made, one frame is divided into four small screen areas each having 320×240 dots. The first small screen area (positions of horizontal 1st to 320th dots; positions of vertical 1st to 240th dots) is assigned to angle #1; the second small screen area (positions of horizontal 321st to 640th dots; positions of vertical 1st to 240th dots) to angle #2; the third small screen area (positions of horizontal 1st to 320th dots; positions of vertical 241st to 480th dots) to angle #3; and the fourth small area (positions of horizontal 321st to 640th dots; positions of vertical 241st to 480th dots) to angle #4.

Alternatively, when one angle to be displayed as a movie is displayed on the full screen, and other angles are displayed as still images on small windows, assignment for one frame may be done as follows.

More specifically, the full screen (640×480 dots) is assigned to movie display angle AGLN=x; the first window frame (positions of horizontal 40th to 160th dots; positions of vertical 50th to 140th dots) to first still display angle AGLN=y1; the second window frame (positions of horizontal 40th to 160th dots; positions of vertical 190th to 280th dots) to second still display angle AGLN=y2; and the third window frame (positions of horizontal 40th to 160th dots; positions of vertical 330th to 420th dots) to third still display angle AGLN=y3. In this case, the 90×120 (dots) first window frame (AGLy1) is popup-displayed on the upper left position of the full screen frame (AGLx), the 90×120 (dots) second window frame (AGLy2) is popup-displayed at the left central position of the full screen frame, and the 90×120 (dots) third window frame (AGLy3) is popup-displayed on the lower left position of the full screen frame.

Upon displaying the full screen and three popup windows, a movie of current angle number AGLN (in the example of the upper image in FIG. 42, AGLx=#1) selected as the angle to be played back is displayed on the full screen, the still image of the first non-selected angle number (AGLy1=#2 in the example of the upper image in FIG. 42) is displayed on the first window frame, the still image of the second non-selected angle number (AGLy2=#3 in the example of the upper image in FIG. 42) is displayed on the second window frame, and the still image of the third non-selected angle number (AGLy3=#4 in the example of the upper image in FIG. 42) is displayed on the third window frame.

After the writing positions and sizes of the respective angles on the frame memory are determined in this way, it is checked if angle number AGLN set at that time (as the angle number to be played back) has exceeded the obtained number of angles (AGLmax=4). If AGLN>AGLmax=4 (YES in step ST44), angle number AGLN is reset to a predetermined value equal to or smaller than AGLmax, e.g., “1” (step ST46). If AGLN at that time is equal to or smaller than AGLmax=4 (NO in step ST44), the flow skips the reset processing in step ST46.

After angle number AGLN to be played back is limited not to exceed the obtained number of angles (AGLmax=4), the writing position and size of angle number AGLN (angle #1 in this case) in the frame memory are designated (step ST47).

In case of equally four-divided display like in FIG. 42, the first small screen area (positions of horizontal 1st to 320th dots; positions of vertical 1st to 240th dots) is assigned to angle #1.

After that, the same processing as in FIG. 34 is executed in steps ST48 to ST58 and steps ST61 to ST68.

In FIG. 34, step ST59 for checking if the automatic angle switching mode is started is executed after a destination address search in step ST58 or ST68. However, in FIG. 43, this check step is omitted (i.e., after the processing in step ST58 or ST68, the angle number to be played back as a movie is always changed in step ST60A).

Note that the angle number increment processing step ST60 in FIG. 43 may be replaced by angle number decrement processing or the random number generation step ST60 like in FIG. 34.

In the above description, the multiangle data that records nearly identical scenes in different camera angles has been exemplified. However, the automatic switching/playback system of the present invention can be similarly applied to multiscene data that records various scenes of different situations. For example, a running scene of a business man may be displayed on upper left screen area #1 in FIG. 42, a travel scene of a sport car like in FIG. 39 may be displayed on upper right screen area #2, a home-run scene of a baseball game may be displayed on lower left screen area #3, and a boxing game scene may be displayed on lower right screen area #4.

FIG. 44 is a flow chart for explaining the sixth example of automatic angle switching (auto-angle by counting angle numbers with a variable angle switching period).

FIG. 44 is a flow chart for explaining the sixth example of automatic angle switching (auto-angle by counting angle numbers with a variable angle switching period) according to another embodiment of the present invention. In this flow chart, random number generation step ST60 in FIG. 36 is replaced by angle number increment/decrement processing step ST60A, and other processing steps ST are common to those in FIG. 36.

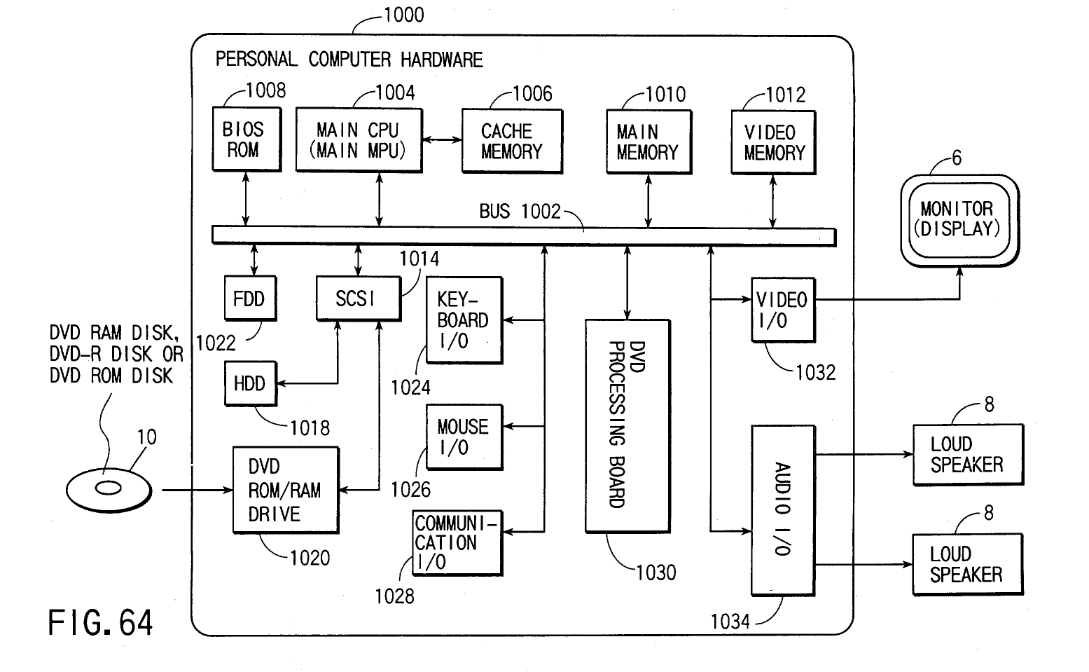

In a personal computer (to be described later with reference to FIG. 64) that can play back a DVD video using a DVD-ROM drive, auto-angle of the present invention can be implemented by software. In such case, auto-angle software installed in that personal computer is obtained by programming the processing operations corresponding to those shown in FIGS. 33 to 44.

When auto-angle software is programmed on the personal computer in such way, for example, angle number increment processing step ST60A in FIG. 35 can be modified to a higher-grade one.

For example, in the angle playback setups shown in FIG. 31, if the angle number is simply incremented, the angle number is automatically switched like angle numbers #1, #2, #4, #7, #1, #2, . . . . However, such automatic switching can be extended to auto-angle playback in the order that the user desired like #1, #7, #4, #2, #4, #7, #1, #7, . . . by computer programming.

The above-mentioned auto-angle program can be individually installed on a personal computer with a DVD drive via a floppy disk, CD-ROM, DVD-ROM, or communication media.

Note that auto-angle described above with reference to FIGS. 34 to 44 is not limited to the case wherein a specific angle picture is displayed on the TV monitor. As shown in, e.g., FIG. 42, when a plurality of angle pictures are simultaneously displayed on the TV monitor, auto-angle (automatic angle switching) may be executed independently in units of angle screen areas.

FIG. 45 is a block diagram for explaining the overall arrangement of a first playback apparatus with a built-in multiangle/scene digest display system.

This playback apparatus comprises remote controller 5 that accepts user operations, remote control receiver 4A for receiving the operation state of remote controller 5, key input portion 4 for accepting user operations at the playback apparatus main body side, and display panel 4B which informs the user of the operation result of the user, the playback state of DVD disk (optical disk) 10, and the like, and is arranged on the playback apparatus main body (and/or remote controller). As other external devices, monitor display 6 and speaker units 8L/8R are prepared.

Key input portion 4, display panel 4B, remote controller 5, and monitor display 6 form a visual user interface. Monitor display 6 is used not only as a playback picture monitor of the DVD disk but also as an OSD (ON-Screen Display) display means. This monitor display 6 is not limited to a direct-view CRT display, liquid crystal display, or plasma display, but may be a CRT projector, liquid crystal projector, or micromirror projector that projects pictures including OSD information on a large screen, in addition to the direct-view type display.

The apparatus comprises speaker units 8L/8R as a portion that forms an auditory user interface. In this embodiment, a pair of 2-channel stereophonic speaker units 8L/8R are used as a simple example. However, five or more pairs of loudspeakers may be prepared to cope with a multi-channel digital surround system (AC-3, DTS, SDDS, and the like).

User operation information from remote controller 5 is supplied to system CPU 50 that controls the operation of the overall playback apparatus via remote control receiver 4A. User operation information at key input portion 4 is directly supplied to CPU 50. CPU 50 displays the operation state (various setup states and playback information of the DVD disk) of the playback apparatus corresponding to user operation information on display panel 4B as needed.

System CPU 50 of the playback apparatus comprises automatic angle switcher 500 implemented by a predetermined processing program. This automatic angle switcher 500 includes playback period determiner 502 for determining the switching/playback period of multiangle pictures, simultaneous display controller 504A for simultaneously displaying a plurality of angles and determining the angle number to be displayed as a movie of these angles and its display timing, and selection controller 506A for controlling switching and display to the angle number designated by the user, simultaneous playback of sub-picture and audio data, simultaneous display of the angle numbers on the screen, and the like. With this arrangement, system CPU 50 can execute multi-screen angle display control (multiangle digest display control).

When angle switching is done in units of ILVUs, the continuous movie playback time (period) of an identical angle can be arbitrarily determined. This continuous movie playback time (period) of the angle can be managed by playback period determiner 502 in system CPU 50.

This automatic angle switcher 500 may include a random number generator/counter (504 in FIG. 63) for generating the angle number to be automatically switched by generating a random number or counting the angle numbers, and an angle number determiner (506 in FIG. 63) for determining the angle to be automatically switched in association with the angle number designated in the playback permitted state by the user. With this arrangement, system CPU 50 can also execute control for automatically switching the playback angle in a portion where multiangle pictures are recorded (auto-angle control).

System CPU 50 is connected to memory (RAM and ROM) 52 and memory interface (memory I/F) 53. The ROM in memory 52 stores various processing programs used in operation control of the playback apparatus, and the RAM in memory 52 used as a work area. This memory 52 is I/O-controlled via memory I/F 53.

CPU 50 uses the RAM in memory 52 as a work area, and controls the operations of disk drive 30, system processor 54, video decoder 58, audio decoder 60, sub-picture decoder 62, and DAC & reproduction processor 64 on the basis of various processing programs stored in the ROM in memory 52.

Disk drive 30 rotates DVD disk 10 set on a tray (not shown) of the playback apparatus main body, and reads out, from DVD disk 10, recording data (main picture data containing movie information and still image information/video data, sub-picture data containing superimposed dialogue information and menu information, audio data containing audio information, navigation data for implementing playback control that the DVD disk provider intended, and the like). Readout data are subjected to signal processing such as signal demodulation, error correction, and the like in disk drive 30, and are sent as a data sequence in the pack format (see FIG. 7) to system processor 54.

In the data sequence output from disk drive 30, the order of three different types of packs after the navigation pack may be arbitrarily determined. The number of types of packs after the navigation pack may be three or less (none, one, or two). Multiangle playback in the DVD disk requires at least navigation and video packs of these packs.

System processor 54 incorporates a packet transfer processor (not shown) that determines various types of packets contained in data played back from DVD disk 10, and transfers data in these packets to the corresponding decoders (58 to 62).

System processor 64, video decoder 58, audio decoder 60, and sub-picture decoder 62 respectively include registers (not shown) for temporarily storing a system time clock (STC) used for determining the operation timings, and commands, information, and the like from system CPU 50.

The packet transfer processor in system processor 54 segments the data sequence in the pack format output from disk drive 30 into four different types of packs (navigation, video (main picture), sub-picture, and audio packs). Each of these packs records transfer time data and ID data indicating the data type.

System processor 54 respectively transfers the video, sub-picture, and audio packs to video, sub-picture, and audio decoders 58, 62, and 60 with reference to the transfer time data and ID data of these packs.

System processor 54 also transfers control data in the navigation pack to memory (RAM) 52 via memory I/F 53. Memory I/F 53 is an interface circuit that I/O controls RAM 52. RAM 52 temporarily stores the transferred control data. CPU 50 controls playback operations of the respective units of the playback apparatus main body with reference to the control data stored in RAM 52.

Video decoder 58 decodes MPEG-encoded video data in each video pack transferred from system processor 54, and generates picture data before compression.

Sub-picture decoder 62 decodes runlength-compressed sub-picture data in each sub-picture pack transferred from system processor 54, and generates bitmap sub-picture data before compression.

Sub-picture decoder 62 includes a highlight processor (not shown) for performing highlight processing for decoded sub-picture data in addition to a sub-picture decoder for decoding sub-picture data from system processor 54.

The sub-picture decoder expands pixel data (including emphasized pixels, pattern pixels, background pixels, and the like) in units of 2 bits, which are runlength-compressed according to a predetermined rule to recover an original bitmap image.

The highlight processor performs corresponding highlight processing in accordance with X- and Y-coordinate values representing a rectangular region where highlight information (e.g., menu selection item) is displayed, color code, and highlight color/contrast value, which are supplied from system CPU 50.

This highlight processing can be used as means for allowing the user to easily recognize a specific item (a button for selecting a specific item such as the type of playback spoken language, the type of language used in the playback superimposed dialogue, and the like) displayed on the visual user interface on monitor display 6.

When the colors and contrasts of decoded sub-picture data have been changed in units of pixels, the changed sub-picture data is supplied to an image synthesizer (not shown) in video processor 640. This image synthesizer synthesizes the decoded main picture data (video data) and sub-picture data (superimposed dialogue, menu, and the like) after the highlight processing, and the synthesized image is displayed on monitor display 6.

Memory 52 mentioned above includes a menu table which stores the start addresses of a sub-picture menu, audio menu, angle menu, chapter (program) menu, and the like. The above-mentioned highlight processing is used for emphasizing specific portions of these menus.

Audio decoder 60 decodes audio data in each audio pack transferred from system processor 54 to generate monaural, 2-channel stereophonic, or multi-channel stereophonic audio data. When audio data in each audio pack is compression-encoded data (MPEG, AC-3, DTS, or the like), audio decoder 60 also implements their decoding.

Picture data (normally, a movie signal) decoded by video decoder 58, and sub-picture data (normally, bitmap data of the superimposed dialogue or menu) decoded by sub-picture decoder 62 are transferred to video processor 640. In video processor 640, picture and sub-picture data are mixed at a predetermined ratio to generate display video data (digital). The generated video data is converted into a final analog picture signal (composite video signal, separate S signal, or component signals Y/Cr/Cb or Y/R-Y/B-Y) via video encoder 641, and the analog signal is output to monitor display 6.

When picture data decoded by video decoder 58 corresponds to the body portion of a movie, sub-picture data normally corresponds to superimposed dialogue data in the language selected by the user, and the movie body with the superimposed dialogue is played back on monitor display 6.

When picture data decoded by video decoder 58 corresponds to a menu portion of a movie, sub-picture data normally corresponds to characters that form menus and a user selection button (to be highlighted as needed). In this case, the background (still image or movie) of the menu is displayed based on the picture data on monitor display 6, and a button, the display state of which changes in correspondence with user selection operation, is superimposed based on the sub-picture data on the background image.

Note that video processor 640 can be comprised of an OSD unit (see FIG. 51) for generating ON-screen display data. User operation input at remote controller 5 or the like is processed by system CPU 50, and the processing result is sent from CPU 50 to the OSD unit of video processor 640. The OSD unit generates image data corresponding to the processing result from system CPU 50, and outputs that data to monitor display 6 in an analog video signal format.

In other words, video processor 640 serves as a unit for converting digital signals output from video decoder 58 and sub-picture decoder 62 into analog signals, and multiplexing these analog signals.

Video processor 640 is connected to frame memory 642. Frame memory 642 is used for multiplexing images of the picture and sub-picture data, and is also used for n-divided (four- or nine-divided) multi-screen display described above with reference to FIG. 42.

This frame memory 642 can be used when picture data output from video decoder 58 is frozen as a still image and the still image is sent to monitor display 6 until the target chapter begins to be played back in, e.g., a chapter search or the like.

Furthermore, frame memory 642 can also be used when display corresponding to the user operation result is made by OSD, and OSD display data is multiplexed on picture data.

Audio data decoded by audio decoder 60 is transferred to DAC with output circuit 644. DAC with output circuit 644 converts audio data (digital) from audio decoder 60 into a corresponding analog audio signal, amplifies it properly, and sends the amplified signal to speaker units 8L/8R.

Video processor 640, video encoder 641, frame memory 642, and DAC with output circuit 644 build DAC & reproduction processor 64.

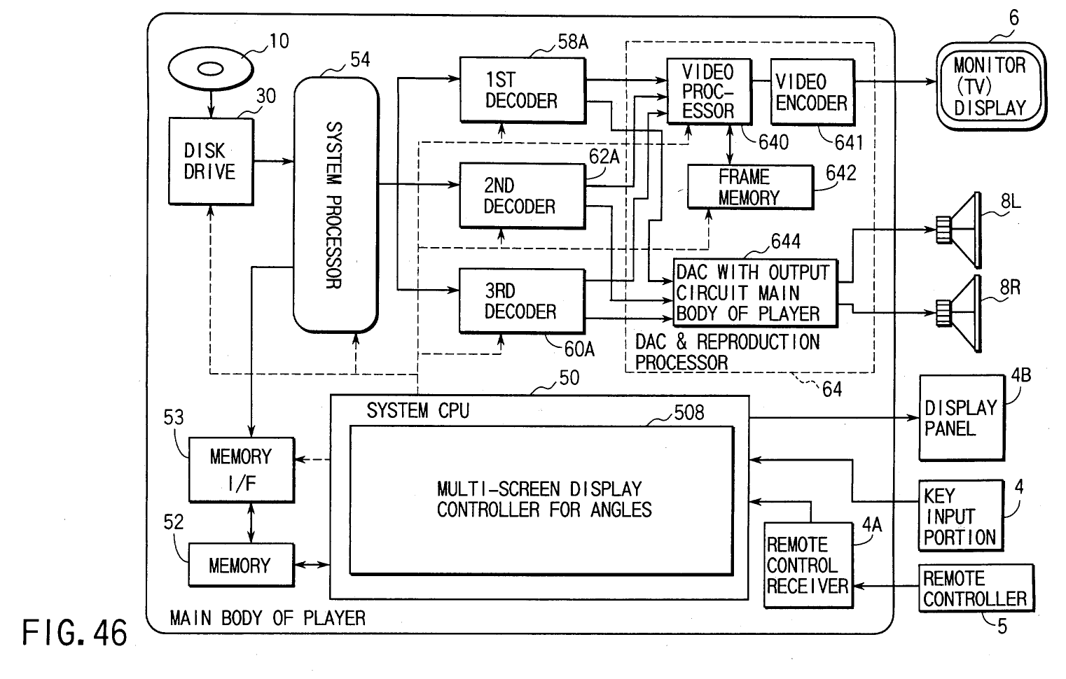

FIG. 46 is a block diagram for explaining the overall arrangement of a second playback apparatus with a built-in multiangle/scene digest display (multiangle movie simultaneous playback) system. FIG. 46 shows an example using a plurality of MPEG decoders.

The arrangement shown in FIG. 46 is substantially common to that in FIG. 45, except for decoder portions (58 to 62) and the functions (programs) of system CPU 50. Hence, the playback apparatus in FIG. 46 will be described below centering on the differences from FIG. 45.

In FIG. 46, first decoder 58A decodes data in video and audio packs transferred from system processor 54, transfers the MPEG-decoded video signal (main picture signal) to video processor 640, and transfers the decoded audio signal (AC-3 multi-channel signal, linear PCM signal, or the like) to DAC 644.

Second decoder 62A decodes data in sub-picture and audio packs transferred from system processor 54, transfers the decoded (runlength-expanded) sub-picture signal (superimposed dialogue or menu data) to video processor 640, and transfers the decoded audio signal to DAC 644.

Third decoder 60A decodes data in video and audio packs transferred from system processor 54, transfers the MPEG-decoded video signal (main picture signal) to video processor 640, and transfers the decoded audio signal to DAC 644.

DAC 644 selects one or a plurality of the audio signals transferred from the first to third decoders in accordance with a command from system CPU 50, converts it or them into an analog audio signal or signals, and output the signal or signals.

Video processor 640 selects one (or both) of the video signals transferred from the first and third decoders in accordance with a command from system CPU 50, superimposes sub-picture data from the second decoder on the selected signal or signals as needed, and transfers the signal or signals to video encoder 641.

When the apparatus comprises a plurality of MPEG decoders (two, i.e., first and third decoders), as shown in FIG. 46, movie data can be displayed on a plurality of (two in this case) angle screen areas in multi-screen multiangle digest display like in FIG. 42. The multi-screen multiangle movie digest display is directed by multi-screen display controller 508 for angles in system CPU 50. Upon executing the multi-screen multi-angle movie digest display, in order to simultaneously and smoothly display movie data on two screen areas, disk drive unit 30 preferably uses a high-speed drive (double- or triple-speed).

In addition, since the arrangement in FIG. 46 has a plurality of independent audio decoders, a plurality of types (e.g., linear PCM, AC3 multichannel, and DTS multichannel) of audio decoding operations can be simultaneously performed.

For example, assume that first decoder 58A uses an AC-3 decoder, second decoder 62A a DTS decoder, and third decoder 60A a linear PCM decoder. When an audio pack played back from DVD disk 10 contains two different types of audio signals, e.g., an AC-3 digital audio signal and linear PCM audio signal, first decoder 58A can output 5.1-channel multi-audio data for AC-3, and third decoder 60A can output 2-channel stereophonic audio data. These audio data are converted by DAC 644 into analog audio signals. As a consequence, audio data for the two, front right and left channels are played back using linear PCM data, and audio data for surround channels and a sub-woofer channel are played back using AC-3 data.

Likewise, when an audio pack played back from DVD disk 10 contains two different types of audio signals, e.g., a DTS digital audio signal and linear PCM audio signal, first decoder 58A can output 5.1-channel multi-audio data for DTS, and third decoder 60A can output 2-channel stereophonic audio data. These audio data are converted by DAC 644 into analog audio signals. As a consequence, audio data for the two, front right and left channels are played back using linear PCM data, and audio data for surround channels and a sub-woofer channel are played back using DTS data.

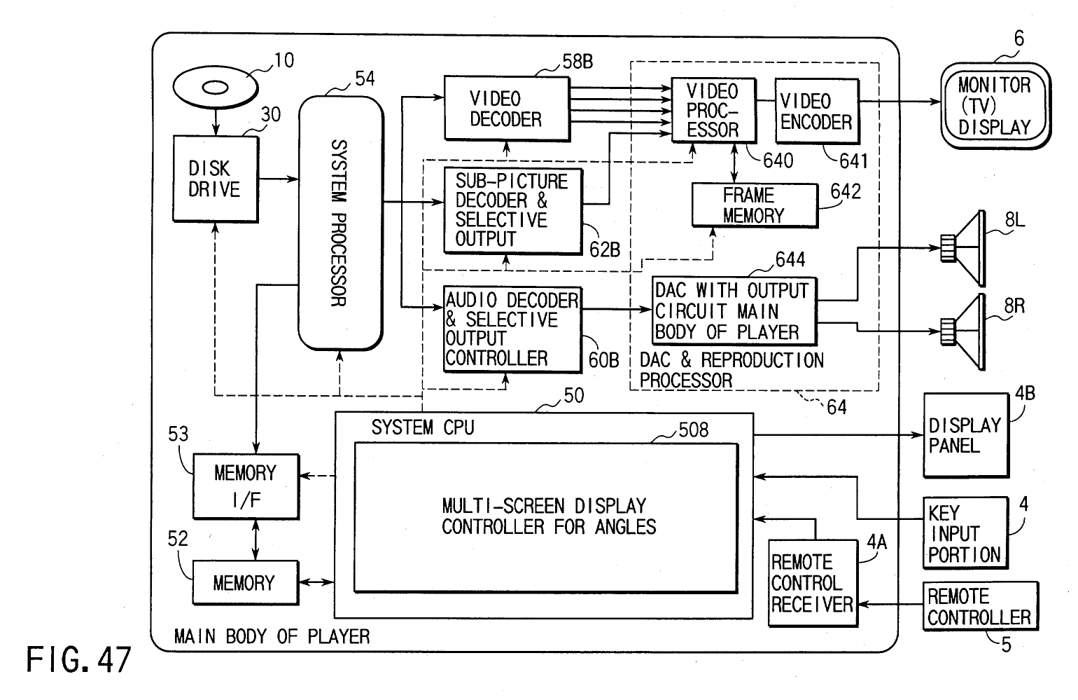

FIG. 47 is a block diagram for explaining the overall arrangement of another playback apparatus with a built-in multiangle/scene digest display (multiangle movie simultaneous playback) system. FIG. 47 shows an example using a high-performance decoder.

The arrangement in FIG. 47 is substantially common to that in FIG. 45, except for the functions (processing performance) of a decoder portion (58). Hence, the playback apparatus in FIG. 47 will be explained below centering on differences from FIG. 45.

In FIG. 47, video decoder 58B high-speed decodes data in a video pack (multiangle data) high-speed transferred from system processor 54, and transfers the MPEG-decoded video signal (multiangle main picture signal) to video processor 640. In the example shown in FIG. 42, video decoder 58B can substantially simultaneously MPEG-decode videostreams in a plurality of (a maximum of four) angles.

Sub-picture decoder & selective output 62B decodes data in a sub-picture pack transferred from system processor 54, and selectively transfers the decoded (runlength-expanded) sub-picture signal (superimposed dialogue or menu data) to video processor 640 in accordance with a command from system CPU 50.

For example, when video decoder 58B is transferring four multi-screen movie video signals to video processor 640, if a specific angle (e.g., angle #1 in FIG. 42) has been selected, sub-picture data (superimposed dialogue or the like) corresponding to this specific angle (angle #1) is selected. The selected sub-picture data is transferred from sub-picture decoder & selective output 62B to video processor 640.

Video processor 640 superimposes sub-picture data (superimposed dialogue or the like) from sub-picture decoder & selective output 62B on picture data of the specific angle (angle #1) of the 4-screen multiangle video signals from video decoder 58B, and sends them to video encoder 641.

Audio decoder & selective output (controller) 60B decodes data in an audio pack transferred from system processor 54, and selects one (movie display angle #1 or #2 bounded by the bold frame in the example of FIG. 42) of decoded audio signals for a plurality of angles (e.g., four angles in the example in FIG. 42) in accordance with a command from system CPU 50. The digital audio signal of the selected angle is transferred to DAC 644.

DAC 644 converts the digital audio signal transferred from audio decoder & selective output 60B into an analog audio signal, and outputs it to a device outside the playback apparatus.

When angle pictures #1 to #4 displayed in the multiangle digest display mode (FIG. 42) use common audio data, the need for selecting the audio signal in audio decoder & selective output 60B can be obviated.

Video decoder 58B in FIG. 47 has high MPEG processing performance, and has performance capable of substantially simultaneously implementing a plurality of MPEG decode processes (e.g., performance of implementing MPEG decode at a speed four times or more normal playback). In this case, upon executing multi-screen multiangle digest display in FIG. 42, movie data can be displayed on all of a plurality of (a maximum of four) angle screen areas. The multi-screen multiangle movie digest display is directed by multi-screen display controller 508 for angles in system CPU 50. In this multi-screen multiangle movie digest display, in order to simultaneously and smoothly display movie data on four screen areas, disk drive 30 preferably uses a high-speed drive (quadruple- or quintuple-speed drive).

FIG. 48 is a view for explaining the arrangement of a remote controller that can be used in the playback apparatus/DVD video player/personal computer with the DVD playback function (or a recording/playback apparatus/DVD video recorder (not shown)) shown in FIGS. 45 to 47 or FIGS. 63 and 64. The DVD video player or DVD video recorder allows the user to make fundamental operations using operation keys provided to its main body front panel (not shown). However, various operations using DVD features are made by remote controller 5.

The functions (or the ways of use) of the respective keys on remote controller 5 shown in FIG. 48 will be explained below.

[Function of Power Key (POWER) 5a]

<1> The power key turns on/off the secondary side of an AC power supply circuit of the apparatus main body.

<2> When the power key is pressed while a disk is set inside the apparatus, the type of disk (DVD-RW, DVD-R, or DVD video) is determined and displayed. If that disk cannot be played back, a message indicating this is displayed.

<3> When the power key is pressed when a disk set inside the apparatus contains a first-play program chain (auto-start code), playback of that program chain automatically starts.

<4> When the power key is pressed while power is ON and the tray is open, the tray is closed, and the power supply is turned off.

[Function of Open/close (OPEN/CLOSE) 5g]

<5> The open/close key opens/closes the disk tray. When the open/close key is pressed during disk playback, the apparatus operation made so far ends, and the disk tray is opened. During recording, the operation of key 5g is invalidated.

<6> When the open/close key is pressed while power is OFF and the tray is closed, the power supply is turned on, and the disk tray is opened.

<7> When the open/close key is pressed while the disk tray is open, the disk tray is retracted into the apparatus main body. At this time, if a disk is set on the tray, its management information is read, and the type of set disk (DVD-RW, DVD-R, or DVD video) is displayed. If that disk cannot be played back, a message indicating this is displayed.

<8> When the open/close key is pressed while the disk tray is open, the disk tray is retracted into the apparatus main body. At this time, if no disk is set on the tray, for example, a message “NO DISK” is displayed on display panel 4B or monitor TV (OSD).

<9> When the disk retracted into the apparatus main body upon ON of the open/close key contains a first-play program chain (auto-start code), playback of that program chain automatically starts.

[Function of Stop Key (STOP) 5e]

<10> When the stop key is pressed during disk playback or recording, playback or recording is stopped. When the stop key has been pressed in the halt state, the title number played back or recorded so far (or a default title number) is displayed.

[Function of Playback Key (PLAY) 5c]

<11> When the playback key is pressed while a disk is set on the disk tray, playback of that disk is started under the conditions (default setups, or the screen aspect ratio, spoken language, superimposed dialogue language, and the like set by the user) set at that time.

<12> When the playback key is pressed after a disk is set on the open tray, the tray is retracted into the apparatus main body, and playback starts from a default title (or a title designated by the title producer) recorded on the DVD disk. If the disk contains a first-play program chain (auto-start code), that chain is executed.

<13> Playback ends at the end of a title unless otherwise specified in information recorded on a disk.

<14> When the playback key is pressed while the chapter and title numbers are set on a memory setup screen which is being displayed, memory playback starts from the position of the set chapter and title numbers.

<15> When the playback key is pressed while a random mode is selected, the contents of a disk set on the tray are randomly played back.

<16> When the cell playback mode of the disk is switched to a still mode during playback, playback made so far is canceled, and a still image is played back.

[Function of Pause key (PAUSE) 5d]

<17> When the pause key is pressed during playback of a program chain in a certain title, a video frame in the program chain which is currently being played back is displayed as a still image. When the pause key has been pressed once again in this state, the displayed image is switched to a still image of the next frame. Likewise, every time the pause key has been pressed, the frame is switched in the time progress direction, and the frame advances in correspondence with the number of times of depression of this key.

<18> During still image playback or frame-by-frame playback, sub-picture data may be played back, but audio data may be prohibited from being played back.

<19> The still image playback or frame-by-frame playback is allowed in only the program chain that is currently being played back, and after the frame reaches to the last one in the title, this key operation is invalidated.

<20> When a still image is displayed in the cell playback mode, this key operation is invalidated for the last still cell.

<21> When the playback key is pressed in the still image state set by that key operation, normal playback restarts.

[Function 1 of Skip Key (SKIP/Rightward Double-Triangular Mark with Vertical Bar) 5f; In Case of One Sequential Program Chain Title]

<22> When this skip key is pressed during playback, the next chapter (or program) in the title which is currently being played back is found by a search and played back. If no next chapter is available, this key operation is invalidated. During the chapter search, the search destination chapter number on display panel 4B (or OSD) is flickered to inform the user that a search is in progress.

<23> When this skip key is pressed in the halt state, the chapter next to the current chapter is selected. When the playback key is turned on in this state, the selected chapter is played back upon search.

In the halt state, chapters (or programs) present across two titles can be skipped. For example, when this skip key has been pressed while the last chapter number of title 1 is displayed, the first chapter number of title 2 is selected. When the playback key is turned on in this state, the selected chapter (chapter 1 of title 2) is played back upon search.

<24> When the skip key is kept pressed for a predetermined period of time or more in the halt state, the chapter number increases in unitary increments at a given speed (if the next title is available, the chapter number can be continuously changed from the current title to the next title). When the playback key is pressed after the skip key that has been held down is released, the chapter of the title selected at that time is played back upon search.

[Function 2 of Skip Key (SKIP/Rightward Double-Triangular Mark with Vertical Bar) 5f; In case of Random Program Chain Title]

<25> When the skip key is pressed during playback, a chapter (or program) randomly selected next to the chapter in the title which is currently being played back is played back upon search. However, when the number of times of random playback loops has reached its maximum value, and no next program chain is available in the title, this operation is invalidated.

<26> When the skip key is pressed during playback of a still image, the selected chapter (or program) is located by a search, and a still image is played back at the beginning of that chapter. However, when a still image is displayed in the cell playback mode, the selected chapter is found by a search, and a still image at the beginning of that chapter is played back.

<27> The skip key can be used for selecting the chapter number (program number) and title number set on the memory setup window (to increment values, move the cursor forward, and so forth).

<28> The skip key can be used for changing the menu page.

[Function 1 of Skip Key (SKIP/Leftward Double-Triangular Mark with Vertical Bar) 5f; In Case of One Sequential Program Chain Title]

<29> When this skip key is pressed during playback, the beginning of the current playback chapter (or program) in the title which is currently being played back is played back upon search. When this key is kept pressed, the chapter number decreases in unitary decrements to chapter number 1.

<30> When this skip key is pressed in the halt state, the chapter immediately preceding the current chapter is selected. When the playback key is turned on in this state, the selected chapter is played back upon search.

In the halt state, chapters (or programs) present across two titles can be skipped. For example, when this skip key has been pressed while chapter number 1 of title 3 is displayed, the last chapter number X of title 2 is selected. When the playback key is turned on in this state, the selected chapter (chapter X of title 2) is played back upon search.

Chapter decrement skip across different titles can be executed until chapter 1 of title 1.

<31> When the skip key is held down for a predetermined period of time or more in the halt state, the chapter number decreases in unitary decrements at a given speed (until chapter 1 of title 1). When the playback key is pressed after the skip key that has been held down is released, the chapter of the title selected at that time is played back upon search.

[Function 2 of Skip Key (SKIP/Leftward Double-Triangular Mark with Vertical Bar) 5f; In case of Random Program Chain Title]

<32> When the skip key is pressed during playback, the beginning of the chapter (or program) in the title which is currently being played back is played back upon search. In this case, the search destination can always be set at the beginning of the chapter (program) which is being currently played back even if the key is kept pressed.

<33> When the skip key is pressed during playback of a still image, the beginning of the current playback chapter (or program) is located by a search, and a still image is played back at the beginning of that chapter. However, when a still image is displayed in the cell playback mode, the chapter which is being played back is found by a search, and a still image at the beginning of that chapter is played back.

<34> The skip key can be used for selecting the chapter number (program number) and title number set on the memory setup window (to decrement values, move the cursor backward, and so forth).

<35> The skip key can be used for changing the menu page.

[Function of Menu key (MENU) 5n]

<36> When a disk is set on the tray, the root menu in the currently selected video title set recorded on the disk is played back and displayed. When no disk is set, an error (or warning) display is made (OSD).

<37> When no root menu is included in the currently selected video title set, an error (or warning) display is made (OSD).

<38> After a menu is played back by pressing this menu key during normal playback, when the control exits the menu display by pressing the menu key, playback restarts from the position played back before menu playback or a position designated by the menu.

<39> When the menu key is pressed while displaying the root menu, the display state returns to that before the root menu was displayed.

[Function of Title Key (TITLE) 5p]

<40> When a disk is set on the tray, and it records a title menu, the title menu is displayed. When no disk is set, an error (or warning) display is made (OSD).

<41> When no title menu is recorded on the disk set on the tray, the following operations can be made while the disk is being played back (or in the halt state).

More specifically, when the title key is pressed, the title number and chapter number are displayed on a portion (e.g., the upper left corner) of the screen. When a clear key (to be described later) is pressed, when the title key is pressed once again, or when a predetermined period of time (e.g., 3 sec) elapses without any key operations after that, the title number and chapter number are cleared from the screen.

When the title number (e.g., “1”) and chapter number (e.g., “1”) are displayed on the screen, and a desired title number (e.g., “2”) is input from the ten-key pad in this state, the screen display changes to “title number: 2” and “chapter number: 1” in case of the above example. When the playback key is pressed in this state, or when the apparatus is left unoperated for a predetermined period of time (e.g., 2 sec), playback starts from chapter 1 of title 2.

In this case, during the search for the title and chapter, the destination title number and chapter number on display panel 4B are flickered to inform the user that a search is in progress.

<42> After the title menu is played back by pressing the title key during normal playback, when the title key is pressed again before title selection is confirmed, playback restarts from the position that has been played back before menu title playback.

[Function of Select Key/Cursor Key (Upward•Downward Triangular Mark Pair) 5q]

<43> The select key/cursor key is used for item selection in a disk menu (a menu called by the title key or menu key) and item selection in the setup menu. For example, when a certain item is selected by pressing the upward or downward triangular mark on the select key/cursor key, if that item includes some choices, the leftward or rightward triangular mark of this select key/cursor key can be used to select one of these choices.

<44> When the select key/cursor key is pressed during display of the setup value of one of an audio stream, sub-picture stream, and angle, if the upward triangular mark of this select key is pressed, the next stream or angle is selected; if the downward triangular mark is pressed, the immediately preceding stream or angle is selected.

<45> When the select key/cursor key is pressed during display of the title number by a character generator, if the upward triangular mark of this select key is pressed, the next title is selected; if the downward triangular mark is selected, the immediately preceding title is selected.

[Function of End Key (END) 5end]

<46> This key is used when the user informs the apparatus that he or she wants to end selection/setup processing (to exit the processing loop such as setups of angles that can be played back, and the like).

The cursor operation for selecting a desired angle during display of a multiangle selection menu screen (not shown) can use select key/cursor key 5q described above or ten-key pad 5t (to be described later). (Alternatively, mouse operation or touch panel operation may be implemented although not shown.)

[Function of Confirmation Key (ENTER) 5s]

<47> This key is used to confirm an item selected in the disk menu or setup menu.

<48> This key can also be used to confirm the title number and chapter number on the memory screen.

[Function of Return Key (RETURN) 5r]

<49> The return key is used for making a search for the address on the disk, which is set in advance by the title producer (software provider). More specifically, this key is pressed to issue an exit instruction from the menu or a return instruction to the playback start (restart) point. Also, this key can be used to issue a return instruction to a selection branch point of multistories that can be selected by the user.

[Function 1 of Audio Key (AUDIO) 5aud; In Case of Playback]

<50> When the audio key is pressed during playback, the language name (when the type of audio stream is not a music or the like but is a language) of the audio stream which is currently being played back is displayed (OSD) on the playback screen for a predetermined period of time (e.g., 3 sec) using a character generator (after the audio stream information recorded on the disk is checked). When the audio key is pressed once again during this display, audio data of the next audio stream number is played back. When this audio key operation is repeated, audio data (various languages) of audio streams recorded in that title are cyclically played back.

<51> When select key/cursor key 5q is pressed while the audio stream setup value is displayed on the screen, an audio stream next to or immediately preceding the currently set audio stream can be selected. Then, the contents of the selected audio stream are played back.

<52> When a certain key on the ten-key pad is pressed while the audio stream setup value is displayed on the screen, an audio stream corresponding to the number input by the ten-key pad can be selected. Then, the contents of the selected audio stream are played back.

<53> When the clear key is pressed while the audio stream setup value is displayed on the screen, the audio stream setup value display can be cleared from the screen.

[Function 2 of Audio Key (AUDIO) 5aud; In case of Halt State (During Display of Blue-back Screen)]

<54> When the audio key is pressed during the halt state, the language name (when the type of audio stream is a language) of an audio stream set in the currently selected title is displayed on the blue-back screen for a predetermined period of time (e.g., 3 sec) using the character generator (after the audio stream information recorded on the disk is checked). When the audio key is pressed once again during this display, the next audio stream number is set. By repeating this audio key operation, the numbers of audio streams recorded in that title are cyclically set and displayed.

<55> When select key/cursor key 5q is pressed while the audio stream setup value is displayed on the blue-back screen, an audio stream next to or immediately preceding the currently set audio stream is selected.

<56> When a certain key on the ten-key pad is pressed while the audio stream setup value is displayed on the blue-back screen, the audio stream with the number input by the ten-key pad is selected.

<57> When the clear key is pressed while the audio stream setup value is displayed on the blue-back screen, the audio stream setup value display is cleared.

[Function 1 of Subtitle Key (SUBTITLE) 5sbt; During Playback]

<58> When the subtitle key is pressed during playback, the language name of a sub-picture stream which is currently being played back (when the type of sub-picture stream is a language) is displayed (OSD) on the playback screen for a predetermined period of time (e.g., 3 sec) using the character generator (after the sub-picture stream information recorded on the disk is checked). When the subtitle key is pressed once again during this display, sub-picture data of the next stream number is played back. By repeating this subtitle key operation, sub-picture streams recorded in that title are cyclically played back.

<59> When select key/cursor key 5q is pressed while the sub-picture stream setup value is displayed on the screen, a sub-picture stream next to or immediately preceding the currently set sub-picture stream can be selected. Then, the contents of the selected sub-picture stream are played back.

<60> When a certain key on the ten-key pad is pressed while the sub-picture stream setup value is displayed on the screen, a sub-picture stream with the number input by the ten-key pad can be selected. Then, the contents of the selected sub-picture stream are played back.

<61> When the clear key is pressed while the sub-picture stream setup value is displayed on the screen, the sub-picture stream setup value display can be cleared from the screen.

[Function 2 of Subtitle Key (SUBTITLE) 5sbt; In Halt State (During Display of Blue-back Screen)]

<62> When the subtitle key is pressed in the halt state, the language name of the sub-picture stream set in the currently selected title (when the type of sub-picture stream is a language) is displayed on the blue-back screen for a predetermined period of time (e.g., 3 sec) using the character generator (after the sub-picture stream information recorded on the disk is checked). When the subtitle key is pressed once again during this display, the next sub-picture stream number is set. By repeating this subtitle key operation, the numbers of sub-picture streams recorded in that title are cyclically set and displayed.

<63> When select key/cursor key 5q is pressed while the sub-picture stream setup value is displayed on the blue-back screen, a sub-picture stream next to or immediately preceding the currently set sub-picture stream is selected.

<64> When a certain key on the ten-key pad is pressed while the sub-picture stream setup value is displayed on the blue-back screen, a sub-picture stream with the number input by the ten-key pad is selected.

<65> When the clear key is pressed while the sub-picture stream setup value is displayed on the blue-back screen, the sub-picture stream setup value display can be cleared from the screen.

[Function of Subtitle ON/OFF Key (SUBTITLE ON/OFF) 5v]

<66> This key is used for turning on/off sub-picture (subtitle) display.

<67> When the subtitle ON/OFF key is pressed while video playback is in progress and sub-picture display is made (sub-picture display ON setup state), the sub-picture stream number setup value is turned off, and after the setup value is displayed for a predetermined period of time (e.g., 3 sec) by the character generator, sub-picture data is cleared from the screen.

<68> When the subtitle ON/OFF key is pressed while video playback is in progress but no sub-picture display is made (sub-picture display OFF setup state), the sub-picture stream number setup value is turned on, and after the setup value is displayed for a predetermined period of time (e.g., 3 sec) by the character generator, sub-picture data of the language corresponding to the ON stream number is played back (when sub-picture data is recorded on the disk which is being played back).

<69> When the subtitle ON/OFF key is pressed while video playback halts, the sub-picture display alone can be turned on/off.

<70> In the sub-picture display OFF setup state, if a sub-picture stream having the same language code as that of the playback audio stream includes a forced image output command, sub-picture data corresponding to this command must be played back and output onto the screen.

[Function of Angle Key (ANGLE) 5ang]

<71> When the title having the angle block formed by multiangle information is selected, and the angle key is pressed while this angle block (angle period) is being played back, the currently played-back angle number is displayed (OSD) for a predetermined period of time (e.g., 5 sec) by the character generator. When the angle key is pressed once again during this angle number display period, the same time point of a cell with the next angle number is obtained by a search, and playback starts from there.

For example, assume that a home-run scene of a certain hitter is being played back in angle number 1 (a camera angle that watches the back of a pitcher from the center field side) of the multiangle block, the bat of the hitter meets the pitch 5 sec after the playback start time of that angle block cell, and that ball is gone into the right outfield stand 3 more sec after that. When the user who wants to watch this home-run scene in another camera angle presses the angle key and then select angle number 2, the playback start time point of that angle block cell is located by a search, and the playback of the home-run scene in angle 2 (e.g., a camera angle that covers the overall field from the first-base infield stand side) restarts.

When the angle key is further pressed during the angle number display period, the recorded angle numbers are cyclically selected, and playback of the selected angle restarts.

<72> When the angle number is displayed on the screen by the character generator, a desired angle number can be directly selected by operating the ten-key pad (if an angle number which does not exist in the angle block, playback of which is in progress, is input using the ten-key pad, that key input is invalidated). Alternatively, the angle number can be increased/decreased in unitary increments/decrements using select key/cursor key 5q.

<73> When angle switching is done during playback of a still image in a cell of the multiangle blocks a similar playback time search is made and a still image in the obtained different angle is played back.

For example, assume that a still image of a given automobile is played back in angle number 1 (a camera angle that covers the front side of the automobile). When the user who wants to watch this automobile in another camera angle presses the angle key and selects angle number 2, the playback start time point of the angle block cell of angle number 2 is located by a search, and a still image in angle 2 (e.g., a camera angle that covers the automobile from, e.g., the right side surface) is played back.

When the angle key is further pressed during the angle number display period, the recorded angle numbers are cyclically switched, and a still image in the selected angle is played back.

<74> Angle setups (angle number switching) may be denied even when angle key operation is made while a cell other than those in the multiangle block is being played back. Angle setups (angle number switching) are accepted only when the title which is being played back includes multiangle block cells.

<75> When the selected title includes multiangle block cells, angle setups (angle number switching) may be accepted even in the halt state.

[Function of Fastforward (FWD) Key/Rewind (REW) Key (Leftward and Rightward Double-triangular marks) 5j]

<76> When the fastforward or rewind key is pressed while a movie or still image is being played back, fastforward or rewind playback is made at a speed higher than the normal playback speed (e.g., about twice the normal playback speed). (In case of a movie, its motion speed doubles; in case of a still picture, its frame-by-frame switching period halves.) When the fastforward or rewind key is kept pressed, fastforward or rewind playback is made at a speed still higher than the normal playback speed (e.g., about eight times the normal playback speed). (In case of a movie, its motion speed becomes an eight-fold speed; in case of a still picture, its frame-by-frame switching period is shortened to ⅛.)

Upon playing back and displaying main picture video data in case of fastforwarding/rewinding, I-picture+P-picture data in the MPEG format are played back at the double speed; I-picture data are played back at a speed higher than the double speed.

In such case, audio data may be played back as follows. More specifically, in case of double-speed playback, audio data are decoded by clocks of a rate twice those in normal playback to obtain double-speed audio data. Also, in case of playback higher than the double speed, audio data at the jump destination (from a certain I-picture to the next I-picture) is partially played back at a normal playback speed to decode audio data.

<77> When the playback key is pressed, the fastforward or rewind playback is canceled to restore normal-speed playback.

<78> The fastforward or rewind playback using the fastforward or rewind key is done in only a program chain which is being played back at the time of that key operation. After the program chain is fastforwarded to its end or is rewound to its beginning, the apparatus pauses temporarily.

<79> During the fastforward or rewind playback using the fastforward or rewind key, playback of audio (audio stream) and subtitle (sub-picture stream) can be automatically prohibited.

Note that audio data may be played back while changing its playback pitch in correspondence with the fastforward speed. For example, when a movie is a documentary film of a marathon race, and subtitle data is used for displaying the time elapsed from the start of the race, the subtitle data may be played back upon fastforward or rewind playback.

<80> When the cell playback mode is switched to a still mode during the fastforward or rewind playback using the fastforward or rewind key, the fastforward or rewind operation is canceled, and a still image is played back. When the fastforward key (or rewind key) is pressed while the cell playback mode is set in a still mode, continuous frame-by-frame fastforwarding (or rewinding) at a switching rate of approximately one frame per second can be started. At this time, when the fastforward key (or rewind key) is kept pressed, continuous frame-by-frame fastforwarding (or rewinding) at a rate of about 4 frames per second can be started. When the fastforward key is pressed once again, continuous frame-by-frame fastforwarding (or rewinding) at a rate of about one frame per second resumes. When the cell playback mode ends during this continuous frame-by-frame fastforwarding (or rewinding), fastforward (or rewind) playback at approximately double speed can be started.

If “the cell playback mode is switched to a still mode” in units of video object units (VOBU still), when the fastforward (or rewind) key is pressed, the next (or previous) VOBU is played back, and a still image is displayed upon completion of playback of that VOBU. In such case, if the fastforward (or rewind) key is pressed again during VOBU playback, that VOBU is fastforwarded (or rewound), and the VOBU still mode is then set to display a still image.

[Function of Display Key (DISPLAY) 5u]

<81> When this key is pressed in the halt or playback state, a display corresponding to various key operation contents at that time is made (on display plane 4B of the apparatus main body and/or on the screen of monitor display 6).

[Function of Ten-key Pad ([0] to [9] & [+10]) 5t]

<82> During normal playback, the ten-key pad can be used for designating the chapter number in the title which is currently being played back. Simultaneously with confirmation of the ten-key input (the confirmation key operation), a search for the chapter with the designated number starts (this search may be attained by title number key T (to be described later)). A non-existing chapter number is not accepted.

<83> The ten-key pad can be used for designating the chapter number in the selected title in the halt state. Simultaneously with confirmation of the ten-key input, a search for the chapter with the designated number starts (this search may be attained by title number key T). A non-existing chapter number is not accepted.

<84> While a title containing a multiangle block is being played back (an angle cell is being played back) and an angle number is being displayed, the angle number input by the ten-key pad is directly selected. However, a non-existing chapter number is not accepted.

<85> During display of a disk menu, when the items on the disk menu screen are given with numbers, an item corresponding to the number input by the ten-key pad is selected and executed. However, a non-existing item number input is not accepted.

<86> When parental lock is set from the setup menu, the ten-key pad can be used for inputting a password.

[Function of Clear Key (CLEAR) 5cr]

<87> This key is used for canceling the key input of the title or chapter number.

<88> The clear key is used for canceling the password input for changing the parental level.

<89> The clear key is used for canceling a repeat mode (to be described later).

<90> The clear key is used for canceling the input number upon operation on the memory setup screen (to be described later).

<91> The clear key is used for canceling a memory playback mode (to be described later).

<92> The clear key is used for canceling a random playback mode (to be described later).

<93> The clear key is used for canceling the number display of a title, audio (audio stream), subtitle (sub-picture stream), and angle.

[Function of Repeat Key (REPEAT) 5k]

<94> The repeat key is used for setting a repeat mode of a chapter or title (only for the title of a one-sequential program chain).

<95> Every time this key is pressed, the repeat mode is cyclically switched like “chapter repeat”→“title repeat”→“repeat OFF”→“chapter repeat”.

<96> When the repeat key is pressed during A-B repeat operation (to be described later), the A-B repeat operation is canceled to start the chapter repeat mode.

<97> When the playback position falls outside the repeat period upon operation of the fastforward key, rewind key, or skip key, the repeat operation is canceled.

<98> When the repeat period includes a multiangle block, angle change is permitted (the angle key is accepted even in the repeat mode).

[Function of A-B Repeat Key (A-B REPEAT) 5k]

<99> This key is used for setting the start and end points for the repeat operation between two points (only for the title of a one-sequential program chain).

<100> When this key is pressed once, the start point (A) is set, and when this key is pressed once more, the end point (B) is set. Simultaneously with completion of setting of the end point, a search for the set start point is made to repetitively play back the portion between A and B.

<101> The A-B repeat mode can be cleared by operating the clear key.

<102> When the playback position is changed to that in a title or chapter other than the period between the points A and B during the A-B repeat operation, or when the repeat key is pressed, the A-B repeat mode can be canceled.

<103> When the playback position falls outside the A-B repeat period upon operation of the fastforward key, rewind key, or skip key, the A-B repeat mode is canceled.

<104> By pressing the clear key, fastforward key, rewind key, or skip key before the repeat end point (B) is set, the A-B repeat operation can be canceled.

<105> When the title ends before the end point (B) is reached during the A-B repeat playback, the A-B repeat operation is canceled.

<106> The setup of the start point (A) for the A-B repeat mode can be invalidated during the multiangle block period. (The beginning of the multiangle block period can be set at the start point of the A-B repeat mode. For example, the camera angle scene of angle number 1 in a certain multiangle block may be set as an A-B repeat period in that angle block.)

<107> When a multiangle block is reached during A-B repeat playback, the A-B repeat operation can be canceled.

<108> The start point (A) and end point (B) set by the A-B repeat key indicate the beginning (start address) of the corresponding image data (GOP) immediately after setups.

[Function of Memory Key (MEMORY) 5m]

<109> When this key is pressed while the tray is closed and a disk is set, the memory setup screen is displayed (OSD). When this key is pressed while the memory setup screen is displayed, the state before the memory setup screen is displayed is restored.

<110> In the memory setup method, the title and chapter numbers to be played back in the memory mode are sequentially input using the ten-key pad and title number (T) key (to be described later) during display of the memory setup screen.

<111> When the memory setup input is made at a memory number at the cursor position by moving the cursor on the display screen using the select key/cursor key, the title and chapter numbers set at the memory numbers after that memory number shift one by one to the subsequent memory numbers.

For example, assume that “title 1•chapter 3” and “title 2•chapter 1” have already been set at memory numbers 1 and 2, and memory number 3 and the subsequent numbers have no entries. If “title 2•chapter 5” is set by setting the cursor at memory number 1, the contents set so far at memory numbers 1 and 2 shift to memory numbers 2 and 3, respectively. As a consequence, the setup contents of memory numbers 1, 2, and 3 respectively become “title 2•chapter 5”, “title 1•chapter 3”, and “title 2•chapter 1”.

<112> When the clear key is operated at a memory number at the cursor position by moving the cursor on the display screen using the select key/cursor key, the contents set at that memory number are cleared, and the contents set at the subsequent memory numbers shift to the previous memory numbers.

For example, assume that “title 2•chapter 5”, “title 1•chapter 3”, and “title 2•chapter 1” are respectively set at memory numbers 1, 2, and 3, and memory number 4 and the subsequent numbers have no entries. If the clear key is operated by setting the cursor at memory number 2, the contents “title 1•chapter 3” set so far at memory number 2 are cleared, the contents set so far at memory number 3 shift to memory number 2, and the contents (no entry) set at memory number 4 shift to memory number 3. Consequently, the setup contents at memory numbers 1, 2, and 3 respectively become “title 2•chapter 5”, “title 2•chapter 1”, and “no entry”.

Note that the number of memory setups (the upper limit memory number) need not always be determined. However, the maximum number of memory setups is selected to be, e.g., about 30, owing to the necessity in practical software, and the physical memory capacity of the apparatus. (Even when 99 titles are recorded on a single disk, the normal user does not always require a maximum of 99 memory setups. On the other hand, in apparatuses for business use, memory setup requests may often be issued for a plurality of chapters in each of 99 titles, and in such case, the maximum number of memory setups may be set to be 99 or more.)

<113> When the playback key is pressed while the memory setup screen is displayed, memory playback starts in the memory setup registration order.

For example, assume that “title 2•chapter 5”, “title 1•chapter 3”, and “title 2•chapter 1” are respectively set at memory numbers 1, 2, and 3, and memory number 4 and the subsequent numbers have no entries. In such state, if the playback key is pressed while the memory setup screen is displayed, memory playback is executed as follows. More specifically, “title 2•chapter 5” is played back first, “title 1•chapter 3” is played back next, and “title 2•chapter 1” is played back lastly. Upon completion of playback of “title 2•chapter 1”, playback stops.

<114> When the clear key is pressed during memory playback, the memory playback mode is canceled and normal playback can be started.

<115> The contents set on the memory setup screen can be cleared by the following methods.

(a) While the memory setup screen is displayed, all the set title and chapter numbers are cleared by the clear key.

(b) The tray is opened to eject the disk outside the apparatus. (However, an apparatus for business use may have an internal nonvolatile memory, which saves the memory setup contents together with a code that specifies a disk after the disk is ejected.)

[Function of Random Key (RANDOM) 5rm]

<116> When the selected title is a one-sequential program chain, chapters in that title are randomly played back.

<117> When this key is pressed during playback, random playback starts from a chapter next to the chapter which is currently being played back. (When the random key is pressed during playback of chapter 2 of a title that includes chapters 1 to 9, random playback starts when the playback position enters chapter 3, and chapters are randomly played back like chapters 5, 3, 7, 1, 9, . . . .

<118> When the random key is pressed in the halt state, random playback starts upon next depression of the playback key to start disk playback.

<119> Upon completion of random playback of all the chapters in the selected title, the playback stops. During this random playback, normally, identical chapter numbers are inhibited from being repetitively played back, and the playback order alone is randomly determined. However, random playback including repetitive playback may be permitted, and random playback may repeat itself in an infinite loop unless the power supply is turned off or the stop key is pressed.

<120> When the clear key is pressed during random playback, the memory playback mode is canceled and normal playback can be started.

<121> When the random key is pressed during random playback, the random playback mode is canceled.

[Function of Slow Key (SLOW) 5sw]

<122> When the slow key is pressed during playback, forward slow playback starts at a ½ speed. At the same time, “½” or a corresponding numeral, symbol, or the like is displayed on the video picture which is being played back using a character generator.

<123> When the slow key is kept pressed, the forward slow playback speed is changed to ⅛ speed. When the slow key is further kept pressed, the slow playback speed is cyclically switched like 1/16→⅛→½→⅛→1/16 . . . , and the slow display on the video picture which is being played back changes accordingly.

<124> When the slow key is pressed during a playback pause (by the pause key), for example, 1/16 slow-speed playback starts. The subsequent depressions of the slow key effect in the same manner as described above.

<125> When the playback key is pressed during slow playback, normal playback restarts.

<126> When the title has changed during slow playback, the slow playback mode is canceled to restore normal playback.

<127> While a still image is played back in the cell playback mode, the slow key operation is not accepted.

<128> Normally, audio data is not played back during slow playback. However, audio data may be played back by changing its pitch in correspondence with the playback speed.

[Function of Last Play Key (LAST PLAY) 5tp]

<129> When this last play key is pressed after playback is interrupted by the stop key or turning off the power key (including a power failure) during disk playback, playback starts from the interrupted position or a position slightly before the interrupted position.

<130> When the disk tray is opened after playback is stopped, the last play key can be invalidated by clearing the memorized playback interrupted position. If the playback interrupted position is saved in the memory in the apparatus without being cleared, playback can be restarted from the interrupted position or a position slightly before the interrupted position by pressing the last play key even after the disk is removed from the tray.

<131> When a first-play program chain (auto-start code) is included in that disk, this last play key is invalidated when playback is interrupted by turning off the power key. (That is, playback starts from the first-play program chain.)

<132> When playback is interrupted while a random program chain is being played back, playback can be restarted from the interrupted position or a position slightly before the interrupted position by pressing the last play key if the number of random playback loops is stored in the apparatus.

[Function of Setup Key (SETUP) 5y]

<133> This key is used for calling the setup menu for attaining various setups (e.g., to set the screen size/aspect ratio, angle mark, parental lock, desired spoken language type, desired superimposed dialogue language type, desired menu language type, auto-angle mode, and the like), and is effective only in the playback halt state.

<134> When this setup key is pressed while the setup menu is displayed, the setup menu display is cleared, and the playback halt state (blue-back screen) is set.

[Function of Title Number Key (T) 5tt]

<135> Upon designating the title number and chapter number to start a search or memory playback, a numerical value input by the ten-key pad before depression of this key is set as a title number, and a numerical value input by the ten-key pad after depression of this key is set as a chapter number.

<136> When this title number key is pressed before depression of the random key, not chapters but titles are randomly played back. For example, if the disk set on the tray records titles 1, 2, 3, 4, and 5, and the random key is pressed after depression of the title number key (also requires depression of the playback key in the halt state), random playback starts in units of titles in the order of, e.g., titles 2, 5, 1, 4, and 3.

[Function of Remote Controller Switch Key 5x]

<137> This key is used for switching remote controller 5 shown in FIG. 48 to that for operating equipment (e.g., AV television, VCR, or the like) other than the DVD video player or DVD video player. Alternatively, when a single DVD video player and a single DVD video recorder are set at the same time, and single remote controller 5 is used for independently operating them, remote controller switch key 5x can be used for switching their operations.

[Function of Recording Mode Key 5rmd]

<138> Every time this key is pressed in the recording halt or pause state, the recording mode is cyclically switched like MPEG2/8 Mbps→MPEG2/6 Mbps→MPEG2/4 Mbps→MPEG2/2 Mbps→MPEG1/2 Mbps→MPEG1/1 Mbps→automatic image quality mode→MPEG2/8 Mbps→, . . . .

If the user requires quality as high as an NTSC broadcast studio, he or she selects MPEG2/8 Mbps although the recording time becomes short. When the user wants to obtain image quality equal to or higher than the S-VHS video standard mode by slightly prolonging the recording time, he or she selects MPEG2/6 Mbps or MPEG2/4 Mbps. When the user need only obtain image quality equal as high as the S-VHS video 3× mode (or video CD) but requires a longer recording time, he or she can select MPEG1/2 Mbps or MPEG1/1 Mbps.

[Function of Recording Key 5rec]

<139> When this switch is pressed when DVD-RW (or DVD-R) disk 10 set in a DVD video recorder main body (not shown) has free capacity and initial setups for recording (selection of MPEG2/MPEG1, setups of recording average bit rate, and the like) have already been done, recording starts.

When the user presses this recording key without such initial setups, default setup values are automatically selected as the initial setup values, and recording starts.

[Function of Display Mode Key 5dm]

<140> Every time this key is pressed while recordable DVD-RW (or DVD-R) disk 10 is set in the DVD video recorder main body, OSD display (or the display panel of the apparatus main body) is switched to have the following contents:

(1) Recording source (TV channel number or AV input number)+current date;

(2) Current title set number, recorded time, recordable time+average recording rate at that time;

(3) Display OFF

Note that contents (1) and (2) may be simultaneously displayed.

<141> When angle key 5ang described above and display mode key 5dm are pressed at the same time during playback of the angle block, the multiangle multi-screen digest display mode starts, as shown in FIG. 42.

An n-screen multi-screen digest display mode, i.e., the number of divided screen areas, can be determined by one of the following methods:

(a) When the user simultaneously presses angle key 5ang and display mode key 5dm during playback of an angle block, the screen is divided into four areas as a default mode. If the default mode is set to be a 9-screen mode, a 9-screen digest display mode starts by a combination of keys 5ang and 5dm. The default number of divided screen areas can be desirably set by the user (although not shown). When the 4-screen mode is selected although the number of angles that can be played back in the current angle block is 7, the angle number is changed in turn like “1”→“2”→“3”→“41” by operating cursor key 5q, and the cursor key is also pressed in ascending order of angle number. Then, the contents on the 4-divided screen areas correspond to those for the remaining three angles (the last one of 4-divided screen areas is blank). When the angle number is changed in turn like “5”→“6”→“71” by operating cursor key 5q, and the cursor key is also operated in ascending order of angle number, the contents on the 4-vided screen areas return to those for the first four angles;

(b) When the user simultaneously presses angle key 5ang and display mode key 5dm during playback of an angle block, which one of non-seamless angle information NSML_AGLI (FIG. 13) and seamless angle information SML_AGLI (FIG. 19) is actually recorded is looked up, and the number of angles in that angle block is detected. Subsequently, selectable angle permitted/prohibited flags in FIG. 32 are looked up to specify angles which are not prohibited from being played back. For example, if that angle block includes seven angle cells (in this case, seamless angle information SML_AGLI in FIG. 19 contains seven pieces of address information SML_AGL_C#1_DSTA to SML_AGL_C#7_DSTA), and the number of angles which are permitted to be played back is four, the screen is divided into four areas. On the other hand, if the angle block includes seven angle cells, and the number of angles which are permitted to be played back is five, the screen is divided into nine areas. In this case, four out of the 9-divided screen areas are blank areas.

[Function of OSD Key 5osd]

<142> When this key is pressed while CPU 50 shown in FIGS. 45 to 47 (or multi-screen display controller 508 in FIG. 51) outputs character (or image) data for OSD display, OSD display contents that the user does not desire are cleared from the monitor screen. When this key is pressed once again, OSD data output from CPU 50 is displayed on the monitor screen.

[Function of Timer Key 5tme]

<143> When this key is pressed for a DVD video recorder (not shown), a timer reservation menu (including a table for designating a desired recording channel, recording reservation date, recording mode, average recording rate, and the like in units of reserved programs) is output (OSD) onto the screen of monitor display 6. On this menu, a program can be reserved by using cursor key 5q, ten-key pad 5t, enter key 5s, and the like.

<144> After timer reservation, when this timer key 5tme and recording key 5rec are simultaneously pressed while recordable DVD-RW (or DVD-R) disk 10 is set in a DVD video recorder main body (not shown), this DVD video recorder enters a reservation recording mode (timer recording standby state).

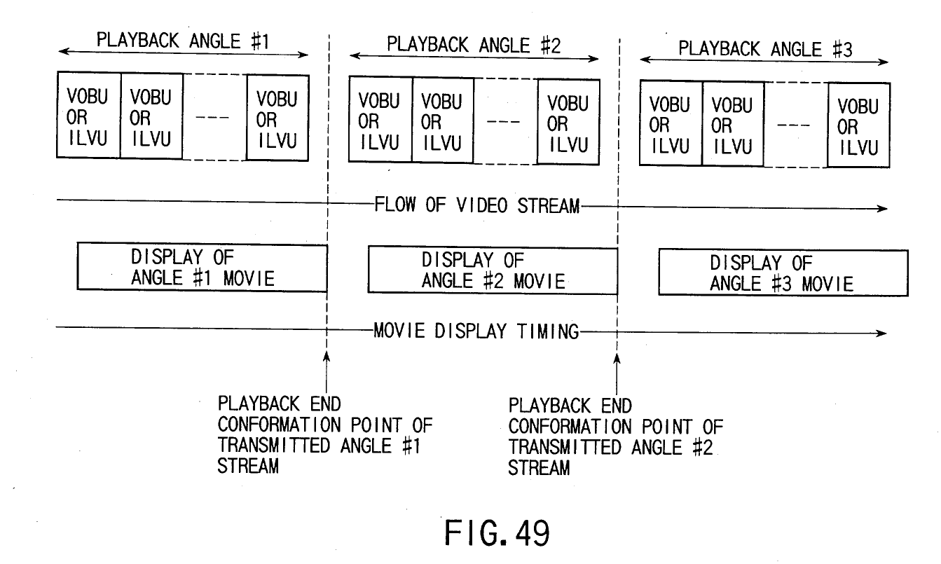

FIG. 49 is a view for explaining the flow of multiangle videostreams and their display timings.

As has already been described earlier with reference to FIG. 15, each angle cell (AGL_C#) of an angle block used in non-seamless angle change is formed by video object units (VOBUs) as minimum units. As has already been described earlier with the aid of FIG. 21, each angle cell (AGL_C#) of an angle block used in seamless angle change is formed by interleaved units (ILVUs) as minimum units. Hence, if playback angles #1 to #3 in FIG. 49 are those for an angle block used in non-seamless angle change, each angle is formed by VOBUs; if these angles are those for an angle block used in seamless angle change, each angle is formed by ILVUs.

Movies of playback angles #1 to #3 are played back in correspondence with the flows of their videostreams, as shown in FIG. 49. More specifically, movie display of angle #1 (or decode output of angle #1) is made during playback of the stream of playback angle #1, and ends after the end of the stream of playback angle #1 and before the stream of the next playback angle #2 starts. The movie display end point of angle #1 can be used as the playback end confirmation point of the transmitted angle #1 stream (e.g., from video decoder 58 to video processor 640 in FIG. 45).

Likewise, the movie display end point of angle #2 can be used as the playback end confirmation point of the transmitted angle #2 stream, and the movie display end point of angle #3 can be used as the playback end confirmation point of the transmitted angle #3 stream.

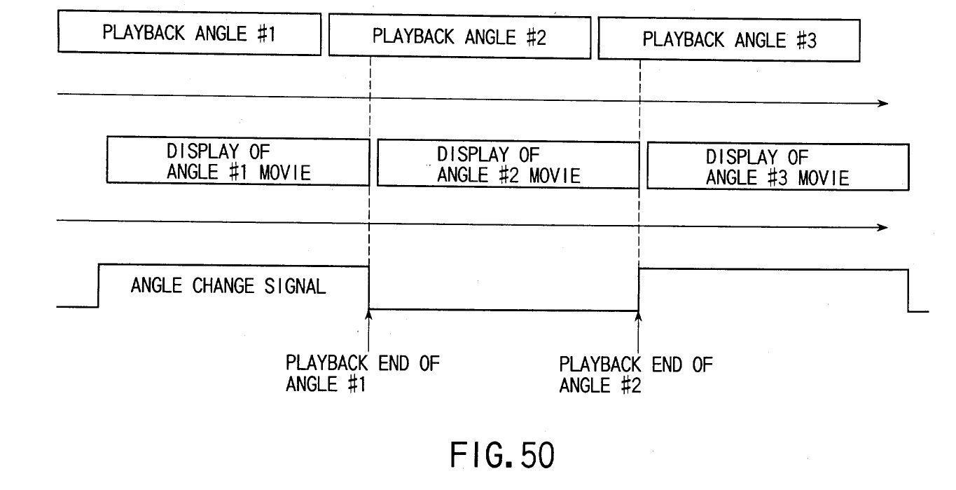

FIG. 50 is a view for explaining the flows of multiangle videostreams and their seamless movie display timings.

The videostreams of the angle block are continuously transmitted to the decoders (58 to 62 in FIG. 45). FIG. 50 depicts how, upon completion of display of a single angle number based on data transmitted to the decoders (especially, video decoder 58), movies played back on the screen are seamlessly coupled (the display position changes in correspondence with the angle number).

In order to seamlessly display movies in the angle block, the change timings in units of angles of signals output from the individual decoders (58 to 62 in FIG. 45) must be detected. Especially, “information indicating that the angle number has been changed” of a video signal output from the internal MPEG2 decoder of video decoder 58 to video processor 640 that performs multi-screen digest display processing must be detected.

As the “information indicating that the angle number has been changed”, in the example shown in FIG. 50, a signal, the level of which is inverted at the movie display end point of each angle (corresponding to the playback end confirmation point of each angle stream shown in FIG. 49) is used. This angle number change information signal (the lowermost signal in FIG. 50) has logical level “1” during, e.g., movie display of angle #1, changes to logical level “0” during movie display of the next angle #2, and then returns to logical level “1” during movie display of the last angle #3. In other words, this angle number change information signal is toggle-switched between “0” and “1” every time the angle has been changed.

Note that “the signal which is toggle-switched between “0” and “1” every time the angle has been changed” is merely an example, and other signal formats may be used. For example, pulses at a duty ratio of 25% may be generated during playback of angle #1, pulses at a duty ratio of 50% during playback of the next angle #2, and pulses at a duty ratio of 75% during playback of the last angle #3. Also, a signal, the frequency or phase of which changes every time the angle changes may be used as the “information indicating that the angle number has been changed”.

Alternatively, a 4-bit register may be prepared, and a binary code indicating the angle number which is currently being played back may be written in the register. In this case, the contents of the 4-bit register change in correspondence with the playback angle number every time the angle is changed. For example, the contents of this register are “0001” during playback of angle #1, the contents of the register are “0010” during playback of angle #2, and the contents of the register change to “0011” when the angle is changed to #3. This 4-bit register may be temporarily allocated on memory 52 by software processing of system CPU 50 in FIG. 45.

In addition, the “information indicating that the angle number has been changed” may have any other formats as long as it can be informed.

FIG. 51 is a block diagram for explaining the circuit arrangement that implements seamless multiangle/scene multi-screen display.

MPEG2 decoder 580 incorporated in video decoder 58 shown in FIGS. 45 to 47 transmits a video signal (MPEG-decoded digital video signal) including angle switch information (angle change signal and the like in FIG. 50) and an angle block stream to video processor 640. MPEG2 decoder 580 also transmits angle number information of the angles to be played back to multi-screen display controller 508A together with the angle switch information. In this case, the angle switch information is transmitted in synchronism with the video signal. Also, the angle number information of the angles to be played back corresponds to angle numbers #1 to #4 (the maximum angle number is #9 in case of DVD video) for 4-screen simultaneous display angles in the example shown in FIG. 42.

Multi-screen display controller 508A determines the angle numbers, display positions, display sizes, and the like of angle pictures to be displayed in the multi-screen digest display mode on the basis of the information transmitted from MPEG2 decoder 580. The determined display position information and display size information are supplied to video processor 640 as portions of a screen dividing instruction. The determined angle numbers and the like are sent to ON-screen display (OSD) processor 649 as OSD generating information.

Video processor 640 uses frame memory 642 as a work area, and divides a video RAM area mapped in frame memory 642 into four or nine areas on the basis of the screen dividing instruction supplied from multi-screen display controller 508A. Also, video processor 640 determines the positions and sizes of pictures to be displayed in 4- or 9-divided areas on the monitor screen.

For example, if MPEG2 decoder 580 has informed multi-screen display controller 508A that “the current angle block includes two to four angle cells”, multi-screen display controller 508A outputs a 4-dividing instruction to video processor 640. In such case, if the monitor screen is a bitmap or equivalent having a size of 640 dots×480 dots, a ¼ shrunk screen having a size of 320 dots×240 dots is assigned to each of 4-divided display screen areas.

On the other hand, if MPEG2 decoder 580 has informed multi-screen display controller 508A that “the current angle block includes five to nine angle cells”, multi-screen display controller 508A outputs a 9-dividing instruction to video processor 640. In such case, a 1/9 shrunk screen having a size of 213 dots×160 dots is assigned to each of 9-divided display screen areas.

Furthermore, if MPEG2 decoder 580 has informed multi-screen display controller 508A that “the current angle block includes only one angle cell” or if “a block other than an angle block is currently being played back”, multi-screen display controller 508A does not output any dividing instruction to video processor 640. In such case, video processor 640 does not divide the video RAM area of frame memory 642, and maps video data for the full display screen size (640 dots×480 dots in the above-mentioned example) of monitor display 6 onto this RAM area.

Moreover, if MPEG2 decoder 580 has informed multi-screen display controller 508A of “the numbers of angles that can be played back in the current angle. block”, multi-screen display controller 508A sends the informed angle number data to OSD processor 649. This OSD processor 649 serves as a pattern generator for converting the received data into corresponding bitmap picture data (character or design dot pattern).

The character (angle number or the like) or design (icon or the like formed to represent a camera angle) patter data (monochrome or color) generated by OSD processor 649 are sent to video processor 640. Video processor 640 superimposes the corresponding angle numbers, icons, and the like on angle pictures displayed on the divided screen areas on the basis of the dividing instruction from multi-screen display controller 508A (such processing is implemented by digital processing).

The multi-screen video signal (digital) on which characters or icons corresponding to the angle number information are superimposed is sent to video encoder 641 shown in FIGS. 45 to 47. Video encoder 641 converts the received multi-screen video signal (digital) into an analog video signal in a predetermined format (e.g., NTSC), and outputs it to external analog monitor display 6.

With this processing, a plurality of angle pictures (one of them is a movie) that can be played back are simultaneously displayed on the monitor screen that the user actually watches, and angle numbers and the like corresponding to these angle pictures are OSD-displayed.

In the example shown in FIG. 32, “the numbers of angles that can be played back in the current angle block” are four numbers, i.e., #1, #2, #4, and #7. In such case, angle numbers #1, #2, #4, and #7 are OSD-displayed on the corresponding angle picture screen areas on the 4-divided monitor screen. (If the numbers of angles that can be played back are #1 to #4, a display shown in FIG. 42 is made.)

If system CPU 50 (FIGS. 45 to 47) has a sufficient margin in its processing performance, multi-screen display controller 508A can be implemented by multi-screen display controller 508 for angles (formed by software) in system CPU 50. On the other hand, if system CPU 50 does not have any margin in its processing performance, multi-screen display controller 508A can be built using a dedicated control MPU or logic circuit. The arrangement of multi-screen display controller 508A need only be determined in units of actual products.

In the example shown in FIG. 51, MPEG2 decoder 580 is used as a means for providing angle switch information. However, this “angle switch information” or information having corresponding contents may be obtained from information generating means other than MPEG2 decoder. For example, if individual audio data are assigned in units of angles, i.e., if audio data is switched in correspondence with angle switching, audio decoder 60 in FIG. 45 may be used as means for generating information having contents corresponding to “angle switch information”.

The angle switch information in FIG. 51 is transmitted from MPEG2 decoder 580 to video processor 640 in synchronism with the video signal via independent paths. Alternatively, the angle switch information may be superposed on the blanking period of the video signal, and may be transmitted together with the video signal using a single signal transmission path. The angle switch information superposed on the blanking period is removed when it is output from video processor 640, and is replaced by a signal indicating the blanking period. With this method, the number of signal lines between MPEG2 decoder 580 and video processor 640 can be reduced.

In the above-mentioned multi-screen display, sub-picture and audio data can be turned on/off at arbitrary timings. Such ON/OFF control may be done by user operation or may be automatically done by the playback apparatus in synchronism with the display in units of ILVUs.

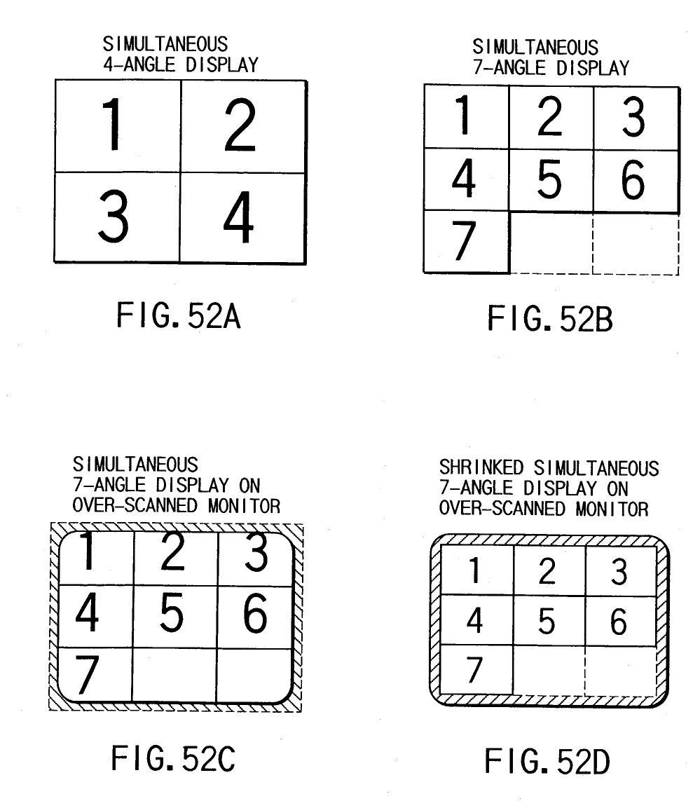

FIGS. 52A to 52D are views for explaining n-divided (4- or 9-divided) shrunk display examples of multiangle simultaneous display (digest display). FIG. 52A shows a case wherein the screen is equally divided into four areas, and four angle pictures are simultaneously displayed. FIGS. 52B to 52D show a case wherein the screen is equally divided into nine areas, and seven angle pictures are simultaneously displayed.

In the DVD, a plurality of aspect ratios (e.g., horizontal:vertical=4:3 and 16:9) for the display screen are available. As an example of making multi-screen display without changing the aspect ratio, a method of dividing the screen into n areas in both the horizontal and vertical directions may be used. When n=2, a maximum of four angles can be simultaneously displayed; when n=3, a maximum of nine angles.

If all of seven angles exemplified in FIGS. 52B to 52D are to be displayed, seven out of 9-divided areas are used. On the other hand, if all of seven angles need not be simultaneously displayed, the screen may be divided into four areas, as shown in FIG. 52A, and arbitrary four out of seven angles may be selectively displayed. In such case, since each angle display screen size is larger than that of each 9-divided area, the display contents are easy to see.

When a CRT of a home TV is used as monitor display 6, the monitor is often over-scanned. On such monitor, if the upper and lower edge portions of the screen are output, flickering such as noise that does not pertain to the picture itself is often produced in these portions. Also, if all the rasters on the screen are displayed, an image on the monitor often is distorted. (In a CRT of a home TV, it is hard to accurately adjust each raster to a rectangle in terms of manufacturing cost, and a raster which should have a rectangular shape often has a barrel, bobbin, or trapezoidal shape.) By over-scanning the CRT monitor screen of the TV, the peripheral portions of rasters where image distortion and flickering are conspicuous can be put out of the physical screen of the monitor screen. Hence, a normal user notices neither image distortion nor noise on the raster edge portions.

The over-scanned monitor has the above-mentioned merits. However, when the screen (rasters) is divided into small areas (especially, in case of 9-divided areas), since each screen size is relatively small, screen eclipse of the peripheral portions of rasters poses a problem. For example, when the 9-divided screen areas that digest-display seven angles (FIG. 52B) are displayed on the over-scanned monitor shown in FIG. 52C, the hatched portions around angles #1 to #4, #6, and #7 are not displayed.

However, as exemplified in FIG. 52D, when the size of the entire n-divided (n=2 to 9; in this case, 9) screen areas is slightly shrunk, screen eclipse of the peripheral portions of rasters can be prevented even when the monitor TV itself is over-scanned.

More specifically, if a normal home TV monitor is over-scanned to 110%, the size of the entire 9-divided digest screen areas is shrunk to 80% to 90% that of the non-divided screen. With this control, defects such as raster distortions and the like are removed by over-scanning the monitor of the home TV, and all the 9-divided digest screen areas can be displayed without any eclipse.

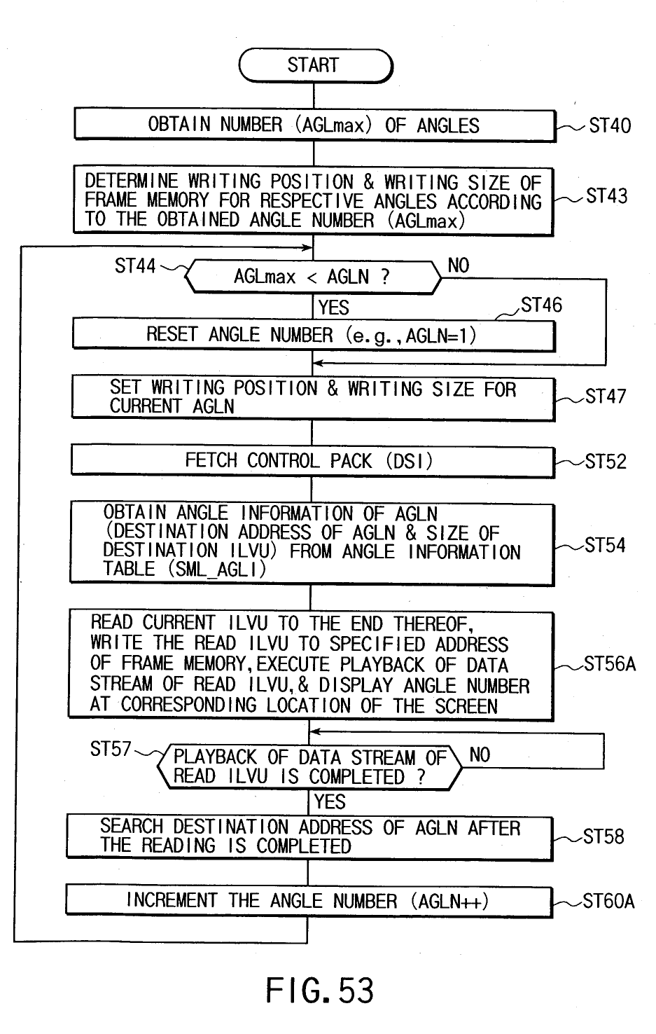

FIG. 53 is a flow chart for explaining an example of the processing sequence of n-divided shrunk display shown in FIG. 42 or 52. In this flow chart, a description is limited to seamless angle change shown in FIG. 21. However, the same processing sequence can also be applied to non-seamless angle change shown in FIG. 15.

When the user has pressed playback key 5c on remote controller 5, playback of DVD disk 10 starts. When the playback position enters the angle block shown in FIG. 21, CPU 50 of the playback apparatus obtains the number of angles (four in the example shown in FIG. 42) in that angle block (step ST40).

The writing positions and sizes of the respective angles onto frame memory 642 of the playback apparatus (FIGS. 45 to 47) are determined on the basis of the obtained number AGLmax (=4) of angles (step ST43).

A case will be examined below wherein a bitmap image for one frame to be mapped on frame memory 642 has a resolution of 640×480 dots, and each dot is expressed by 8 bits. In such case, when pictures are displayed on equally divided screen areas corresponding to the obtained number of angles, one frame is divided into four small screen areas each having 320×240 dots. The first small screen area (positions of horizontal 1st to 320th dots; positions of vertical 1st to 240th dots) is assigned to angle #1; the second small screen area (positions of horizontal 321st to 640th dots; positions of vertical 1st to 240th dots) to angle #2; the third small screen area (positions of horizontal 1st to 320th dots; positions of vertical 241st to 480th dots) to angle #3; and the fourth small area (positions of horizontal 321st to 640th dots; positions of vertical 241st to 480th dots) to angle #4.

Alternatively, when one angle to be displayed as a movie is displayed on the full screen, and other angles are displayed as still images (or movies) on small windows, assignment for one frame may be done as follows.

More specifically, the full screen (640×480 dots) is assigned to movie display angle AGLN=x as a main image; the first window frame (positions of horizontal 40th to 160th dots; positions of vertical 50th to 140th dots) to first still (or movie) display angle AGLN=y1 as a sub image; the second window frame (positions of horizontal 40th to 160th dots; positions of vertical 190th to 280th dots) to second still (or movie) display angle AGLN=y2 as a sub image; and the third window frame (positions of horizontal 40th to 160th dots; positions of vertical 330th to 420th dots) to third still (or movie) display angle AGLN=y3 as a sub image.

In this case, the 120×90 (dots) first window frame (AGLy1) is popup-displayed on the upper left position of the full screen frame (AGLx), the 120×90 (dots) second window frame (AGLy2) is popup-displayed at the left central position of the full screen frame, and the 120×90 (dots) third window frame (AGLy3) is popup-displayed on the lower left position of the full screen frame.

Upon displaying the full screen and three popup windows, a movie of current angle number AGLN (in the example of the upper image in FIG. 42, AGLx=#1) selected as the angle to be played back is displayed on the full screen, the still image (or movie) of the first non-selected angle number (AGLy1=#2 in the example of the upper image in FIG. 42) is displayed on the first window frame, the still image (or movie) of the second non-selected angle number (AGLy2=#3 in the example of the upper image in FIG. 42) is displayed on the second window frame, and the still image (or movie) of the third non-selected angle number (AGLy3=#4 in the example of the upper image in FIG. 42) is displayed on the third window frame.

After the writing positions and sizes of the respective angles on the frame memory are determined in this way, it is checked if angle number AGLN set as “the angle number to be played back” at that time has exceeded the obtained number of angles (AGLmax=4). If AGLN>AGLmax=4 (YES in step ST44), angle number AGLN is reset to a predetermined value equal to or smaller than AGLmax, e.g., “1” (step ST46). If AGLN at that time is equal to or smaller than AGLmax=4 (NO in step ST44), the flow skips the reset processing in step ST46.

After angle number AGLN to be played back is limited not to exceed the obtained number of angles (AGLmax=4), the writing position and size of angle number AGLN to be played back in frame memory 642 are designated (step ST47).

Subsequently, DSI data 115 is fetched from navigation pack 86 (FIG. 16) at the beginning of the first VOBU of the ILVU with the angle number to be played back (step ST52).

This DSI data contains seamless angle information SML_AGLI, as shown in FIG. 19. If the angle number to be played back is #1, the CPU of the playback apparatus looks up SML_AGL_C1_DSTA in this seamless angle information SML_AGLI, and obtains the destination address to angle #1 (AGLN=1) and the ILVU size of that angle number therefrom (step ST54).

CPU 50 of the playback apparatus controls reads of disk drive 30 on the basis of the obtained destination address to angle number #1 and the ILVU size of that angle number so as to read that ILVU to its end and write it in frame memory 642, thus playing back that angle (step ST56A). In this case, the number (#1) of the angle which is being played back is OSD-displayed at a predetermined position on the corresponding divided screen area (in the example in FIG. 42, a corner near the center of the 4-divided screen areas).

After that, 4-divided digest display (starting from the picture of angle #1) shown in FIG. 42 continues (a loop formed if NO is determined in step ST57) until playback of the transmitted stream (videostream of angle number #1) is completed.

Upon completion of playback and display of the stream of angle #1 read by video decoder 58, its end information (the playback end confirmation point in FIG. 49 or the level change point of the angle change signal shown in FIG. 50) is received from the decoder (one of 58 to 62), and the flow then advances to the next step (YES in step ST57).

In the next step, the destination address of angle #2 to be played back (AGLN=2) is searched (step ST58), and the angle number is incremented (from #1 to #2) (step ST60A).

The writing position and size of the new angle number (#2) are designated (step ST47), and DSI data 115 is fetched from navigation pack 86 at the beginning of the first VOBU in the ILVU of that angle (step ST52). After that, similar operations (ST54 to ST60A) are executed.

Steps ST44 (NO) to ST60A are cyclically repeated until the angle number is incremented from #1 to #4 in step ST60A. As a result, multi-screen digest display shown in FIG. 42 can be implemented.

In the example shown in FIG. 53, the address of the next angle is searched in step ST58. However, when display is switched in units of ILVUs, data in units of ILVUs need only be transmitted without making an address search. In such case, the continuous movie playback time (period) of a single angle may be arbitrarily determined if that angle is played back in units of ILVUs. This period can be managed by playback period determiner 502 (FIG. 45).

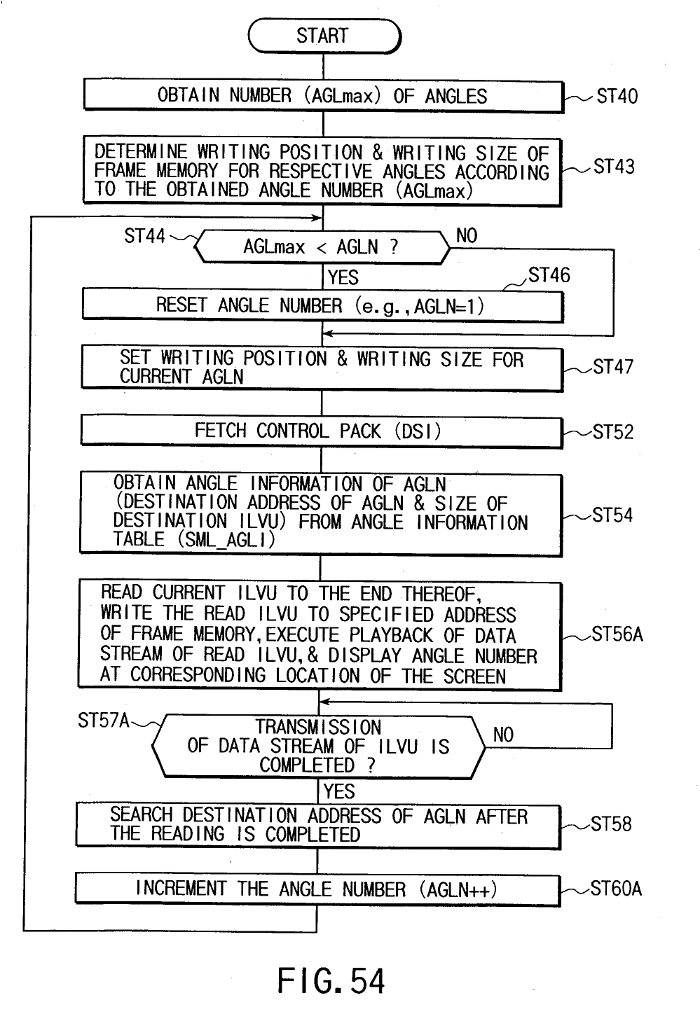

FIG. 54 is a flow chart for explaining an example of the processing sequence for seamlessly attaining n-divided shrunk movie display. Since this flow chart includes many common steps to those in FIG. 53, only differences from FIG. 53 will be explained below. The major difference resides in that the angle number is incremented after the stream that contains more than one ILVUs is played back to its end (steps ST57 to ST60A) in FIG. 53, while the angle number is incremented upon completion of transmission of each ILVU stream (steps ST57A to ST60A) in FIG. 54.

More specifically, after the current ILVU stream is transmitted to decoder 58 to its end (step ST56A), the flow advances to the next step.

After the current ILVU is read out (step ST57A), the destination address of an angle indicated by the angle number (e.g., AGLN=#2) is searched (ST58). The angle number is then incremented (step ST60A), and the flow returns to step ST44 to continue playback.

In the example in FIG. 54, the address of the next angle is searched in step ST58. If the displayed pictures are to be switched in units of ILVUs, data in units of ILVUs need only be continuously transmitted without searching the address.

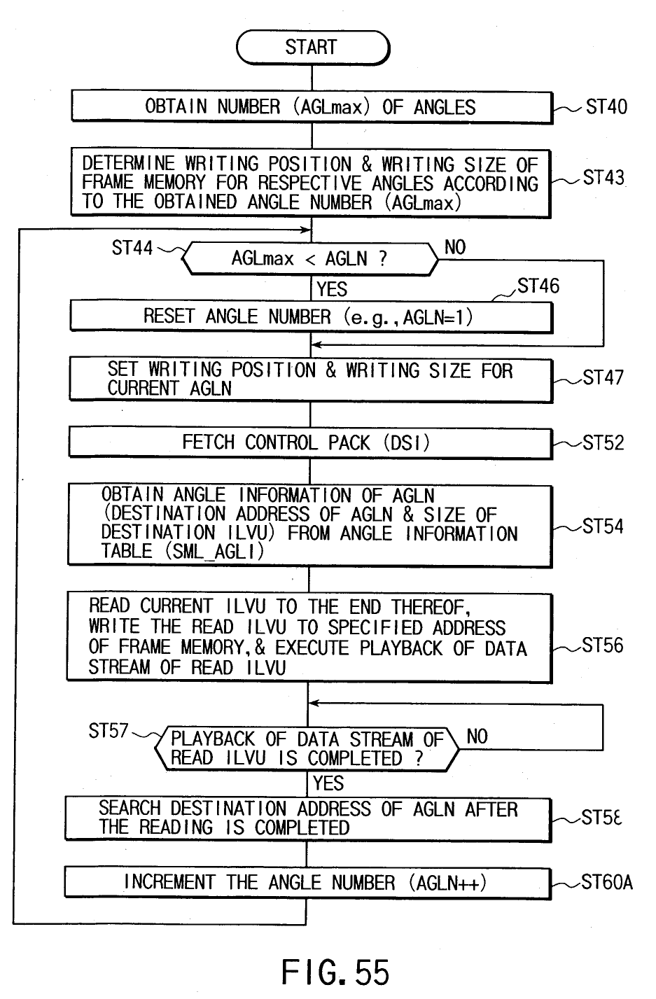

FIG. 55 is a flow chart for explaining another example of the processing sequence of n-divided shrunk display shown in FIG. 42 or 52.

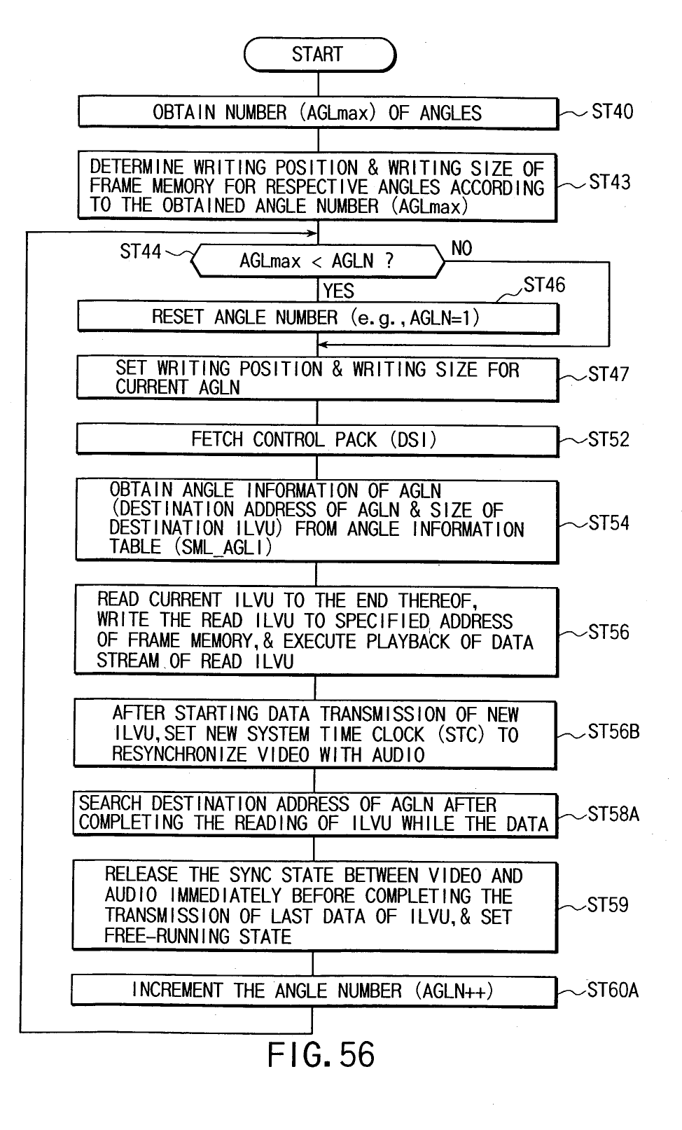

The example in FIG. 55 is substantially common to FIG. 53 except for the contents in processing step ST56. More specifically, in step ST56A in FIG. 53, the corresponding angle number information is OSD-displayed upon multi-screen digest displaying angles on the n-divided shrunk display screen areas. However, in step ST56 in FIG. 56, this OSD display is omitted.

FIG. 56 is a flow chart for explaining synchronization between video and audio data for discontinuous system time clocks STC upon making n-divided shrunk display shown in FIG. 52C or 52D.

In the example shown in FIG. 56, processing steps ST40 to ST56 are common to those in FIG. 55, and the subsequent processing is different from that in FIG. 55. More specifically, after the current ILVU is played back, when data transmission of a new ILVU starts, new STC is set, and video data is resynchronized with audio data (step ST56B).

Upon completion of reading of the new ILVU data after resynchronization between video and audio data, the destination address of the next angle number of that ILVU is searched, and data transmission of the ILVU at the obtained address is continued (step ST58A).

Immediately before completion of transmission of the last data of the ILVU at the destination address, the “sync state between video and audio data” is released to set transmission of video and audio data in a free-running state (step ST59).

After that, the angle number is incremented (step ST60A), and a loop of steps ST44 to ST60A is cyclically repeated for all the angles to be digest-displayed (#1 to #4 in the example in FIG. 42). In this loop, video and audio data are resynchronized in step ST56B, and this sync state is released in step ST59.

In stream transmission in FIG. 50, when the angle is switched, time stamp data recorded in the stream input to the decoders (58 to 62 in FIG. 45) become discontinuous. In such case, discontinuity of time stamp data is detected, and time stamp discontinuity processing is executed in the MPEG, sub-picture, and audio decoders (58 to 62), thus realizing seamless playback. This discontinuity processing corresponds to step ST56B in FIG. 56.

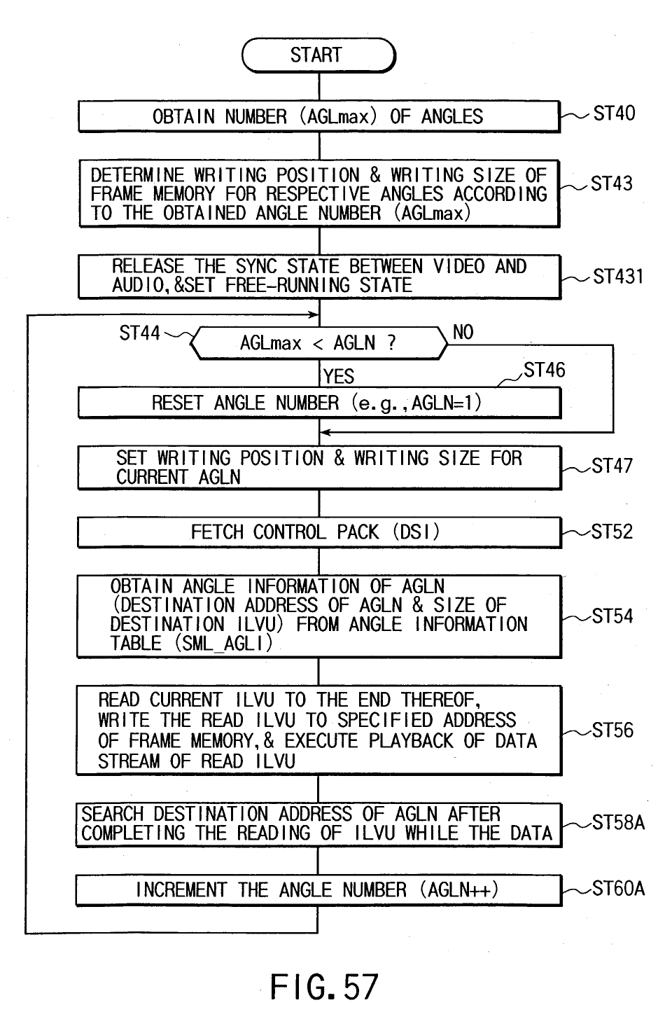

FIG. 57 is a flow chart for explaining an example of the processing sequence of making multiangle simultaneous display (digest display) without synchronizing video and audio data.

When a plurality of angles are to be displayed on multi-screen areas, time stamp comparison described in FIG. 28 may be skipped, and each decoder may be fixed in a free-running state in which it operates according to its own time management. FIG. 57 shows the processing example in that case, and processing corresponding to step ST59 in FIG. 56 is executed immediately after step ST43.

More specifically, after the writing positions and sizes for a plurality of angles are determined (step ST43), the sync state between video and audio data is released, and transmission of video and audio data is set in a free-running state (step ST431). In this state, the processing loop of steps ST44 to ST60A in FIG. 56 is executed. However, the processing operations in steps ST56B and ST59 in FIG. 56 are omitted from FIG. 57.

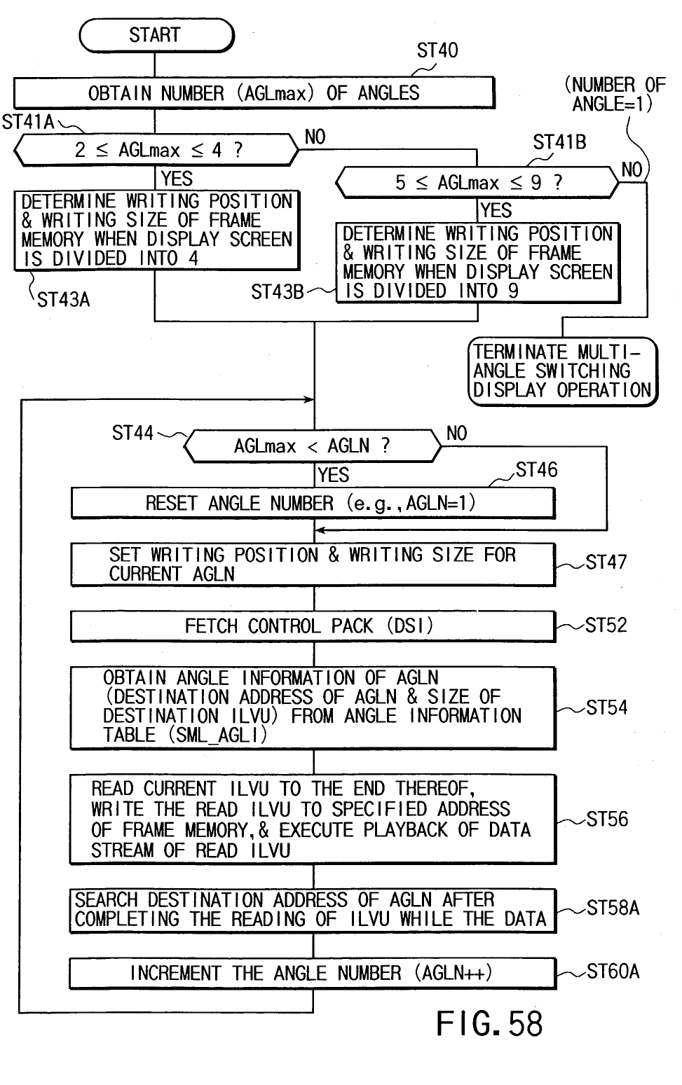

FIG. 58 is a flow chart for explaining an example of independently processing 4- and 9-divided display modes in the processing sequence of n-divided (4- or 9-divided) shrunk display shown in FIG. 52.

The processing in FIG. 58 is common to that in FIG. 57, except for the processing for automatically determining the number of divisions of frame memory 642. Hence, only the automatic dividing processing of the frame memory will be described.

The number of angle cells of the current angle block is obtained from the information table shown in FIG. 19, and the angles that can be played back are checked based on the playback permitted flags shown in FIG. 32. For example, if the angle block includes seven angle cells, and four out of the these cells are set with playback permitted flags, it is determined that the number of angles (AGLmax) for multi-screen digest display is “4” (step ST40).

If the number of angles is “4” (YES in step ST41A), the number of divided screen areas can be four. In this case, the writing positions and sizes of angle picture information onto frame memory 642, the frame of which is divided into four areas, are determined (step ST43A).

On the other hand, if the number of angles obtained in step ST40 is “7” (NO in step ST41A; YES in step ST41B), the writing positions and sizes of angle picture information onto frame memory 642, the frame of which is divided into nine areas, are determined (step ST43B).

If the number of angles obtained in step ST40 is “1” (NO in step ST41A; NO in step ST41B), the screen area need not be divided. In this case, the multiangle switching display operation (multiangle digest display) is terminated, and the processing in FIG. 58 ends (in this case, normal playback using the full monitor screen is made).

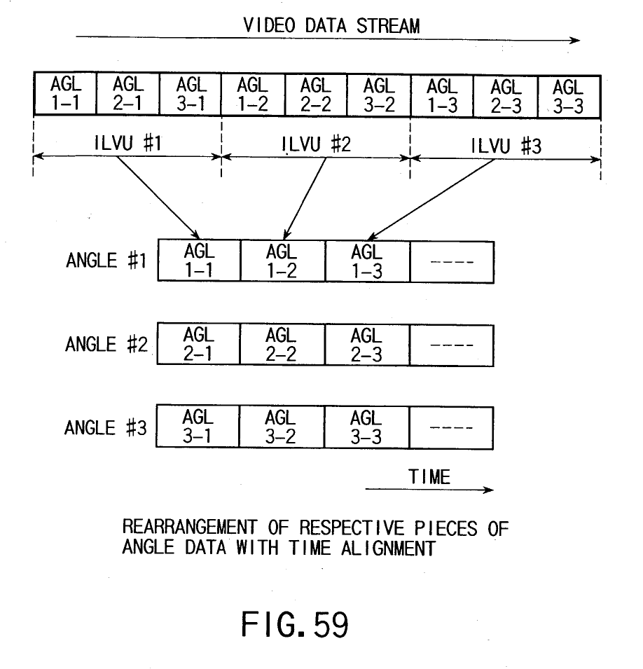

FIG. 59 is a view for explaining the correspondence between the recording pattern (interleaved arrangement of a video stream including a plurality of angles) of angle blocks on a disk, and a plurality of angle data which have been rearranged based on the time axis.

A video data stream played back from a seamless angle block on DVD video disk 10 includes serial data, as shown in the upper portion in FIG. 59. When the contents of this stream are rearranged in correspondence with individual actual playback angle data, parallel data are obtained, as shown in the lower portion in FIG. 59.

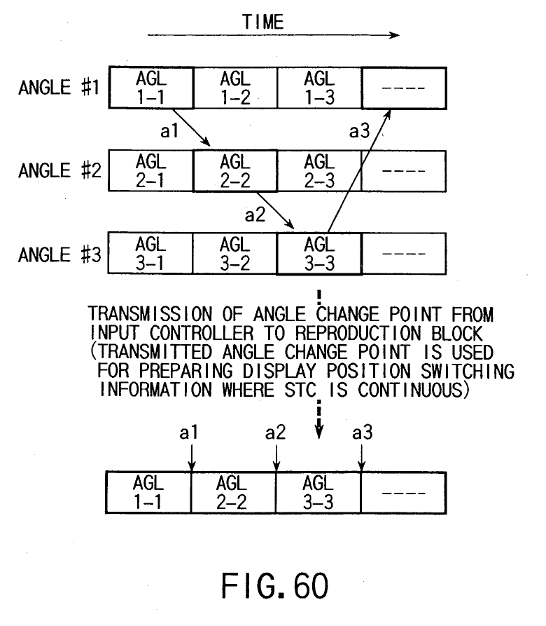

FIG. 60 is a view for explaining angle switching when system time clocks STC are continuous.

When the angles are switched like angle #1→angle #2→angle #3→angle #1, . . . using angle data with the arrangement shown in FIG. 59, and the data to be read out of each angle are switched along a switching path a1→a2→a3, . . . , system time clocks STC are continuous. In this case, the angle switching point (the playback end confirmation point in FIG. 49 or the level change point of the angle change signal in FIG. 50) is sent from an input controller (controller 508A in FIG. 51) to a playback unit (video processor 640), and is used for generating display position switching information. In this situation, the processing in the flow chart of, e.g., FIG. 54 is used.

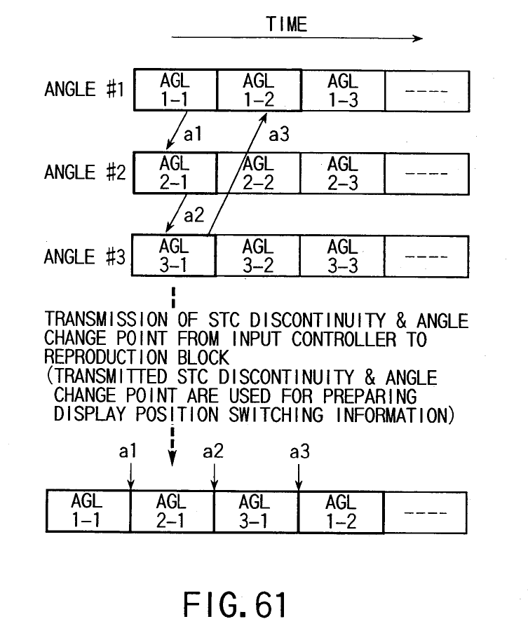

FIG. 61 is a view for explaining angle switching when system time clocks STC are discontinuous.

When the angles are switched like angle #1→angle #2→angle #3→angle #1, . . . using angle data with the arrangement shown in FIG. 59, and the data to be read out of each angle are switched along a switching path b1→b2→b3, . . . , system time clocks STC are discontinuous. In this case, the angle switching point (the playback end confirmation point in FIG. 49 or the level change point of the angle change signal in FIG. 50) is sent from an input controller (controller 508A in FIG. 51) to a playback unit (video processor 640), and is used for generating display position switching information. In such situation, the processing in the flow chart of, e.g., FIG. 56 is used.

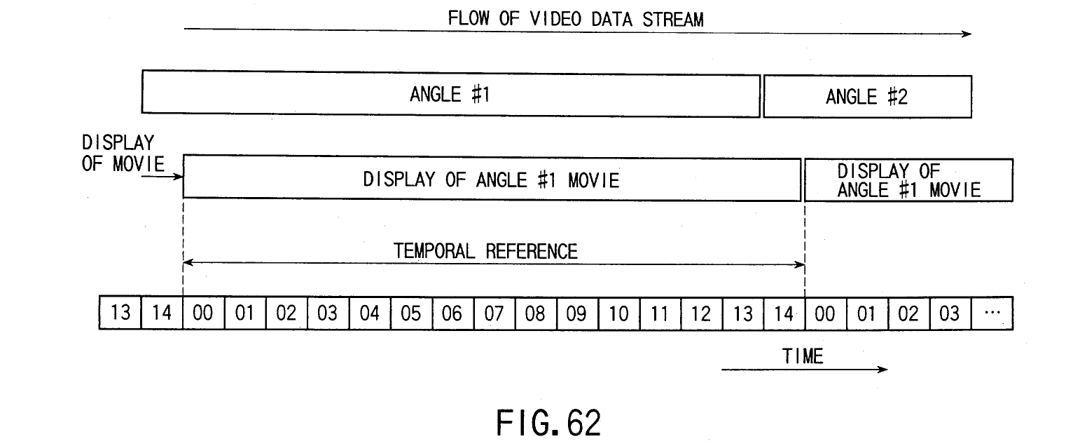

FIG. 62 is a view for explaining the correspondence between the movie display timing of each angle and MPEG temporal reference upon making n-divided shrunk display shown in FIG. 42 or 52.

In the above-mentioned example in FIG. 50, the angle switch information is a binary signal of “0” or “1” which is synchronous with switching of the angle to be displayed as a movie. In addition, the following data may be used as angle switch information:

(a) an arbitrary signal corresponding to angle switching and output from the decoders (58 to 62);

(b) angle number (recorded as information in a stream);

(c) temporal reference; and

(d) a combination of (a) to (c) above.

Temporal reference (c) is information indicating the display order in one GOP of MPEG, and corresponds to numbers 00 to 14 in FIG. 62. The instance when the temporal reference number is switched from 14 to 00 can be supplied from MPEG2 decoder 580 in FIG. 51 to multi-screen display controller 508A as “angle switch information”.

In the above embodiment, the contents of multi-screen digest display have been described using multiangle pictures. Alternatively, if the data search speed, read speed, and decode speed of the playback apparatus are high enough, pictures on the divided display areas in FIG. 42 can be those of various scenes other than the angle block.

In step ST60A in FIGS. 35, 43, and 53 to 58, the angle number is incremented (counted up) as its count processing. Alternatively, in this step, the angle number may be decremented (counted down), as shown in step ST60A in FIG. 44.

FIG. 63 is a block diagram for explaining the overall arrangement of an optical disk playback apparatus (dedicated DVD player or DVD/CD compatible player) with a built-in multiangle automatic switching/playback system (or auto-angle playback system) according to an embodiment of the present invention.

The differences from the arrangement shown in FIG. 45 will be mainly described below.

System CPU 50 comprises automatic angle switcher 500 implemented by a predetermined processing program. This automatic angle switcher 500 includes playback period determiner 502 for determining the automatic playback period of multiangle pictures, random number generator/counter 504 for generating the angle number to be automatically switched by generating a random number or counting the angle number, and angle number determiner 506 for determining the angle to be automatically switched in association with the angle numbers designated in the playback permitted state by the user.

In the arrangement shown in FIG. 63, the angle image to be displayed on monitor display 6 can be automatically switched using the angle number generated by random number generator/counter 504. The angle automatic switching period (or display period of each angle image) can be automatically changed by playback period determiner 502.

That is, in the arrangement shown in FIG. 63, the user (viewer) can enjoy multiangle pictures, the angle images and/or playback periods of which are automatically changed every time he or she watches DVD disk 10, without operating angle button 5ang, cursor key 5q, or ten-key pad 5t on remote controller 5 (FIG. 48), under the control of system CPU 50 (see FIGS. 34 to 38, and FIGS. 41, 43, and 44).

In the data sequence output from disk drive 30, the order of three different types of packs after the navigation pack may be arbitrarily determined. The number of types of packs after the navigation pack may be three or less (none, one, or two). The multiangle automatic switching system of the present invention requires at least navigation and video packs of these packs.

FIG. 64 is a block diagram for explaining a case wherein a multiangle/scene automatic switching/playback system or multiangle/scene digest display system is built using a versatile personal computer. Personal computer 1000 in FIG. 64 may use dedicated hardware or may use a versatile personal computer with a general arrangement.

More specifically, internal bus 1002 of personal computer 1000 is connected with main CPU 1004, basic I/O system ROM (BIOS ROM) 1008, main memory 1010, video memory 1012, floppy disk drive (FDD) 1022, keyboard I/O device 1024, mouse I/O device 1026, communication I/O device 1028, and the like. Main CPU 1004 is directly connected to cache memory 1006 via a dedicated high-speed bus.

Internal bus 1002 of personal computer 1000 has a plurality of versatile bus slots (not shown). These slots receive SCSI interface (SCSI board) 1014, DVD processing board 1030, video I/O device (video card) 1032, audio I/O device (audio card) 1034, and the like.

SCSI board 1014 is connected with SCSI hard disk drive (HDD) 1018, and SCSI DVD-ROM/DVD-RAM compatible drive 1020 (drive 1020 may also be compatible with a CD).

Video card 1032 is connected with high-resolution bitmap display (analog RGB type) 6, and audio card 1034 is connected with a pair of 2-channel stereophonic loud speakers 8 (if card 1034 has no power amplifier, the power amplifier may be incorporated in loud speakers 8 or a stereophonic amplifier (not shown) may be inserted between card 1034 and loud speakers 8).

DVD processing board 1030 in FIG. 64 has hardware corresponding to the signal processing function of the main body of the player shown in FIG. 45, 46, 47, or 63.

Disk drive 30 in FIG. 45, 46, 47, or 63 corresponds to DVD-ROM/DVD-RAM compatible drive 1020 in FIG. 64.

The storage area of memory 1010 or video memory 1012 in FIG. 64 may be partially used as memory 52 or frame memory 642 in FIG. 45, 46, 47, or 63 as needed.

Furthermore, hard disk drive 1018 in FIG. 64 can be partially used as a buffer memory for playback signals from disk drive 30 in FIG. 45, 46, 47, or 63.

If hard disk drive 1018 uses a disk having a capacity as large as several Gbytes (e.g., 3 to 5 GB), a predetermined area (e.g., for 4.7 GB) in that disk may be partitioned, and may temporarily store playback signals from DVD disk 10. Then, that area can be used as virtual DVD disk 10.

The functions of the operation keys of the main body of the player in FIG. 45, 46, 47, or 63 can be assigned to a keyboard (not shown) connected to keyboard I/O device 1024 in FIG. 64. Also, the functions of various keys (buttons and cursor) of remote controller 5 in FIG. 48 can be assigned to a keyboard (not shown) connected to keyboard I/O device 1024 in FIG. 64, a mouse (not shown) connected to mouse I/O device 1026, or an external controller (not shown) connected to communication I/O device 1028.

In a personal computer that can play back a DVD video using a DVD-ROM drive (or DVD-ROM/DVD-RAM compatible drive), auto-angle playback or multiangle digest display of the present invention can be implemented by software. In such case, software installed in that personal computer is obtained by programming the processing operations corresponding to those shown in FIGS. 33 to 44 or FIGS. 53 to 58.

When auto-angle playback or multiangle digest display processing is programmed on the personal computer in such way, for example, angle number increment processing step ST60A in FIG. 35 can be modified to a higher-grade one.

For example, in the angle playback setups shown in FIG. 31, if the angle number is simply incremented, the angle number is automatically switched like angle numbers #1, #2, #4, #7, #1, #2, . . . . However, such automatic switching can be extended to auto-angle playback in the order that the user desired like #1, #7, #4, #2, #4, #7, #1, #7, . . . by computer programming.

The above-mentioned auto-angle playback program or multiangle digest display program can be individually installed on a personal computer with a DVD drive via a floppy disk, CD-ROM, DVD-ROM, or communication media.

To recapitulate, according to the playback apparatus of the present invention, since a plurality of angles recorded on a recording medium are simultaneously displayed on a single screen, the user can recognize all the angles at a glance. Also, the contents of angle pictures simultaneously displayed on the single screen can be automatically switched and changed. For this reason, variations of angle selections can be increased, and colorful, appealing multiangle picture playback can be provided to the user.

Also, according to the playback apparatus of the present invention, variations of angle selections can be increased, and colorful, appealing multiangle picture playback can be provided to the user.

Additional advantages and modifications will readily occurs to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for reproducing image information, in which a predetermined number of images are selected from multi-image information being formed of selectively-reproducible image data pieces and the selected images are reproduced, provided that the predetermined number is one or more number, said method comprising:
providing one or more display areas for the predetermined number of images; and
displaying the predetermined number of images which are reproducible when a display thereof is performed, wherein the predetermined number of images are respectively displayed at the display areas.

2. The method of claim 1, further comprising:
detecting the predetermined number of the reproducible images; and
determining a position and size of each of the display areas based on the detected predetermined number,
wherein the predetermined number of the reproducible images are respectively exhibited at the displayed areas each having the determined position and size.

3. The method of claim 1, further comprising:
detecting the predetermined number of the reproducible images;
dividing by four the one display area so as to produce four display areas when the detected predetermined number is equal to or more than two and less than five;
dividing by nine the one display area so as to produce nine display areas when the detected predetermined number is equal to or more than five and less than ten; and
writing information of the reproducible images in the four display areas when the detected predetermined number is equal to or more than two and less than five, and writing information of the reproducible images in the nine display areas when the detected predetermined number is equal to or more than five and less than ten.

4. The method of claim 3, wherein a whole size of the display areas is shrunk or reduced by a predetermined rate when the detected predetermined number is equal to or more than two and less than ten.

5. The method of claim 1, further comprising:
optionally assigning a flag or flags to specific one or ones of the reproducible images so that display of the reproducible image to which said flag is assigned is prohibited.

6. The method of claim 1, further comprising:
changing displayed contents of the reproducible images on the display areas in accordance with a given order of reproduction of the reproducible images.

7. The method of claim 1, further comprising:
randomly changing displayed contents of the reproducible images on the display areas.

8. The method of claim 1, further comprising:
changing a reproduction period of the reproducible images on the display areas.

9. The method of claim 1, wherein
the multi-image information includes a plurality of multi-angle videos which are selectively reproducible within a substantially same time period, and
specific angle numbers are respectively assigned to the multi-angle videos,
said method further comprising:
displaying the specific angle numbers, with the corresponding multi-angle videos, at the display areas, respectively.

10. The method of claim 9, wherein the specific angle number varies with a change in the corresponding multi-angle video.

11. A remote controller to be used for controlling operation of an apparatus which can reproduce recorded data from a medium in which recorded are multi-angle scenes formed of video data pieces, said video data pieces being reproducible within a substantially same period of time, wherein said apparatus comprises:
means for selecting a desired angle scene from the multi-angle scenes so as to reproduce the desired angle scene;
multi-angle display means for simultaneously displaying two or more scenes of the multi-angle scenes at given display areas; and
movie area switch means for switching a movie display area among the given display areas at which the multi-angle scenes are simultaneously displayed,
said remote controller having:
means for instructing to said apparatus the simultaneous display of the multi-angle scenes in accordance with a predetermined operation of a key or keys provided on said remote controller.

12. A method for automatically changing a view of multi-angle presentation wherein one of image data pieces which are selectively-reproducible within a substantial same period of time is selected and reproduced from a recording medium in which said image data pieces are recorded with predetermined numbers, said method comprising:
automatically selecting any of the image data pieces of said multi-angle presentation; and
automatically changing the view of said multi-angle presentation according to the automatically-selected image data piece.

13. The method of claim 12, wherein said automatically selecting includes:
generating a random number, and
determining the number of the image data piece to be automatically selected in accordance with the generated random number.

14. The method of claim 12, wherein said automatically selecting includes:
incremetally or decrementally counting the number of said image data pieces to provide a counted angle number, and
determining the number of the image data piece to be automatically selected in accordance with the counted angle number.
